(19) United States
(12) Patent Application Publication
(10) Pub. No.: US 2015/0058327 A1
(43) Pub. Date: Feb. 26, 2015

(54) Responding to apprehension towards an experience with an explanation indicative of similarity to a prior experience

(71) Applicants: Ari M. Frank, Haifa (IL); Gil Thieberger, Kiryat Tivon (IL)

(72) Inventors: Ari M. Frank, Haifa (IL); Gil Thieberger, Kiryat Tivon (IL)

(21) Appl. No.: 14/537,000

(22) Filed: Nov. 10, 2014

Related U.S. Application Data
(63) Continuation of application No. 14/088,392, filed on Nov. 23, 2013.
(60) Provisional application No. 61/729,488, filed on Nov. 23, 2012.

(51) Int. Cl. G06F 17/30; G06F 17/27

(52) U.S. Cl. CPC G06F 17/30595; G06F 17/2785
USPC 707/722

(57) ABSTRACT

Described herein are systems, methods, and computer programs for responding to apprehension of a user towards an experience. In some examples, an experience involves content for the user or an activity for the user to participate in. In some embodiments, a first token instance is extracted from an expression of the user that indicates apprehension towards the experience. A prior experience, represented by a second token instance similar to the first token instance, is selected from among prior experiences the user had. Additionally, an affective response the user had to the prior experience reaches a threshold, which implies that the user may remember the prior experience. An explanation of the relevance of the experience to the user, which is indicative of similarity between the first token instance and the second token instance is generated and optionally presented to the user to ameliorate the apprehension.

### BACKGROUND

Users of computer systems in this day and age have a plethora of experiences to choose from. Examples include various content they can consume at any given time (e.g., websites, videos, books, and social networks), and activities they may partake in (e.g., games, virtual worlds, and real world events), and/or items the users may purchase in real or virtual stores. Thus, many users may find it difficult, and at times even frustrating, to make choices.

In addition to increasing opportunities to choose, technological progress has also made available tools that can assist in making choices. In particular, a technology that has become more popular in recent years is personal software assistants (also called software agents). These software based helpers can act on behalf of their users, and may perform a wide array of tasks such as managing meetings and schedules, monitoring the user's daily life and well-being, and suggesting and/or providing products and/or experiences for users. Since the software agents are able to keep tabs of many facets of users' digital and real lives, they are able to learn a lot about their users' preferences and utilize this data in order assist users in making choices. Nonetheless, users may not always respond well to choices and/or suggestions of software agents. In particular, users may be apprehensive to suggested experiences for a variety of reasons, such as lack of understanding of the reasoning that lead to the suggested experience, the relevance of the experience to the user, and/or inability to associate the experience with past experiences the user may have had.

### BRIEF SUMMARY

While software agents may suggest to users that they will like or dislike certain content and/or activities, it is often difficult for them to explain why and how they reached their conclusions. One previously unknown problem, encountered by the present inventors and addressed by some embodiments, concerns helping users to understand the decision process, which can help them assess if they want to act upon the software agent's suggestion. This can also help address apprehension the users may have towards certain experiences.

In some cases, knowing information behind the reasoning that led to the software agent's suggestion can help the users to formulate a choice and make up their mind regarding various options available to them. Such information may also encourage a dialogue between a user and the agent, which can further help the user and/or the agent better understand the user's needs and/or desires at that given time and situation.

Some aspects described in this disclosure involve responding to apprehension of a user towards an experience with an explanation indicative of similarity between the experience and a prior experience of the user.

On aspect described in this disclosure involves a system configured to respond to apprehension of a user towards an experience with an explanation indicative of similarity between the experience and a prior experience of the user. The system includes at least an expression analyzer, an experience selector, and an explanation generator. The expression analyzer is configured to receive an expression of the user and to analyze the expression to determine that the expression indicates apprehension of the user towards the experience. The expression analyzer is also configured to extract a first token instance from the expression, which represents an aspect of the experience. The experience selector is configured to select a prior experience, from among prior experiences, such that the prior experience is represented by a second token instance that is more similar to the first token instance than most of the token instances representing the other prior experiences, and an affective response of the user to the prior experience reaches a predetermined threshold. The fact that the affective response reaches the predetermined threshold implies that there is a probability of more than 10% that the user remembers the prior experience. The explanation generator is configured to generate an explanation of relevance of the experience to the user, which is indicative of similarity between the first token instance and the second token instance. Optionally, the system also includes a user interface configured to present the explanation to the user in response to the expression of the user indicating the apprehension.

Another aspect described in this disclosure involves a method for responding to apprehension of a user towards an experience with an explanation indicative of similarity between the experience and a prior experience of the user. The method includes the following steps: receiving an expression of the user; analyzing the expression to determine that the expression indicates apprehension of the user towards the experience; extracting a first token instance from the expression, which represents an aspect of the experience; selecting a prior experience, from among prior experiences, such that the prior experience is represented by a second token instance that is more similar to the first token instance than most of the token instances representing the other prior experiences, and affective response of the user to the prior experience reaches a predetermined threshold (the fact that the affective response reaches the predetermined threshold implies that there is a probability of more than 10% that the user remembers the prior experience); and generating an explanation of relevance of the experience to the user, which is indicative of similarity between the first token instance and the second token instance. Optionally, the method also includes a step of presenting the explanation to the user as a response to the expression of the user indicating the apprehension.

Another aspect described in this disclosure involves a non-transitory computer-readable medium for use in a computer to respond to apprehension of a user towards an experience with an explanation indicative of similarity between the experience and a prior experience of the user. The computer includes a processor, and the non-transitory computer-readable medium includes the following program code: program code for receiving expression of the user; program code for analyzing the expression to determine that the expression indicates apprehension of the user towards the experience; program code for extracting a first token instance from the expression, which represents an aspect of the experience; program code for selecting a prior experience, from among prior experiences, such that the prior experience is represented by a second token instance that is more similar to the first token instance than most of the token instances representing the other prior experiences, and affective response of the user to the prior experience reaches a predetermined threshold (the fact that the affective response reaches the predetermined threshold implies there is a probability of more than 10% that the user remembers the prior experience); and program code for generating an explanation of relevance of the experience to the user, which is indicative of similarity between the first token instance and the second token instance. Optionally, the non-transitory computer-readable also includes program code for presenting the explanation to the user as a response to the expression of the user indicating the apprehension.

### BRIEF DESCRIPTION OF THE DRAWINGS

The embodiments are herein described, by way of example only, with reference to the accompanying drawings. In the drawings:

The embodiments are herein described, by way of example only, with reference to the accompanying drawings. In the drawings:

FIG. 1 illustrates one embodiment of a system configured to select a prior experience resembling a future experience;

FIG. 2 illustrates one embodiment of a method for selecting a prior experience resembling a future experience;

FIG. 3 illustrates one embodiment of a system configured to select a prior experience resembling an experience utilizing a model for a user;

FIG. 4 illustrates one embodiment of a method for selecting a prior experience resembling an experience utilizing a model for a user;

FIG. 5 illustrates one embodiment of a system configured to utilize eye tracking to select a prior experience similar to an experience;

FIG. 6 illustrates one embodiment of a method for utilizing eye tracking to select a prior experience similar to an experience;

FIG. 7 illustrates one embodiment of a system configured to utilize a library that includes expected affective responses to token instances to select a prior experience relevant to an experience of a user;

FIG. 8 illustrates one embodiment of a method for utilizing a library comprising expected affective responses to token instances to select a prior experience relevant to an experience of a user;

FIG. 9 illustrates one embodiment of a system configured to rank experiences for a user based on affective responses to prior experiences;

FIG. 10 illustrates one embodiment of a method for ranking experiences for a user based on affective response to prior experiences;

FIG. 11 illustrates one embodiment of a system configured to respond to uncertainty of a user regarding an experience;

FIG. 12 illustrates one embodiment of a method responding to uncertainty of a user regarding an experience;

FIG. 13 illustrates one embodiment of a system configured to explain to a user a selection of an experience for the user;

FIG. 14 illustrates one embodiment of a method explaining to a user a selection of an experience for the user;

FIG. 15 illustrates one embodiment of a system configured to provide positive reinforcement for performing a task; and

FIG. 16 illustrates one embodiment of a method providing positive reinforcement for performing a task.

### DETAILED DESCRIPTION

Experiences, such as the prior experiences and/or future experiences for the user (e.g., experiences chosen for the user), may be of various types and involve entities in the physical world and/or a virtual world. Below are examples of several typical types of experiences. It is to be noted that the examples do not serve as a partitioning of experiences (e.g., an experience may be categorized as conforming to more than one of the following examples). In addition, the examples are not exhaustive; they do not describe all possible experiences to which this disclosure relates.

In one example, an experience may involve content for consumption by a user (e.g., a video, a game, a website, a book, a trip in a virtual world, a song). Similarly, some of the prior experiences involve content consumed by the user and/or content consumed by other users. Herein, if an experience involves consumption of content, it may be represented by that content. Thus, an experience may be described using token instances related to the content. Optionally, additional token instances, not directly related to the content, may be used to represent the experience; e.g., token instances related to the device on which the content is to be consumed and/or conditions under which the content was consumed.

In another example, an experience may involve an activity for a user to participate in (e.g., interaction with a computer, interaction with a virtual entity, going out to eat, hanging out with friends, going to play a game online, going to sleep). Similarly, some of the prior experiences may involve activities in which the user participated and/or activities in which other users participated in. Optionally, the experience may be described using token instances related to the activity.

In yet another example, an experience may involve a purchase of an item for the user, such as a purchase of a real or virtual item in a virtual store. Similarly, some of the prior experiences may involve items purchased for the user and/or other users. Optionally, the chosen experience may be described using token instances related the purchased item.

Affective response measurements of a user refer to measurements of physiological signals of the user and/or behavioral measurements of the user, which may be raw measurement values and/or processed measurement values (e.g., resulting from filtration, calibration, and/or feature extraction). Measuring affective response may be done utilizing various existing, and/or yet to be invented, measurement devices such as sensors, which can be attached to a user's body, clothing (such as gloves, shirts, helmets), implanted in the user's body, and/or be placed remotely from the user's body.

Herein, “affect” and “affective response” refer to physiological and/or behavioral manifestation of an entity's emotional state. The terms “affective response/state” and “emotional response/state” may be used herein interchangeably. However, affective response typically refers to values obtained from measurements and/or observations of an entity, while emotional responses are typically predicted from models or reported by the entity feeling the emotions. In addition, the terms “state” and “response”, when used in phrases such as “emotional state”/“emotional response” and “affective state”/“affective response”, may be used herein interchangeably; however, in the way the terms are typically used, the term “state” is used to designate a condition in which a user is in, and the term “response” is used to describe an expression of the user due to the condition the user is in or due to a change in the condition the user is in. For example, according to how terms are typically used in this document, one might state that a person's emotional state (or emotional response) is predicted based on measurements of the person's affective response.

Phrases like “an affective response of a user to content”, or “a user's affective response to content”, or “a user's affective response to being exposed to content” refer to the physiological and/or behavioral manifestations of an entity's emotional response to the content due to consuming the content with one or more of the senses (e.g., by seeing it, hearing it, feeling it). Optionally, the affective response of a user to content is due to a change in the emotional state of the user due to the user being exposed to the content. Similarly, phrases like “an affective response of a user to an experience”, or “a user's affective response to an experience” refer to the physiological and/or behavioral manifestations of an entity's emotional response to undertaking the experience (e.g., consuming content, participating in an activity, or purchasing or utilizing an item).

The term “token” refers to a thing that has a potential to influence the user's affective response. Optionally, tokens may be categorized according to their source with respect to the user: external or internal tokens. In one embodiment, the tokens may include one or more of the following:

(i) Information referring to a sensual stimulus or a group of sensual stimuli that may be experienced or sensed by the user. These tokens usually have a specified source such as objects or systems in the user's vicinity or that the user is interacting with in some way, such as digital or printed media, augmented reality devices, robotic systems, food, and/or beverages. For example, a token may be an item (e.g. car), a movie genre (e.g., “comedy”), a type of image (e.g., “image of a person”); a specific character (e.g., “Taco Bell Chihuahua”); web-site (e.g., “Facebook”); Scents or fragrances (e.g., “Chanel no. 5”); a flavor (e.g., “salty”), a physical sensation (e.g., “pressure on the back”).

(ii) Properties or values derived from a stimulus or group of stimuli. For example, the rate in which scenes change in a movie; the sound energy level; the font-size in a web-page; the level of civility in which a robot conducts its interaction with a user.

(iii) Information about the environmental conditions that may influence the user's affective response. For example, a token may refer to the user's location (e.g., home vs. outdoors), the time of day, lighting, general noise level, temperature, humidity, speed (for instance, when traveling in a car).

(iv) Information about the user's physiological and/or cognitive state. For example, the user's estimated physical and/or mental health, the user's estimated mood and/or disposition, the user's level of alertness and/or intoxication.

A token and/or a combination of tokens may represent a situation that if the user becomes aware of it, is expected to change the user's affective response to certain stimuli. In one example, monitoring the user over a long period, and in diverse combinations of day-to-day tokens representing different situations, reveals variations in the affective response that are situation-dependent, which may not be revealed when monitoring the user over a short period or in a narrow set of similar situations. Examples of different situations may involve factors such as: presence of other people in the vicinity of the user (e.g., being alone may be a different situation than being with company), the user's mood (e.g., the user being depressed may be considered a different situation than the user being happy), the type of activity the user is doing at the time (e.g., watching a movie, participating in a meeting, driving a car, may all be different situations). In some examples, different situations may be characterized in one or more of the following ways: (a) the user exhibits a noticeably different affective response to some of the token instances, (b) the user is exposed to significantly different subsets of tokens, (c) the user has a noticeably different user emotional state baseline value, (d) the user has a noticeably different user measurement channel baseline value, and/or (e) samples derived from temporal windows of token instances are clustered, and samples falling into the same cluster are assumed to belong to the same situation, while samples that fall in different clusters are assumed to belong to different situations.

The term “token instance” refers to the manifestation of a token during a defined period of time and/or event. The relationship between a token and its instantiation (i.e., the token instance) is somewhat similar to the relationship between a class and its object in a programming language. For example, a movie the user is watching is an instance of the token “movie” or the token “The Blues Brothers Movie”; an image of a soda can viewed through a virtual reality enabled device is a token instance of “soda can”; the sound of the soda can opening in an augmented reality video clip played when viewing the can may be considered a token instance of “soda can popping sound”; the scent of Chanel 5 that the user smelt in a department store while shopping for a present is an instance of the token “perfume scent”, or a more specific token may be “scent of Chanel no. 5”; the temperature in the room where the user is sitting may be considered an instance of the token “temperature is above 78F”; the indication that the user sitting alone in the room is an instance of the token “being alone”, and the indication that the user is suffering from the flu may be considered an instance of the token “sick”.

In one example, token instances may be generated manually, e.g., by users manually annotating events that occur, content they consume, and/or experiences they have. Additionally or alternatively, experts and/or third party observes may similarly annotate events, content, and/or experiences that occur to others. In another example, token instances may be generated by software, e.g., by analyzing images, text, and/or audio. In yet another example, token instances may be generated from data collected from many users having similar experiences, events, and/or consuming similar content. By monitoring token the token instances provided to many users, token instances may be provided to other individual users (e.g., using token instances provided to content by many users to represent content for a user).

In some embodiments, token instances may include a single value or multiple values (e.g., multiple attribute values). For example, a single token instance may correspond to an object, describing its location, size, velocity, and a certain time during which the object is in existence. Thus, depending on the implementation, in some embodiments, the same information may be conveyed via a single token instance (e.g., with multiple attributes) and/or multiple token instances (possibly each with less attributes than the single token instance). Therefore, when a single token instance is mentioned herein (e.g., “receiving a token instance” or “comparing a token instance”), it may be interpreted as involving a single or multiple token instances.

In some embodiments, token instances may have various attributes that indicate weight and/or importance of a token instance. Optionally, values of attributes such as weight and/or importance may vary over time. Thus, a token instance may have multiple attribute values for weight corresponding to different times (e.g., weight of a character in a video may be proportional to the size of the character on the screen).

The term “exposure” in the context of a user being exposed to token instances means that the user is in a position to process and/or be influenced by the token instances, be they of any source or type (e.g., the token instances may represent aspects of content the user is exposed to and/or an experience the user has).

The response of a user to token instances may refer to the affective response of the user to being exposed to the token instances. Optionally, response may be expressed as a value, and/or a change to a value, of measurements of a user (e.g., in terms of physiological measurements). Additionally or alternatively, the response may be expressed as a value, and/or a change to a value, of an emotional state.

Herein, a phrase like a “token instance representing an experience” means that the token instance may represent the whole experience (e.g., the whole movie) and/or a certain aspect of the experience. For example, a token instance representing a movie may correspond to a character in the movie, a car chase in the movie, or the color of the dress an actress wears in a certain scene in the movie. Similarly, an object may be said to be represented by a token instance and/or the object may correspond to the token instance if the token instance describes the object and/or an aspect of the object. Herein, referring phrases referring to token instances “representing” and “describing” may be used interchangeably.

In some embodiments, some of the token instances may be assigned values reflecting the level of interest a user is predicted to have in said token instances. The terms “interest” and “attention” with respect to a level of attention or interest of a user in a token and/or a token instance are used herein interchangeably. Optionally, interest level data in tokens and/or token instances may be compiled from one or more sources, such as (i) attention level monitoring, (ii) prediction algorithms for interest levels, and/or (iii) using external sources of information on interest levels. Optionally, interest level data may be stored as a numerical attribute of token instances. Optionally, interest levels may be grouped into broad categories, for example, the visual tokens may be grouped into three categories according to the attention they are given by the user: (i) full attention, (ii) partial/background attention, (iii) low/no attention.

The term “software agent” may refer to a computer program that operates on behalf of an entity such as a person, institution or a computer. Optionally, the software agent may operate with some degree of autonomy and be capable of making decisions and/or taking actions in order to achieve a goal of the entity it operates on behalf.

Some embodiments described in this disclosure involve selection of an experience from among prior experiences that the user and/or other users may have had. This selected experience is typically referred to herein as “the prior experience” and/or “the specific prior experience”. The prior experience may be selected because it corresponds to an experience the user is undertaking and/or may undertake in the future (e.g., an experience chosen for the user by a software agent). This experience, to which the prior experience corresponds, is typically referred to herein as “the experience”, “the future experience”, and/or “the chosen experience”.

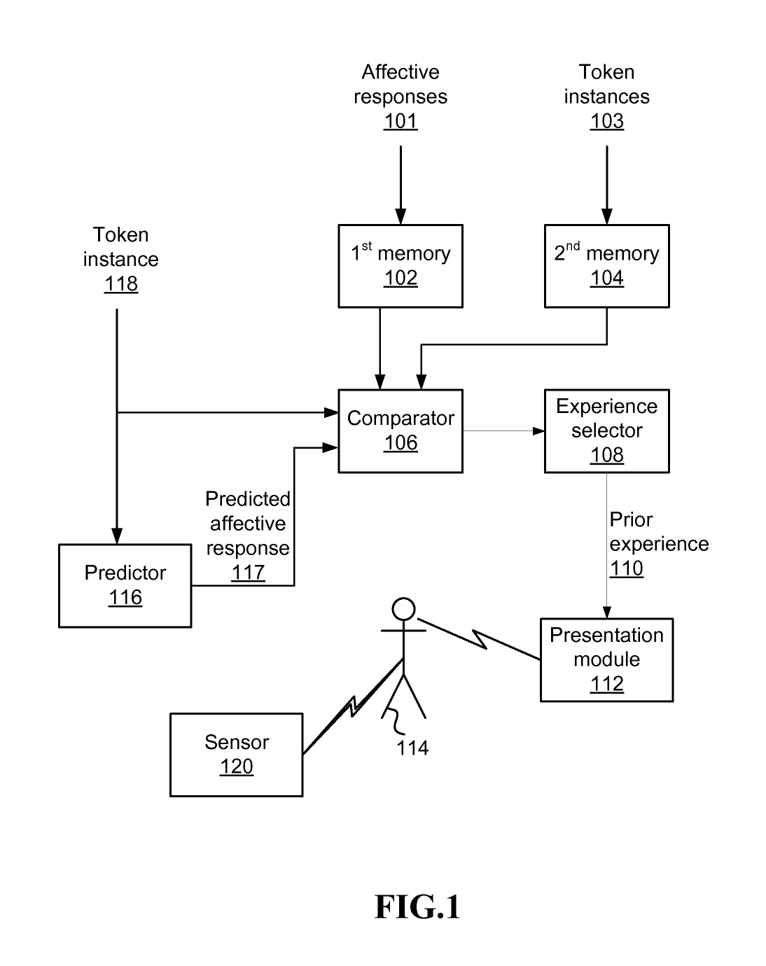

FIG. 1 illustrates one embodiment of a system configured to select a prior experience resembling a future experience. The system includes at least a first memory 102, a second memory 104, a comparator 106, and an experience selector 108. Optionally, the first memory 102 and the second memory 104 involve the same memory (e.g., both are part of memory belonging to the same server). Optionally, the comparator 106 and the experience selector 108 are realized in the same computer hardware (e.g., they are realized, at least in part, as programs running on the same processor). Optionally, the first memory 102 and/or the second memory 104 are coupled to the comparator 106 and/or the experience selector 108. For example, the memories belong to a server on which the comparator 106 and/or the experience selector 108 run. Optionally, at least one of the first memory 102 and the second memory 104 reside on a server that is remote, such as a cloud-based server. Optionally, at least one of the comparator 106 and the experience selector 108 run on a remote server, such as a cloud-based server.

The first memory 102 is configured to store affective responses 101 to prior experiences which are relevant to a user 114. Optionally, the affective responses 101 are received essentially as they are generated (e.g., a stream of values generated by a measuring device or a device used to predict affective responses). Optionally, the affective responses 101 are received in batches (e.g., downloaded from a device or server), and the affective responses 101 may be stored at various durations after they occur (e.g., possibly hours or even days after they the affective responses occurred).

In one embodiment, the affective responses 101 include affective responses of the user 114, and as such may be relevant to the user 114 since they indicate preferences of the user 114. Additionally or alternatively, the affective responses 101 may include affective responses to experiences that are similar to experiences that the user 114 experienced in the past and/or might experience in the future, and as such are relevant to the user.

In another embodiment, the affective responses 101 may include affective responses to experiences that were deemed relevant to the user 114 by an algorithm. For example, an algorithm monitoring social network activity of the user 114 may determine which social network-related experiences are relevant to the user 114 (e.g., dating), and which are not (e.g., playing certain games).

In one embodiment, the affective responses 101 include affective response measurements of the user 114 to at least some of the prior experiences. Optionally, at least some of the affective response measurements are obtained utilizing a sensor 120 which may be configured to measure a physiological value and/or a behavioral cue of the user 114.

In another embodiment, the affective responses 101 may include predicted affective responses. For example, affective responses predicted by a model (of the user 114 or of other users). Additionally or alternatively, the affective responses 101 may include affective responses derived from actions of the user 114 or other users with respect to the prior experiences. For example, a certain clip was shared and forwarded by many users, this may correspond to a positive affective response to an experience involving viewing the clip. If the user 114 ignores indications of incoming calls from a certain acquaintance, this may correspond to a negative affective response of the user 114 to an experience involving a conversation with the certain acquaintance.

The second memory 104 is configured to store token instances 103 representing the prior experiences. Optionally, at least some of the token instances 103 are stored as the prior experiences occur. For example, token instances representing a conversation the user 114 is having are generated within a few seconds as the conversation takes place by algorithms that employ speech recognition and semantic analysis, and are conveyed to the second memory 104 essentially as they are generated. Alternatively or additionally, at least some of the token instances 103 may be stored before or after the experiences take place. For example, token instances representing a movie may be downloaded from a database prior to when the user views the movie (or sometime after the movie was viewed).

In embodiments described herein, representation of experiences with token instances may be realized in different ways, which may differ between implementations and embodiments. In one embodiment, each prior experience is represented by one or more token instances. In another embodiment, a token instance may represent at most one prior experience. For example, a token instance may correspond to occurrence of an experience (e.g., playing a game); each time the game is played different token instances may be created possibly containing attributes unique to each instance in which the game is played (though many of the token instances may be instantiations of the same tokens). In still another embodiment, a token instance may represent multiple experiences. For example, each time a game is played the same token instances are used to represent characters or events in the game.

In one embodiment, at least some of the token instances are generated by a provider of the prior experiences. For example, a game console on which a game is being played may generate token instances that represent the game play. Additionally or alternatively, at least some of the token instances may be generated from separate analysis (not of the experience provider) of at least some of the prior experiences. For example, analysis by a software agent of web pages visited by a user may be used to generate token instances that represent content of the web pages. In another example, statistical analysis of a sporting event that is downloaded from a web service (e.g., statistics regarding the plays in a baseball or football game), may be used to derive token instances describing the event (e.g., number of runs, home runs, or unforced errors).

The comparator 106 is configured to receive a token instance 118 representing the future experience, and to receive a predicted affective response 117 of the user to the future experience. Optionally, the token instance 118 may include multiple values and/or attributes which may be realized utilizing by one or more tokens, all of them referred to as token instance 118. Optionally, the token instance 118 and the affective response may be received essentially at the same time and/or from the same source. For example, a movie provider may provide both token instances and a predicted affective response (e.g., based on affective responses of other viewers) for movies that users may request to view on demand. Optionally, the token instance 118 and the affective response may be received at different times and/or they may be received from different sources. For example, while token instances describing a movie may be downloaded ahead of time from a movie provider (e.g., a website), the predicted affective response 117 may be generated, essentially right before the comparator 106 performs its task (e.g., a few seconds before), by a predictor that uses a personal model of the user 114 and relates to the state of the user at that time (e.g., takes into account baseline physiological values and/or the situation the user is in).

The comparator 106 is also configured to compare the token instance 118 representing the future experience with at least one of token instance representing at least one of the prior experiences, and to compare the predicted affective response 117 with at least one of the affective responses 101. Optionally, the at least one of the affective responses 101 corresponds to the at least one of the prior experiences. For example, the at least one of the affective responses 101 is a measured affective response to the at least one of the prior experiences or the at least one of the affective responses 101 may be a predicted affective response to the at least one of the prior experiences. Thus, in some embodiments, the comparator 106 compares the future experience to prior experiences by considering both similarity of token instances between the future experience and prior experiences and similarity of affective responses corresponding to the future experience and prior experiences.

In one embodiment, comparing the token instance 118 with the at least one of token instance representing at least one of the prior experiences is done separately of the comparing of the predicted affective response 117 with at least one of the affective responses 101. For example, each comparison produces a separate value; a first value may indicate how similar the token instances are, while a second value may indicate how similar the affective responses are. Both the first and second values may be conveyed in results generated by the comparator 106, which are utilized by the experience selector 108. Additionally or alternatively, the results may include a single value that is derived from the first and second values (e.g., a weighted sum of the first and second values).

In another embodiment, comparing the token instance 118 with the at least one of token instance representing at least one of the prior experiences is done together with the comparing of the predicted affective response 117 with at least one of the affective responses 101. For example, a distance function or predictor may receive as input feature values derived from a token instance and an affective response (e.g., a feature vector created from both), and be used to make the comparison. Thus a single value may represent the results of the comparison. Optionally, the single value may not indicate a separate contribution of token instances or affective responses to the result of the comparison. Optionally, the single value may be conveyed in results generated by the comparator 106, which are utilized by the experience selector 108.

In one embodiment, the comparator 106 compares the token instance 118, to essentially all token instances 103 stored in the second memory 104. Additionally or alternatively, the comparator 106 may compare the predicted affective response 117 with essentially all affective responses 101 stored in the first memory 102. For example, this may occur if the comparator 106 compares data related to the future experience with data related to all the prior experiences.

Alternatively, the comparator 106 may compares data related to the future experience with a subset of the data related to the prior experiences or compare with data related to a subset of the prior experiences. In one embodiment, based on the token instance 118, the predicted affective response, and/or characteristics of the future experience, the comparator 106 selects which token instances stored in the first memory 102 and/or affective responses stored in the second memory 104 it should compare with. For example, the comparator 106, may determine a type of the token instance 118 (e.g., is related to a game, a movie, or homework) and decide only to compare the token instance 118 with token instances of a similar type. In another example, the comparator may elect to compare affective responses of the same type; for example, compare emotional responses with each other, or physiological response values, but not compare an emotional response (e.g., happy) with a physiological value (e.g., heart rate 80). In another embodiment, the comparator 106 may receive the data it is to compare (e.g., token instances and/or affective responses of certain prior experiences). For example, an external source may send the data that needs to be compared and/or indicate which prior experiences are more relevant for comparison with the future experience.

The experience selector 108 is configured to select, based on results received from the comparator 106, the prior experience 110 from among the prior experiences. Optionally, the selection of the prior experience 110 is done such that there is a certain similarity between the prior experience 110 and the future experience. In one embodiment, the selection may be done such that similarity between the token instance 118 representing the future experience and a token instance representing the prior experience 110 is greater than similarity between the token instance representing the future experience and most of the token instances 103 representing the other prior experiences. That is, the similarity between the token instance 118 and the token instance representing the prior experience 110 is, on average, greater than the similarity of the token instance 118 and a randomly selected token instance from among the token instances 103. Additionally, the selection is done such that similarity between the predicted affective response 117 and an affective response to the prior experience 110 is greater than similarity between the predicted affective response 117 and most of the affective responses 101 to the other prior experiences. That is, the similarity between the predicted affective response 117 and the affective response to the prior experience 110 is, on average, greater than the similarity between the predicted affective response 117 and a randomly selected affective response from among the affective responses 101.

In another embodiment, a single similarity value may represent the similarity between the prior experience and the future experience, such as a single value representing the combined similarity of token instances and affective responses. For example, the single value may be derived from comparing feature vectors representing the prior experience and future experience, which include feature values corresponding to token instances and/or to the affective responses. Optionally, the prior experience is an experience from among the prior experiences, for which the similarity represented by the single value is a greater than the value obtained when comparing the future experience with most of the prior experiences. That is, on average, the similarity value obtained when comparing the prior experience with the future experience (e.g., when comparing feature vectors representing them), is greater than similarity obtained when comparing between the future experience and a randomly selected prior experience.

In yet another embodiment, similarity between the future experience and prior experiences is expressed via one or more numerical values and/or one or more values that may be converted to numerical values. For example, similarity is expressed as the value of the dot-product between feature vector representations of the experiences. Optionally, the prior experience that is selected is an experience for which the similarity value with the future experience reaches a predetermined threshold. For example, any of the prior experiences which have a similarity with the future experience which exceeds a predetermined threshold of 0.5 may be selected as the prior experience 110. In the last example, the predetermined threshold 0.5 may represent a minimal value required for a dot-product between a feature vector of the future experience and a feature vector of the prior experience. Optionally, if no prior experience is found for which the similarity with the future experience reaches the predetermined threshold, the experience selector 108 may elect not to select the prior experience. Optionally, the experience selector 108 may provide an indication that no prior experience was found to be similar to the future experience. For example, the indication may be provided to the user 114 or to another module such as a software agent that selected and/or suggested the future experience.

Herein, when the term “reaches a predetermined threshold” is used, it is meant that a value being compared to the threshold equals or exceeds the threshold's value. Additionally, herein, a predetermined threshold, such as a predetermined threshold to which a value representing similarity of experiences may be compared, refers to a threshold that utilizes a value of which there is prior knowledge. For example, the threshold value itself is known and/or computed prior to when the comparison is made. Additionally or alternatively, a predetermined threshold may utilize a threshold value that is computed according to logic (such as function) that is known prior to when the comparison is made.

In still another embodiment, in which similarity between the future experience and prior experiences is expressed via one or more numerical values, the prior experience 110 is a prior experience which has a maximal similarity to the future experience. Optionally, if the prior experience with a maximal similarity value to the prior experience has similarity that does not reach a predetermined threshold, the experience selector 108 may elect not to select the prior experience. Optionally, the experience selector 108 may provide an indication that no prior experience was found to be similar enough to the future experience.

In one embodiment, the system illustrated in FIG. 1 optionally includes a presentation module 112 that is configured to present to the user 114 information related to the prior experience 110. This information may be presented in temporal proximity to when the user 114 needs to make a decision related to the future experience. In one example, the presentation module 112 belongs to a device utilized by the user 114 to receive information. In another example, the presentation module 112 may include a screen (e.g., smart phone, tablet, television, monitor), head-mounted eye-wear (e.g., glasses or contact lenses for augmented and/or virtual reality), speakers (e.g., speakers belonging to a smartphone, headphones), and/or haptic feedback (e.g., vibrating devices like a phone or media controller).

Herein, temporal proximity refers to nearness in time. For example, two events are considered to be in temporal proximity if they occur within a short duration of each other such as a less than a minute from each other. In another example, two events are considered to happen in temporal proximity if the occur less than a few seconds from each other.

In one embodiment, the system illustrated in FIG. 1 optionally includes a predictor of affective response 116. Optionally, the predictor is, or utilizes, a content Emotional Response Predictor (content ERP), as described further below in this disclosure. Optionally, the predictor of affective response 116 is configured to receive the token instance 118 representing the future experience, and to predict the predicted affective response 117 utilizing a model of the user 114. Optionally, the model of the user is trained on data comprising experiences described by token instances and measured affective response of the user 114 to the experiences. Optionally, the model is trained on data comprising experiences described by token instances and measured affective response of other users to the experiences. In one example, at least some of the other users may have similar characteristics to the user 114, such as similar demographics, similar social network activity, and/or the other users may have affective responses to experiences that are similar to the responses of the user 114.

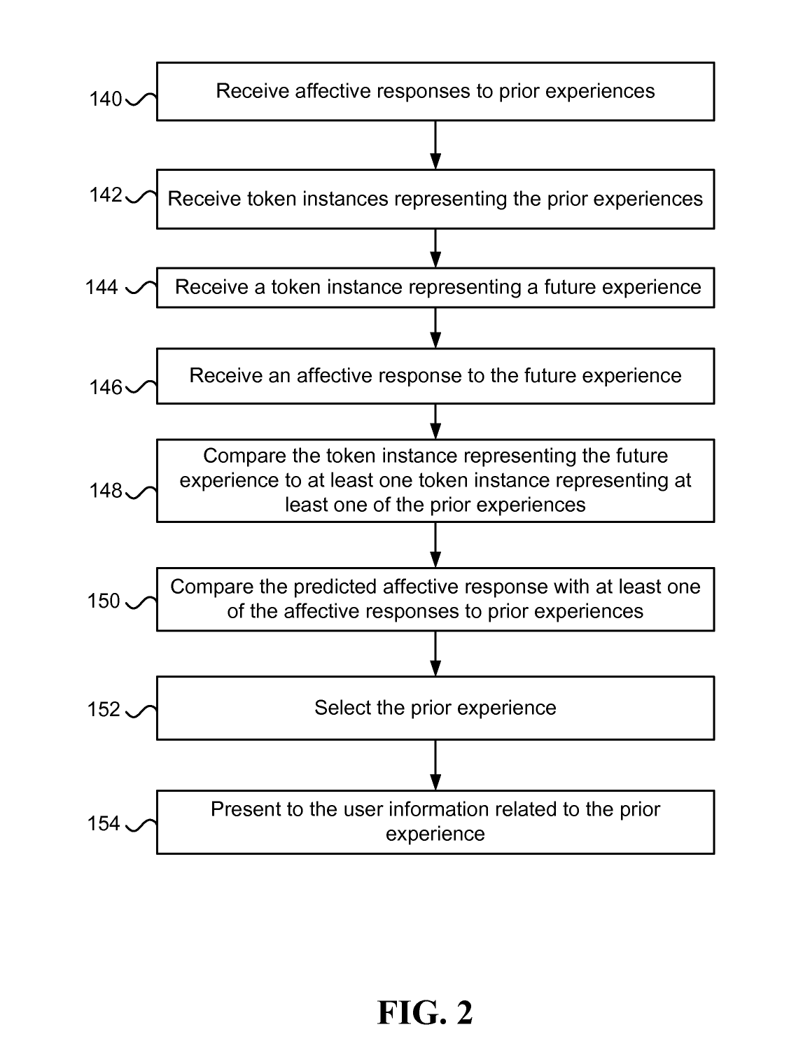

FIG. 2 illustrates one embodiment of a method for selecting a prior experience resembling a future experience. The method includes at least the following steps: In step 140, receiving affective responses to prior experiences which are relevant to a user. In step 142, receiving token instances representing the prior experiences. In step 144, receiving a token instance representing the future experience. In step 146, receiving a predicted affective response of the user to the future experience. In step 148, comparing the token instance representing the future experience with at least one of the token instances representing at least one of the prior experiences. In step 150, comparing the predicted affective response with at least one of the affective responses. And in step 152, based on results of the comparing of the at least one token instance and results of the comparing of the predicted affective response, selecting the prior experience from among the prior experiences.

In one embodiment, selecting the prior experience is done such that similarity between the token instance representing the future experience and a token instance representing the prior experience is greater than similarity between the token instance representing the future experience and most of the token instances representing the other prior experiences. Additionally, the similarity between the predicted affective response and an affective response to the prior experience is greater than similarity between the predicted affective response and most of the affective responses to the other prior experiences.

In one embodiment, the method illustrated in FIG. 2 optionally includes step 154 which involves presenting to the user information related to the prior experience in temporal proximity to decision making, of the user, related to the future experience.

In one embodiment, the method illustrated in FIG. 2 optionally includes a step involving receiving the at least one token instance representing the future experience, and predicting the predicted affective response of the user to the future experience. Optionally, predicting the predicted affective response is done utilizing a model of the user trained on data comprising experiences described by token instances and measured affective response of the user to the experiences. Optionally, predicting the predicted affective response is done utilizing a model trained on data comprising experiences described by token instances and measured affective response of other users to the experiences.

In one embodiment, the method illustrated in FIG. 2 optionally includes a step involving receiving at least one token instance representing the prior experience, and predicting affective response of the user to the prior experience.

In one embodiment, the method illustrated in FIG. 2 optionally includes a step involving measuring affective response of the user to the prior experience utilizing a sensor.

In one embodiment, a non-transitory computer-readable medium stores program code that may be used by a computer to select a prior experience resembling a future experience. The computer includes a processor, and the non-transitory computer-readable medium stores the following program code: Program code for receiving affective responses to prior experiences which are relevant to a user. Program code for receiving token instances representing the prior experiences. Program code for receiving a token instance representing the future experience, and program code for receiving a predicted affective response of the user to the future experience. Program code for comparing the token instance representing the future experience with at least one of the token instances representing at least one of the prior experiences. Program code for comparing the predicted affective response with at least one of the affective responses. And program code for selecting, based on results of the comparing of the at least one token instance and results of the comparing of the predicted affective response, the prior experience from among the prior experiences. Optionally, similarity between the token instance representing the future experience and a token instance representing the prior experience is greater than similarity between the token instance representing the future experience and most of the token instances representing the other prior experiences, and similarity between the predicted affective response and an affective response to the prior experience is greater than similarity between the predicted affective response and most of the affective responses to the other prior experiences.

In one embodiment, the non-transitory computer-readable medium may optionally store program code for presenting to the user information related to the prior experience in temporal proximity to decision making, of the user, related to the future experience. In one embodiment, the non-transitory computer-readable medium may optionally store program code for receiving the at least one token instance representing the future experience, and program code for predicting the predicted affective response of the user to the future experience utilizing a model of the user trained on data comprising experiences described by token instances and measured affective response of the user to the experiences. In one embodiment, the non-transitory computer-readable medium may optionally store program code for receiving the at least one token instance representing the future experience, and program code for predicting the predicted affective response of the user to the future experience utilizing a model trained on data comprising experiences described by token instances and measured affective response of other users to the experiences.

In some embodiments, the presentation to the user 114 of the information related to the prior experience may occur at different times relative to the future experience. In one example, the information related to the prior experience is presented to the user 114 essentially before the user 114 starts the future experience. In this example, the decision making of the user may involve deciding whether to start the future experience. In another example, the information related to the prior experience is presented to the user 114 essentially after the user starts to experience the future experience. In this example, the decision making of the user 114 may involve deciding whether to continue the future experience and/or to complete the chosen experience (e.g., watch a movie to the end).

The information related to the prior experience which is presented to the user in some of the embodiments may relate to various aspects of the prior experience. Optionally, the information may include a direct reference that identifies the prior reference (e.g., “the party last week at Mike's”). Alternatively, the information may allude to a nonspecific experience which does not singularly identify the prior experience but rather alludes to a certain type of experiences to which the prior experience may belong (e.g., “a party at a friend's house”).

In one example, the information includes a description of details of the prior experience, such as a summary of the experience which may describe the experience in a few sentences, a title of the experience to which the user may relate (e.g., “hanging out at Phil's last week”, “watching the Batman movie with Donnie”), and/or a listing of token that are relevant for recalling the experience (e.g., “Super Mario”, “3 am”, “pizza”).

In another example, the information related to the prior experience includes a description of juxtaposition of the prior experience and the chosen experience. The juxtaposition may highlight similarities and/or differences prior experience and the chosen experience (e.g., “this game is a first person shooter just like Call of Duty, which you enjoy so much, but there are zombie aliens and it takes place in space!”).

In yet another example, the information related to the prior experience includes a description of a measurement of affective responses of a user related to the prior experience. The measurement of affective response may describe an emotional state the user was in during the prior experience (e.g., “last time you played this game, you loved it!”). Additionally or alternatively, the measurement of affective response may describe a measurement of a physiological signal (e.g., “when you danced to a similar tune two weeks ago your heart-rate went up to 120”). Additionally or alternatively, the measurement of affective response may describe a behavioral cue (e.g., “There is a new episode of South Park you can watch, every time you watch South Park you crack up!”). It is noted that sentences such as “measurement of affective response may describe [property]” may be interpreted as “measurement of affective response may indicate [property]”, meaning that either the affective response, or result of processing the affective response, may describe the [property].

The information related to the prior experience may be presented in various ways. For example, the information may be conveyed via text (e.g., text appearing on a display such as a device's screen, and/or an augmented and/or virtual reality display). In another example, the information may be conveyed via sound (e.g., a software agent saying sentences to the user 114), and/or via animation and/or rendered images (e.g., images or cartoons generated by the software agent).

In one embodiment, information related to the prior experience may be presented by showing the user media related to the prior experience and/or media corresponding to the user having the prior experience. For example, when referring to a certain movie as the prior experience, the information may include a specific clip of a movie which the user enjoyed (e.g., as determined by measurements of the user). In another example, when presenting information related to a prior experience which involves a social activity, the information presented to the user may include images and/or videos taken at the activity (e.g., images and/or videos from the activity that appear on a social networking site and/or were sent via a messaging system).

Presenting the information related to the prior experience may be done for one or more of a variety of reasons. In one embodiment, a reason for presenting the information related to the prior experience to the user is to explain a choice of the future experience. For example, to explain its selection of an activity, a software agent may remind a user of a similar activity that the user enjoyed in the past, and thus the user is likely to enjoy the current future experience. In another example, a merchant site may explain to a user that a clothing item it suggests has similar characteristics to previous clothing items the user bought and liked. The fact the user liked the previous clothing items may be determined, at least in part, according to measurements of the affective response of the user while examining and/or wearing the previous items. Note that presenting the information related to the prior experience in order to explain the choice of the future experience may be done before the user has the future experience, while the user has the future experience, and/or after the user has the future experience (e.g., to explain why the future experience was chosen).

In another embodiment, a reason for presenting the information related to the prior experience to the user is to trigger a discussion with the user regarding the future experience. Optionally, the discussion may be utilized in order to refine the future experience and/or improve future choices of experiences for the user. For example, a software agent that selects a partner for a user for a chat in a virtual world may state that it chose that partner for the user because the partner was similar to a person the user had an enjoyable discussion within a similar virtual world a week before (measurements of the user determined that the discussion with the person was enjoyable); the agent may state that the person from the week before, like the current partner, likes history and literature. To this the user may respond that what was actually attractive about the person from a week ago is that that person spoke Italian and traveled a lot. Since the current partner does not speak a foreign language and does not like to travel, the agent may decide to make a different choice of partner and/or take note of the user's revealed preferences in order to make better choices in the future.

In another embodiment, a reason for presenting the information related to the prior experience to the user is to assist the user in formulating an attitude towards the future experience. For example, the user may receive a suggestion to play a certain game, along a description of the game. If the user shows ambivalence, the user may be reminded that this game is very similar to a game the user played for many hours in the previous year (and enjoyed that experience, as determined from measurements of the user's affective response). Being reminded of the game played in the previous year may assist the user to determine how the user feels about playing a similar game at that time (the recollection of the prior experience may trigger an emotional response towards the current experience). In another example, the user may want to see a horror movie. However, the agent may suggest an alternative such as to play an adventure game in a virtual world. To support its choice, the agent may recall to the user a previous horror movie the user watched which caused the user excessive anxiety (as was measured via affective response signals of the user during and after the movie). The agent may remind the user of the previous movie, and suggest that the game might be a more enjoyable experience for the user.

In yet another embodiment, a reason for presenting the information related to the prior experience to the user is to imply to the user that affective response of the user to the future experience is likely to be similar to affective response of the user to the prior experience. For example, a user may be hesitant to follow through on an activity selected by a software agent of the user, such as going to folk dancing. The agent may have knowledge of a time two weeks before, in which the user went folk dancing and had a good time (e.g., as detected via images of the user in which the user smiled a lot). The software agent may tell the user something along the lines of “Yes, people may think that folk dancing is lame, but just try and remember how you felt when you went dancing two weeks ago . . . I really suggest you do it again soon!”.

In some embodiments, an experience, such as the future experience or the prior experiences, may be described via token instances that may capture various aspects of the experience. For example, at least some of the token instances that describe an experience that involves consumption of content may describe the content itself. In another example, at least some of the token instances that describe an experience that involves an activity may describe the activity itself.

It is to be noted, that uses of forms of the verb “describe” and “represent” when referring to token instances describing or representing something may be used herein interchangeably. Thus, if it is stated that token instances describe an experience, it means that the token instances also represent the experience, and vice versa.

Token instances may describe various aspects of experiences (e.g., details pertaining to content and/or an activity). Some examples of different aspects that token instances may be used in various embodiments include: (i) Entities—token instances may describe objects and/or characters that are part of the experience (e.g., the identity of participants in a planned party, types of cars that appear in a video clip, the weapons belonging to a character in a game in a virtual world). (ii) Content details—token instances may describe what is happening in the experience. For example, token instances may be used to describe what characters say or do in a video clip (e.g., token instances representing the semantic meaning of what is being said), what events are happening in a video game (e.g., boss character beating the user's character), and/or what actions are included in an activity (e.g., rock climbing and canoeing). (iii) Characteristics of the experience—token instances can describe attributes that may pertain to the experience as a whole at a given time (e.g., the level of difficulty of a game, the cost of going to a movie). In addition, token instances may correspond to low-level features that may be used to describe content (e.g., color schemes of images, transition rate of images in video, or sound energy, beat, tempo and/or pitch in audio). (iv) Situations—token instances may describe aspects involved in how the user is to have the experience (e.g., location, time, participants, identity of people in the proximity of the user). In addition, token instances may be used to describe the user's state (e.g., mood, level of alertness).

It is to be noted, that the examples described above only illustrate possible token instances and do not mention all possible types of token instances that may be used. Furthermore, the examples described above are not meant to define a partitioning of token instances into sets or types. Those skilled in the art may recognize that there are various ways in which information regarding token instances may be organized, and different implementations may utilize token instances in different ways. For example, aspects that in one embodiment may considered token instances (e.g., the price of a game), may be considered attributes of token instances in other embodiments (e.g., the token instance describing a game may have a price attribute).

In some embodiments, token instances may be used to organize and/or represent information regarding the experiences in order to compare between experiences (e.g., detect similar experiences via similarity of their token instances). Additionally or alternatively, the token instances may enable analysis of experiences (e.g., by providing token instances representing experiences to a predictor in order to predict an emotional response to the experiences).

In one embodiment, an experience may come with at least some of the token instances that may be used to describe it. Optionally, the provided token instances come in the form of meta-data. Optionally, token instances that come with the experience may be manually created. Alternatively or additionally, token instances that come with the experience are generated automatically by algorithms (e.g., via automatic analysis of content). In one example, video content may come with token instance annotations the describe various aspects of the content, such as which characters appear, when they appear, which character performs actions and/or talks at a given time, a segmentation of the content into scenes, statistics regarding different scenes (e.g., sound energy, color scheme, transition rates between shots). In another example, a description of a prospective activity such as an invitation to a party may have accompanying meta-information that may be used as token instances such as the location and time of the party, who is expected to participate, the type of music that will be played, and/or the type of food and beverages that will be served.

In another embodiment, token instances are streamed along with content they represent. For example, a game that renders images and generates sound, which are part of the game and provided to the user, e.g., via a screen and speakers, may also generate a stream of token instances corresponding to the images and sound. This stream may be stored and/or utilized in order to analyze the response of the user to the content.

In yet another embodiment, an experience may be analyzed in order to generate token instances that may be used to represent it. For example, content a user consumes may be provided to analysis algorithms. In another example, images taken of content and/or taken during an activity, such as images of a camera attached to the user, may be provided to various analysis algorithms.

In one embodiment, token instances are extracted from images using object recognition algorithms. For example, algorithms that identify objects like people, animals, cars. In another example, algorithms are used to identify specific objects, such as facial recognition algorithms used to identify people in an image. Optionally, identified objects or people may be represented with token instances.

In another embodiment, audio is provided to audio analysis algorithms in order to generate token instances. For example, the algorithms may be used to identify sound effects (e.g., gunshot, or cheering of a crowd), specific musical compositions or songs, and/or the identity of speakers in the audio.

In yet another embodiment, feature extraction algorithms may be used to generate token instances corresponding to low-level features that pertain to scenes in content and not specific details in the scenes. For example, low-level features of images may include features that are typically statistical in nature, such as average color, color moments, contrast-type textural feature, and edge histogram and Fourier transform based shape features. In another example, low-level auditory features may involve statistics regarding the beat, tempo, pitch, and/or sound energy.

In still another embodiment, information related to the experience may be provided to predictors in order to generate token instances that correspond to the experience. For example, video content may be provided to a genre detector, in order to label the type of different scenes (e.g., action sequence, scenery, dialogue).

Semantic analysis may be used order to generate token instances that describe the meaning of content involved in the experience. In one example, latent semantic analysis may be used to assign labels that roughly describe the subject of an article the user reads. In another example, semantic analysis is used to reveals what emotions are expressed in text messages received by the user.

In one embodiment, descriptions of the experience may be analyzed in order to generate token instances that describe an experience. For example, a script of a movie may be analyzed to generate token instances representing characters, objects and/or actions that are mentioned in the script. Optionally, this information may be synchronized with the content, e.g., using time-stamp annotations and/or subtitles that accompany the content. Thus, the token instances may be given time-frames for their instantiation which correspond to the user's exposure to them when consuming the content.

In one embodiment, content from external sources is analyzed in order to create token instances. For example, token instances corresponding to participants in an activity may be generated according to the identities of people that confirmed their participation via an invitation sent through a social network or via geo-location information (e.g., check-ins that mention the user's location). In another example, video feed and/or images taken at an activity (e.g., a party), such as images posted on a social network, may be analyzed to determine who participated (and possibly when), in order to create token instances to represent the participants.

In some embodiments, token instances are compared and/or similarity between token instances needs to be determined. Optionally, similarity may be determined by a predetermined function. In one example, a table may contain values indicating similarity of different pairs of token instances. The table may be generated by an algorithm, or have values that are determined at least in part, by a human. Optionally, the predetermined function may utilize numerical values representing the token instances. In one example, a token instance “height 6 feet” is more similar to a token instance “height 5 feet 9 inches” than it is to a token instance “height 4 feet”. In this example, the absolute difference of the value of the height token instance may be used as a measure of similarity. In another example, attributes of a token instance may be represented as a vector, and various numerical similarity measures, such as dot-products or Euclidean distance, may be used to determine similarity of token instances. Optionally, complex analysis functions may utilize external information in order to determine similarity of token instances. For example, an image analysis algorithm may extract images corresponding to token instances and use image comparison methods to determine similarity of token instances. Thus, downloading images from IMDb™ may reveal that token “Nick Nolte” is much more similar to token instance “Gary Busey” than it is to “Groucho Marx”.

In some embodiments, measurements of the affective response of the user 114 are taken while the user 114 has experiences (e.g., consuming content and/or participating in an activity). Optionally, the measurements may be used to determine how the user 114 felt while having the experience and/or the sentiment of the user towards the experience.

In one embodiment, measurements of the affective response of the user 114 are taken with a sensor, such as the sensor 120. Optionally, the sensor is used to measure a physiological signal (e.g., heart rate, skin conductance, brainwave activity). Alternatively or additionally, the sensor may be used to detect behavioral cues (e.g., movement, gestures, and/or facial expressions).

Measurements of affective response may be processed in various ways. For example, they may undergo normalization, filtration, and/or feature extraction. Additionally or alternatively, measurements of affective response may be analyzed utilizing various models or procedures. For example, measurements of affective response may be provided to a measurement ERP (Emotional Response Predictor) in order to determine an emotional response (e.g., excitement or happiness) from the affective response measurements.

It is noted that herein phrases such as “measurements of affective response” may refer to raw values of affective response (e.g., values received from a sensor) and also to products obtained after processing and/or analysis of the raw measurement values. Thus, for example, stored measurements of affective response of a user may refer to the stored values representing the emotional state of the user as determined by a measurement ERP that was given raw and/or processed measurement values.

In one embodiment, at least some of the measurements of the affective response of the user 114 are taken essentially independently of the experience. For example, the user 114 may be wearing a bracelet that measures GSR (Galvanic Skin Response) and/or heart rate. These measurements may be taken essentially continuously, e.g., they are taken regardless of whether or not the user 114 is consuming content and/or participating in a certain activity at the time.

In one embodiment, at least some of the measurements of the affective response of the user 114 are taken in order to determine the affective response of the user to an experience. Optionally, the instruction to measure the user 114 may come from a source other than the user 114, such as a device the user 114 is interacting with. For example, a headset that records an electroencephalogram (EEG) may be signaled, by a game console, to operate essentially while the user 114 is playing a game, in order to determine the affective response of the user to the game and/or elements in the game.

Information pertaining to experiences the user 114 has, such as token instances representing the experiences and/or measurements of affective response of the user that correspond to the experiences, may be stored for future utilization.

In one embodiment, measurements of affective response 101 of the user taken during and/or shortly after an experience the user has, are stored in the first memory 102. Additionally, the token instances 103 representing the prior experiences are stored in the second memory 104. Optionally, the first memory and the second memory are the same memory. In one example, the first memory 102 and/or the second memory 104 belong to a device belonging to the user 114 and/or in proximity of the user 114. For example, the first and/or the second memories may be ROM belonging to a smartphone of the user 114, or a hard drive or solid state drive on a laptop. In another example, the first memory 102 and/or the second memory 104 are remote information storage devices, such as hard drives belonging to cloud-based servers. Optionally, the measurements and/or token instances may be stored in multiple locations. For example, part of the data may be stored on a device belonging to the user 114, while another part may be stored on the cloud. Optionally, essentially the same data (e.g., measurements and/or token instances) may be stored in multiple locations, in order to maintain redundancy of the data.

In one embodiment, the measurements of the affective response 101 of the user 114 to the prior experiences are stored implicitly when the token instances 103 representing the prior experiences are stored. For example, based on a value of a measurement of affective response to a certain prior experience, token instances representing the certain prior experience may be stored in a certain location. Thus, the value of the measurement of the affective response to the certain prior experience may be inferred based on the location. In another example, token instances representing a particular prior experience may be stored to a particular extent, or even not stored at all, based on a value of a measurement of the affective response to the particular prior experience. Thus, from the extent of stored token instances and/or the fact that the token instances were stored or not, the affective response to the particular prior experience may be deduced.

In one embodiment, the decision whether to store information regarding an experience and/or to what extent to store, may be based in part on an external signal. For example, in cases in which the user 114 explicitly expresses an emotional response to the experience, e.g., by pressing a like button or making a comment about content on a social network, the experience may be deemed meaningful to the user. Consequently, information regarding the experience, such as token instances and/or measurements of the affective response of the user, may be stored in detail.

In one embodiment, affective responses of the user to prior experiences that are stored include affective responses that are deemed relevant to user. In one example, the relevant affective responses include prior affective responses of the user (e.g., measured affective responses of the user and/or predicted affective responses). In another example, the relevant affective responses include prior affective responses that are expected to be relevant to the user according to a predetermined model describing users that respond similarly. For example, if a prior experience was determined to be important by many users (e.g., a certain concert), and a predetermined model of the user determines that the user has similar tastes like the other users, then the affective responses of the user to the concert (e.g., as measured at the concert) may be considered relevant. Herein, a predetermined model is a model that is computed before it is used to make a prediction. In yet another example, relevant affective responses may be affective responses of other users. For example, affective responses of users that are direct connections of the user 114 in a social network (e.g., affective responses of friends of the user on the social network), may be considered relevant affective responses for the user 114.

In some embodiments, the comparator 106 is utilized in order to find one or more prior experiences that are similar to the future experience, from which the prior experience may be chosen. Optionally, the comparator is configured to compare on or more token instances representing the future experience with one or more token instances representing the prior experiences to identify prior experiences similar to the future experience. There are several ways in which a prior experience may be deemed similar to the future experience, based on the token instances representing them.

In one example, a prior experience may be considered similar to the future experience if at least one token instance representing the prior experience is essentially identical to a token instance representing the future experience. For example, at least one token instance may have the same value in both cases (e.g., they represent the same game). Alternatively, the future experience may have a token instance representing it which is essentially identical to a token instance representing the prior experience, i.e., the values of its attributes are very similar to each other. For example, the future experience is represented by a token instance describing race car game, and the prior experience has a token instance describing a different type of race car game; however since both games are very similar, both token instances may be considered essentially identical. Optionally, the essentially identical tokens instances have a substantial weight among the token instances representing the two experiences being compared. For example, they have at least 10% of the token instance weight attributed to them. In another example, the essentially identical token instances are considered token instances of interest (e.g., as determined from eye-tracking data and/or a model predicting interest in token instances).

In another example, a prior experience is similar to the future experience if weight of token instances representing to the prior experience, which are essentially identical to token instances representing the future experience, reaches a predefined weight. For example, the predefined weight may be a predefined portion of total weight of token instances representing the prior experience, such as 50% of the weight.

In some embodiments, token instances representing an experience may be represented as a vector of numerical values. Optionally, not all the token instances representing the experience have corresponding numerical values in the vector. A normalized dot-product (which produces results between −1 and 1), may indicate the similarity of the vectors representing experiences. For example, a normalized dot-product of 1 alludes to the fact that both representations are essentially identical (up to a scaling factor for the actual numerical values, while a normalized dot product close to 0 alludes to the fact that the vector representations are essentially orthogonal and dissimilar.

In one embodiment, a prior experience is similar to the future experience if value of normalized dot-product between vector representation of the token instances representing the prior experience and vector representation of the token instances representing the future experience reaches a certain value.

In some embodiments, a set of token instances representing an experience may be provided to clustering algorithm (e.g., a vector representation of the token instances may be provided). The clustering algorithm may cluster a plurality of sets of token instances representing a plurality of experiences (e.g., each set represents an experience), into clusters. Each cluster may contain sets of token instances that represent similar experiences. Thus, a prior experience may be similar to the future experience the sets of token instances representing them are placed in the same cluster or very close cluster (e.g., the distance of the centroids of the clusters is small compared to the average distance between clusters). Additionally or alternatively token instances representing an experience may be provided as samples to a classifier trained to provide a class label for the provided samples. In this case, a prior experience may be similar to the future experience if a classifier used to classify experiences into classes labels the prior experience and the future experience with essentially the same class label.

In some embodiments, similarity between affective responses needs to be determined, e.g., in order to select the prior experience similar to the future experience. Computing such a similarity may be done in various ways. In one example, affective responses are represented by one or more values, such a scalar (e.g., heart-rate) or a vector (e.g., brainwave potentials). In such cases, computing similarity of affective responses may involve computing numerical difference between values. For example, similarity of heart rate may depend on the numerical difference between the values. Thus, two values of heart-rates that differ by 10 beats per minute may be more similar to each other than to heart rates that differ by 30 beats per minute. In another example, similarity between time series values of different EEG measurements may utilize various distance functions such as divergence or sum or squares in order to determine the similarity between the EEG measurements.

In one embodiment, affective responses are emotional responses represented as values in an emotional coordinate space (e.g., an arousal-valence space). In such a case, computing similarity of affective responses may be done using distance functions that operate on points in the emotional space (e.g., Euclidean distance or vector dot-product).

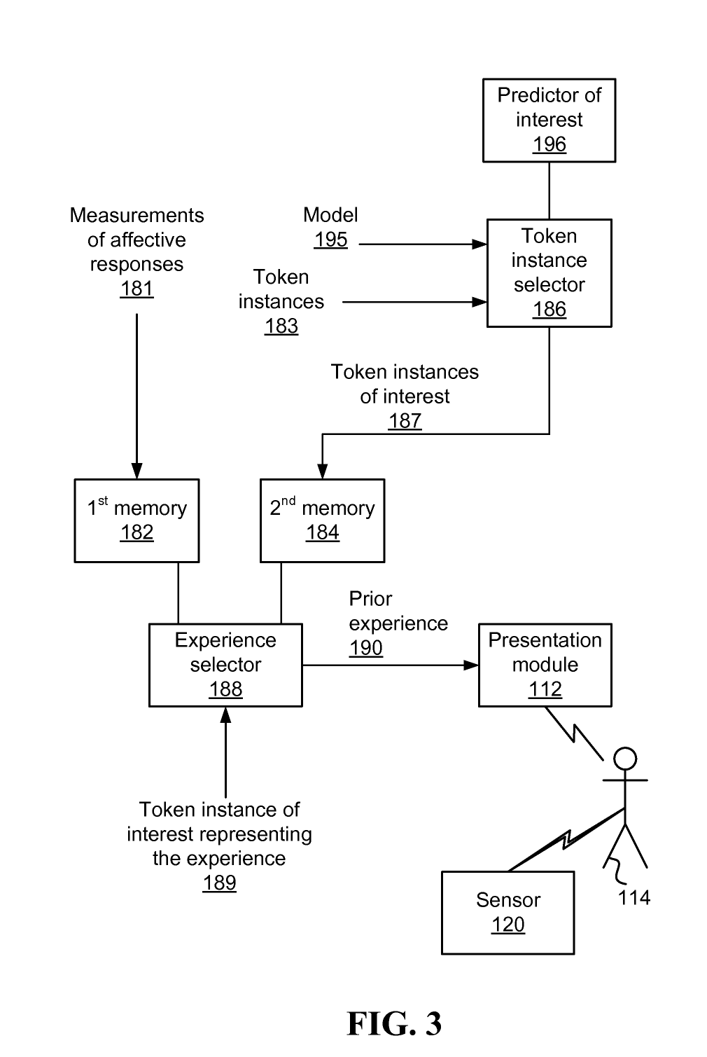

FIG. 3 illustrates one embodiment of a system configured to select a prior experience resembling an experience utilizing a model for a user. The experience may be an experience that the user 114 is experiencing at the time, or may experience in the future. For example, the experience may involve certain content the user 114 is consuming, an activity selected for the user by a software agent, or purchasing an item in a virtual store.

The system includes at least a first memory 182, a second memory 184, a token instance selector 186, and an experience selector 188. Optionally, the first memory 182 and the second memory 184 involve the same memory (e.g., both are part of memory belonging to the same server). Optionally, the token instance selector 186 and the experience selector 188 are realized in the same computer hardware (e.g., they are realized, at least in part, as programs running on the same processor). Optionally, the first memory 182 and/or the second memory 184 are coupled to the token instance selector 186 and/or the experience selector 188. For example, the memories belong to a server on which the token instance selector 186 and/or the experience selector 188 run. Optionally, at least one of the first memory 182 and the second memory 184 reside on a server that is remote of the user 114, such as a cloud-based server. Optionally, at least one of the token instance selector 186 and the experience selector 188 run on a server remote of the user 114, such as a cloud-based server.

The first memory 182 is configured to store measurements of affective responses 181 of the user 114 to prior experiences. Optionally, the measurements of affective responses 181 are received essentially as they are generated (e.g., a stream of values generated by a measuring device). Optionally, the measurements of affective responses 181 are received in batches (e.g., downloaded from a device or server), and the measurements of affective responses 181 may be stored at various durations after they occur (e.g., possibly hours or even days after they the affective responses occurred). Optionally, at least some of the measurements of affective responses 181 are obtained utilizing the sensor 120 which may be configured to measure a physiological value and/or a behavioral cue of the user 114.

The token instance selector 186 configured to receive a model 195 for the user 114 and token instances 183 representing the prior experiences. The token instance selector 186 is further configured to select, based on the model 195, token instances of interest 187, which are relevant to the user from among the token instances 183. In one embodiment, the second memory 184 is configured to store the token instances of interest 187 representing the prior experiences.

In some embodiments, a phrase like “token instance of interest” may refer to a token instance to which a user has, and/or is predicted to have, a certain response. Typically, token instances of interest are token instances to which the user has a stronger response than the response the user has to token instances that are not considered token instances of interest. For example, the lead actor in a scene may be represented by a token instance that is a token instance of interest, while an actor that is in the background in that scene and does not speak, may be represented by a token instance that is not a token instance of interest. Optionally, a token instance of interest captures attention of the user. For example, if the user gazes at an object for at least a certain amount of time, that object may be represented by a token instance that is a token instance of interest. Optionally, a token instance may be determined to be a token instance of interest based on models and/or algorithms that predict that the token instance is likely to capture attention of the user and/or evoke a certain response from the user.

In one embodiment, a token instance of interest is a token instance for which, with respect to an experience represented by the token instance of interest, a predicted attention level to the token instance of interest is the highest, compared to other token instances representing the experience. For example, given all token instances that represent the experience, the token instance of interest is the one that is predicted to capture the attention of the user while the user is having the experience. For example, the token instance of interest may represent the lead actor or performer in a video segment, a character controlled by the user in a video game, and/or an item for purchase displayed in the center of a webpage of an online store.

In one embodiment, a token instance of interest is a token instance for which, with respect to an experience represented by the token instance of interest, a measured attention level to the token instance of interest is the highest, compared to measured attention level to other token instances representing the experience. For example, given all token instances that represent the experience, the token instance of interest is the one that the user was measured to pay the most attention to. For example, the token instance of interest may correspond to an object that captured the gaze of the user for the largest duration of time, compared to objects in the same experience represented by other token instances.

In one embodiment, the token instance selector 186 is also configured to receive token instances representing the experience and to select from among them a token instance of interest 189 that represents the experience.

In one embodiment, the model 195 for the user includes token instances representing prior experiences of the user 114. For example, the model may include information indicating which prior experiences are represented by certain token instances, how many times a token instance represents prior experiences, and/or a weight of the token instances with respect to certain prior experiences (e.g., the weight may indicate how much a token instance is associated with a certain prior experience).

Based on the model 195, the token instance selector 186 may determine that at least some of the token instances 183 may be considered token instances of interest, and selects them to be the token instances of interest 187. In one example, based on the model 195, the token instances of interest 187 represents at least a predetermined number of prior experiences of the user, and as such are relevant to the user. Optionally, selecting a token instance of interest such that it represents at least a predetermined number of prior experiences, it is likely that the user will remember a prior experience that is represented by the token instance of interest. In another example, the model 195 may include important prior experiences. Optionally, if a token instance represents an important prior experience, it may be considered by the token instance selector 186 relevant for the user, and selected as a token instance of interest.

In one embodiment, the model 195 for the user 114 also indicates affective responses of the user 114 to at least some of the prior experiences. For example, it may indicate whether the user enjoyed the experiences or not. Optionally, the token instance selector 186 may consider a token instance that represents at least a predetermined number of prior experiences for which user 114 had a certain affective response, such as enjoyment, to be relevant for the user, and thus it may select the token instance to be a token instance of interest.

Herein a predetermined number refers to a number that is known a priori and/or that the logic for computing the number is known in advance.

The experience selector 188 is configured to select the prior experience 190 from among the prior experiences. Optionally, selecting the prior experience is done based on similarity between the token instance of interest 189 representing the experience and the token instances of interest 187 representing the prior experiences. Optionally, the experience selector 188 receives the token instance of interest 189 representing the experience from an external source. Alternatively, the token instance of interest 189 representing the experience may be selected by the token instance selector 186.

In one embodiment, the selection of the prior experience 190 is done such that there is a certain similarity between the prior experience 190 and the experience. In one embodiment, the selection may be done such that similarity between the token instance of interest 189 representing the experience and a token instance of interest representing the prior experience 190 is greater than similarity between the token instance of interest 189 and most of the token instances of interest 187 representing the prior experiences. That is, the similarity between the token instance of interest 189 and the token instance representing the prior experience 190 is, on average, greater than the similarity of the token instance of interest 189 and a randomly selected token instance of interest from among the token instances of interest 187. Additionally, the selection of the prior experience 190 is done such that magnitude of an affective response of the user to the prior experience 190 reaches a predetermined threshold. Optionally, the predetermined threshold is forwarded to the experience selector 188 prior to selection of the prior experience 190. Optionally, the predetermined threshold is set to a certain value such that the magnitude of the affective response of the user 114 to the prior experience reaching the predetermined threshold implies that there is a probability of more than 10% that the user 114 will remember the prior experience (e.g., when reminded of it). Herein, the terms “magnitude of an affective response” and “affective response” may be used interchangeably, and sentence such as “magnitude of an affective response reaches a predetermined threshold” may be shortened to “affective response reaches a predetermined threshold”.

In one embodiment, magnitude of the affective response the user has to the prior experience (or briefly, affective response the user has to the prior experience) may indicate how much the user is likely to remember the prior experience and/or if recollection of the prior experience is likely to resonate with the user. By comparing the measurement to the predetermined threshold it may be determined whether the user had a significant emotional response to the prior experience. If the threshold is reached, reminding the user of the prior experience may cause the user to have a recollection of the prior experience, and possibly lead to a certain emotional response due to the recollection. However, reminding the user of an experience to which the user did not have a noticeable emotional response (an experience for which a corresponding affective response measurement does not reach the threshold), is less likely to influence the user. Recalling the latter experience will probably not resonate with the user.

In one example, the predetermined threshold may correspond to a certain physiological state, such as a certain heart rate, a certain level of skin conductivity, or a certain pattern of brainwaves. If physiological measurements of the user indicate that the threshold values are met, such as the heart-rate of the user reaches the certain level, the skin conductivity of the user reaches the certain level of skin conductivity, or the user displayed the certain pattern of brainwaves, then the predetermined threshold may be considered reached. Optionally, the predetermined threshold may refer to a change in a physiological state, such as a certain increase in heart-rate (e.g., increase of 10%). If the change in the physiological is observed, then the predetermined threshold may be considered reached.

In another example, the predetermined threshold may correspond to a certain emotional state, such as a certain level of happiness, excitement, and/or anger. Optionally, the emotional state may be determined based on measurements of affective response, for example, using a measurement Emotional Response Predictor (measurement ERP) to determine an emotional response from measurements. Optionally, the emotional state may be determined from content the user is exposed to, for example, using a content Emotional Response Predictor (content ERP). Optionally, the emotional state may be determined based on reports of the user and/or analysis of communications of the user, such as by utilizing semantic analysis to determine expressions expressed in text. If the user is determined to have the certain emotional state corresponding to the predetermined threshold, such as the certain level of happiness, excitement, and/or anger, then the predetermined threshold may be considered reached. Optionally, the predetermined threshold may refer to a change in the emotional state of the user, and if an emotional response is observed corresponding to the change in emotional state, the predetermined threshold may be considered reached.

In one embodiment, the probability that a user will remember a prior experience after having a certain affective response may be determined empirically. For example, a system may track affective responses of the user to experiences (e.g., by measuring the user with a sensor), and determined for various magnitudes of affective response whether the user remembers the corresponding experience. For example, the system may detect from an expression of the user whether the user remembers the experience when it is mentioned to the user. Additionally or alternatively, the system may determine whether the user remembers the experience based on semantic analysis of communications of the user (e.g., is an experience mentioned a communication of the user), and/or from behavior of the user (e.g., does the user return to a restaurant in which the user had a bad meal).

In another embodiment, the probability that a user will remember a prior experience after having a certain affective response may be determined utilizing a predictor. For example, the predictor may be trained on data collected from the user 114 and/or other users. The data may indicate various factors such attributes related to the experience (e.g., the type of the experience), magnitude of affective response, time since the experience, and/or whether the user remembered the experience and/or to what extent the user remembered the experience. Whether or not the user remembers the experience and/or the extent to which the user remembers the experience may be determined by the user (e.g., when asked about the experience), and/or based on analysis of communications and/or behavior of the user. Those skilled in the art may recognize various approaches in which a predictor may be trained to predict probability a user remembers an experience. For example, a neural network may be trained for the task, and/or a classifier, such as a nearest neighbor classifier and/or a regression model.

In one embodiment, the system illustrated in FIG. 3 optionally includes a predictor 196 configured to receive token instances representing experiences, such as the token instances 183, and the model 195 for the user, and to predict interest in the token instances. Optionally, the token instance selector 186 is configured to utilize predictions of the predictor 196 to select the token instances of interest 187. Optionally, the predictor 196 receives the model 195 and/or the token instances representing experiences from the token instance selector 186. Additionally or alternatively, the predictor 196 may receive the token instances and/or the model 195 from another source. Optionally, the predictor 196 and the token instance selector 186 are realized by the same software module (e.g., the predictor is part of the token instance selector 186). Optionally, the predictor 196 operates as an external service utilized by the token instance selector 186.

In one embodiment, the model 195 includes token instances representing prior experiences of other users, interest levels of the other users in at least some of the token instances, and interest level of the user in at least some of the token instances. The predictor 196 is configured to utilize collaborative filtering methods to predict interest in at least some of the token instances representing the prior experiences. For example, the predictor 196 may find other users who have similar patterns of interest as the user 114 (as determined by the token instances of interest in the model 195) in order to predict interest of the user 114 in certain token instances for which there is no data on level of interest of the user 114. Those skilled in the can utilize various collaborative filtering algorithms to make the aforementioned predictions based on the aforementioned data.

In another embodiment, the model 195 includes parameters set by a training procedure that received training data that includes token instances representing experiences and interest levels in at least some of the token instances. The predictor 196 is configured to utilize the parameter values to predict interest level in at least some of the token instances representing the prior experiences. Optionally, the parameter values may corresponds to parameters utilized by various machine learning algorithms, such as a topology and weights for a neural network, support vectors for a support vector machine, or weights for a regression model. Optionally, interest levels in token instances included in the training data may be determined in various ways, such as measuring users (e.g., using eye tracking), from reports of the users (e.g., stating what interested them at the time), and/or from analysis of communications and/or behavior of users.

In one embodiment, the training data includes token instances representing experiences of the user 114 and interest levels of the user 114 in at least some of the token instances. Optionally, as such, the model 195 may be considered a personal model of the user 114.

In one embodiment, the predictor 196 is utilized to select the token instance of interest 189 that represents the experience. Optionally, the token instance of interest 189 representing the experience is the token instance for which a predicted interest is the highest, from among token instances representing the experience.

In one embodiment, the token instance of interest 189 representing the experience is stored in the second memory 184 and also represents the prior experience 190. In another embodiment, the token instance of interest 189 representing the experience and the token instance of interest that is stored in the second memory 184 and represents the prior experience 190 are instantiations of the same token. For example, they both may be different instantiations of a token corresponding to a certain actor, e.g., each appearance of the actor in a different movie is represented by a different instantiation of a token corresponding to the actor, with each token instance possibly having at least some different attribute values that correspond to the specific movie.

In one embodiment, the system illustrated in FIG. 3 optionally includes the presentation module 112 that is configured to present to the user 114 information related to the prior experience 190. This information may be presented in temporal proximity to when the user 114 needs to make a decision related to the experience, such as whether or not to participate in the experience.

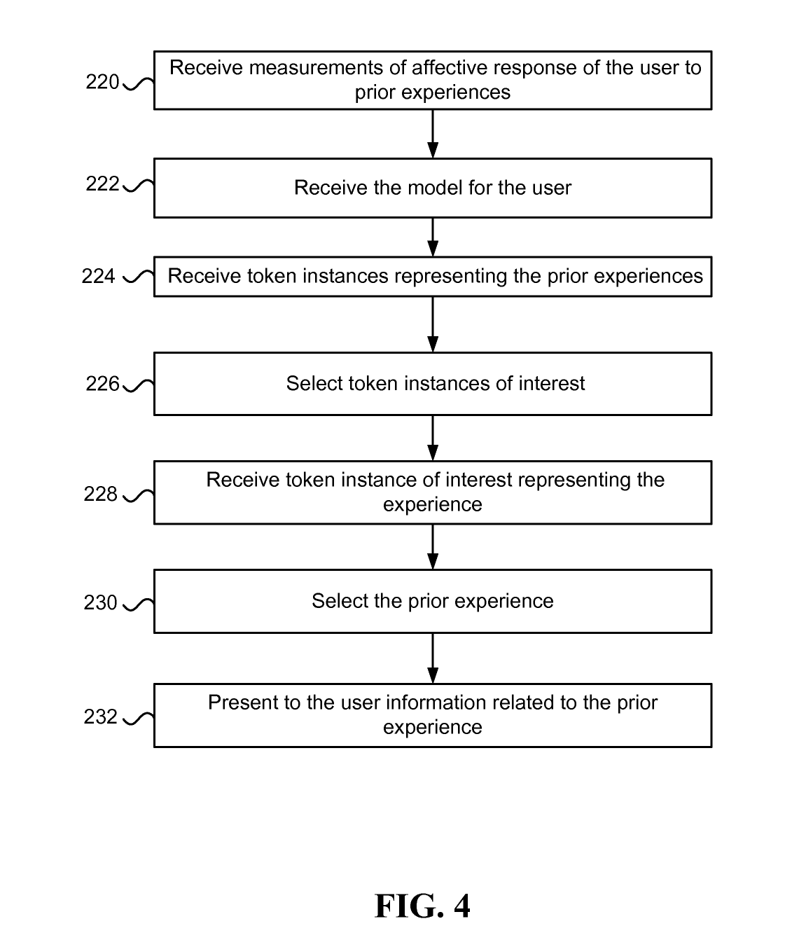

FIG. 4 illustrates one embodiment of a method for selecting a prior experience resembling an experience utilizing a model for a user. The method includes at least the following steps: In step 220, receiving measurements of affective responses of the user to prior experiences. In step 222, receiving the model for the user. In step 224, receiving token instances representing the prior experiences. In step 226, selecting, based on the model, token instances of interest, which are relevant to the user from among the token instances. In step 228, receiving a token instance of interest representing the experience. And. In step 230, selecting the prior experience from among the prior experiences such that an affective response of the user to the prior experience reaches a predetermined threshold. Additionally, similarity between the token instance of interest representing the experience and a token instance of interest representing the prior experience is greater than similarity between the token instance of interest representing the experience and most of the token instances of interest representing the prior experiences.

In one embodiment, the method illustrated in FIG. 4 optionally includes a step involving selecting the token instances of interest representing the prior experiences. Additionally or alternatively, the method illustrated in FIG. 4 may optionally include includes a step involving selecting the token instance of interest representing the experience.

In one embodiment, the method illustrated in FIG. 4 optionally includes a step involving receiving token instances representing an experience, and utilizing the model for the user to predict interest in the token instances.

In one embodiment, the model may include token instances representing prior experiences of other users, interest levels of the other users in at least some of the token instances, and interest level of the user in at least some of the token instances. The method illustrated in FIG. 4 may optionally include a step involving utilizing collaborative filtering methods for predicting interest in at least some of the token instances representing the prior experiences.

In another embodiment, the model may include parameters set by a training procedure that received training data that includes token instances representing experiences and interest levels in at least some of the token instances. The method illustrated in FIG. 4 may optionally include a step involving utilizing the parameter values to predict interest in at least some of the token instances representing the prior experiences.

In one embodiment, the method optionally includes step 232 which involves presenting to the user information related to the prior experience in temporal proximity to decision making, of the user, related to the experience. Optionally, the information related to the prior experience may include a description of the token instance of interest representing the prior experience. Optionally, the information related to the prior experience may include a description of details of the prior experience. Optionally, the information related to the prior experience may include a description of juxtaposition of the prior experience and the experience. Optionally, the information related to the prior experience may include a description of a measurement of affective responses of a user related to the prior experience.

In the embodiment, information related to the prior experience may be presented to the user for various reasons. In one example, the information related to the prior experience is presented to the user in order to explain selection of the experience for the user. In another example, the information related to the prior experience is presented to the user in order to trigger a discussion with the user regarding the experience. In yet another example, the information related to the prior experience is presented to the user in order to assist the user in formulating attitude of the user towards the experience. And in still another example, the information related to the prior experience is presented the user in order to imply to the user that affective response of the user to the experience is likely to be similar to affective response of the user to the prior experience.

In one embodiment, the method illustrated in FIG. 4 optionally includes a step involving measuring affective responses of the user to at least some of the prior experiences with a sensor.

In one embodiment, the method illustrated in FIG. 4 optionally includes a step involving forwarding the predetermined threshold to the experience selector prior to selecting the prior experience.

In one embodiment, the method illustrated in FIG. 4 optionally includes a step involving setting the predetermined threshold to a certain value such that the affective response of the user to the prior experience reaching the predetermined threshold implies that the probability that the user will remember the prior experience is more than 10%.

In one embodiment, a non-transitory computer-readable medium stores program code that may be used by a computer to select a prior experience resembling an experience utilizing a model for a user. The computer includes a processor, and the non-transitory computer-readable medium stores the following program code: Program code for receiving measurements of affective responses of the user to prior experiences. Program code for receiving the model for the user. Program code for receiving token instances representing the prior experiences. Program code for selecting, based on the model, token instances of interest, which are relevant to the user from among the token instances. Program code for receiving a token instance of interest representing the experience. And program code for selecting the prior experience from among the prior experiences such that an affective response of the user to the prior experience reaches a predetermined threshold. Additionally, similarity between the token instance of interest representing the experience and a token instance of interest representing the prior experience is greater than similarity between the token instance of interest representing the experience and most of the token instances of interest representing the prior experiences.

In one embodiment, the non-transitory computer-readable medium may optionally store program code for selecting the token instances of interest representing the prior experiences. Additionally or alternatively, the non-transitory computer-readable medium may optionally store program code for selecting the token instance of interest representing the experience.

In one embodiment, the non-transitory computer-readable medium may optionally store program code for receiving token instances representing an experience, and program code for utilizing the model for the user to predict interest in the token instances.

In one embodiment, the model includes token instances representing prior experiences of other users, interest levels of the other users in at least some of the token instances, and interest level of the user in at least some of the token instances. The non-transitory computer-readable medium may optionally store program code for utilizing collaborative filtering methods for predicting interest in at least some of the token instances representing the prior experiences.

In another embodiment, the model includes parameters set by a training procedure that received training data comprising token instances representing experiences and interest levels in at least some of the token instances. The non-transitory computer-readable medium may optionally store program code for utilizing the parameter values to predict interest in at least some of the token instances representing the prior experiences.

In one embodiment, the non-transitory computer-readable medium may optionally store program code for presenting to the user information related to the prior experience in temporal proximity to decision making, of the user, related to the experience.

In one embodiment, the non-transitory computer-readable medium may optionally store program code for measuring affective responses of the user to at least some of the prior experiences with a sensor.

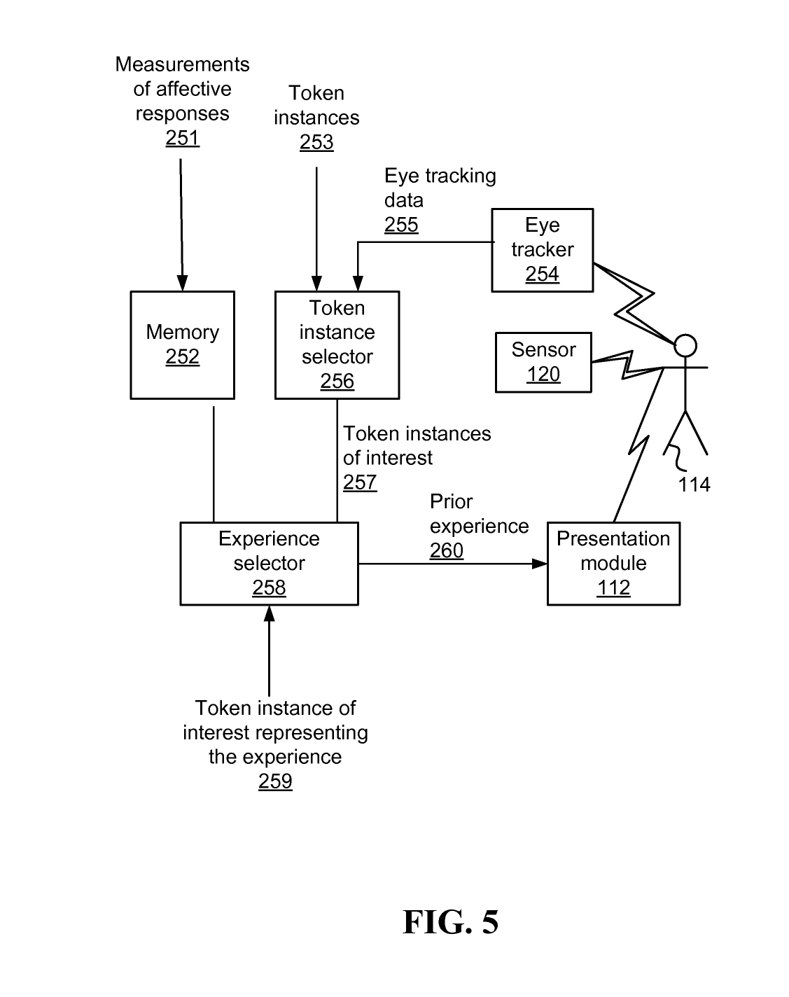

FIG. 5 illustrates one embodiment of a system configured to utilize eye tracking to select a prior experience similar to an experience. The system includes at least a memory 252, an eye tracker 254, a token instance selector 256, and an experience selector 258. Optionally, the token instance selector 256 and the experience selector 258 are realized in the same computer hardware (e.g., they are realized, at least in part, as programs running on the same processor). Optionally, the memory 252 is coupled to the token instance selector 256 and/or the experience selector 258. For example, the memory belongs to a server on which the token instance selector 256 and/or the experience selector 258 run. Optionally, the memory 252 resides on a server that is remote of the user 114, such as a cloud-based server. Optionally, at least one of the token instance selector 256 and the experience selector 258 run on a server remote of the user 114, such as a cloud-based server. Optionally, the eye tracker 254 runs, at least in part, on a remote server, such as a cloud-based server. Optionally, the eye tracker 254 utilizes software that is coupled to and/or part of the token instance selector 256. Alternatively, in some embodiments, the token instance selector 256 may be a module that is part of the eye tracker 254.

The memory 252 is configured to store measurements of affective responses 251 of the user 114 to prior experiences. Optionally, the measurements of affective responses 251 are received essentially as they are generated (e.g., a stream of values generated by a measuring device). Optionally, the measurements of affective responses 251 are received in batches (e.g., downloaded from a device or server), and the measurements of affective responses 251 may be stored at various durations after they occur (e.g., possibly hours or even days after they the affective responses occurred). Optionally, at least some of the measurements of affective responses 251 are obtained utilizing the sensor 120 which may be configured to measure a physiological value and/or a behavioral cue of the user 114.

The eye tracker 254 is configured to track gaze of the user 114 during the prior experiences and to generate corresponding eye tracking data 255. Optionally, the eye tracking data 255 indicates interest level of the user 114 in at least some of the token instances 253 which represent the prior experiences. Optionally, the eye tracker 254 utilizes a camera that is part of a device of the user 114. Optionally, the camera is coupled to the presentation module 112. Those skilled in the art may recognize that there are various types of eye tracking data that may be generated, as explained in more detail further below in this disclosure.

The token instance selector 256 is configured to receive token instances 253 representing the prior experiences and to select, based on the eye tracking data 255, token instances of interest 257 representing the prior experiences. Optionally, the token instance selector 256 is also configured to receive eye tracking data, generated by the eye tracker 254, corresponding to token instances representing the experience, and to select, from among the token instances representing the experience, a token instance of interest 259 representing the experience.

There may be various ways in which the token instance selector 256 utilizes the eye tracking data 255 in order to select the token instances of interest 257. In one embodiment, a token instance of interest selected by the token instance selector 256 is a token instance for which eye tracking data indicates that gaze of the user 114 towards an object represented by the token instance exceeds a predetermined duration. For example, when viewing a movie, if during a scene, the user 114 gazes for more than 2 seconds at an object, a token instance representing the object may be considered a token instance of interest.

In another embodiment, a token instance of interest selected by the token instance selector 256 is a token instance, from among the token instances representing the experience, for which eye tracking data indicates that duration of gaze of the user 114 towards the token instance is not shorter than duration of gaze of the user to any other token instance representing the experience. Thus, for example, in an experience that involves playing a video game, a token instance representing a character controlled by the user 114 is likely to be a token instance of interest since it is not likely that the user will spend more time gazing at other objects in the game.

In yet another embodiment, a token instance of interest selected by the token instance selector 256 is a token instance for which eye tracking data indicates that affective response of the user, as determined by pupil dilation, reaches a predetermined threshold. For example, if the user stares at an object and the pupils of the user dilate and their diameter increases by more than 10%, a token instance representing the object may be considered a token instance of interest.

The experience selector 258 is configured to select the prior experience 260 from among the prior experiences. Optionally, selecting the prior experience 260 is done based on similarity of the token instance of interest 259 representing the experience and the token instances of interest 257 representing the prior experiences. Optionally, the experience selector 258 receives the token instance of interest 259 representing the experience from an external source. Alternatively, the token instance of interest 259 representing the experience may be selected by the token instance selector 256.

In one embodiment, the selection of the prior experience 260 is done such that an affective response of the user 114 to the prior experience 260 reaches a predetermined threshold. Optionally, the predetermined threshold is forwarded to the experience selector 158 prior to selection of the prior experience 260. Optionally, the predetermined threshold is set to a certain value such that the affective response of the user 114 to the prior experience reaching the predetermined threshold implies that with a probability of more than 10% the user 114 will remember the prior experience (e.g., when reminded of it).

In one embodiment, the selection of the prior experience 260 is done such that there is a certain similarity between the prior experience 260 and the experience. In one embodiment, the selection may be done such that similarity between the token instance of interest 259 representing the experience and a token instance of interest representing the prior experience 260 is greater than similarity between the token instance of interest 259 and most of the token instances of interest 257 representing the prior experiences. That is, the similarity between the token instance of interest 259 and the token instance representing the prior experience 260 is, on average, greater than the similarity of the token instance of interest 259 and a randomly selected token instance of interest from among the token instances of interest 257.

In one embodiment, the token instance of interest 259 representing the experience also represents the prior experience 260. In another embodiment, the token instance of interest 259 representing the experience and the token instance of interest that represents the prior experience 260 are instantiations of the same token. For example, they both may be different instantiations of a token corresponding to a certain actor, e.g., each appearance of the actor in a different movie is represented by a different instantiation of a token corresponding to the actor, with each token instance possibly having at least some different attribute values that correspond to the specific movie.

In one embodiment, the system illustrated in FIG. 5 optionally includes the presentation module 112 that is configured to present to the user 114 information related to the prior experience 260. This information may be presented in temporal proximity to when the user 114 needs to make a decision related to the experience, such as whether or not to participate in the experience. Various types of information related to the prior experience 260 may be presented to the user 114. In one example, the information related to the prior experience 260 includes a description of the token instance of interest. In another example, the information related to the prior experience 260 includes a description of details of the prior experience. In yet another example, the information related to the prior experience 260 includes a description of juxtaposition of the prior experience and the experience. In still another example, the information related to the prior experience 260 includes a description of a measurement of affective responses of a user related to the prior experience.

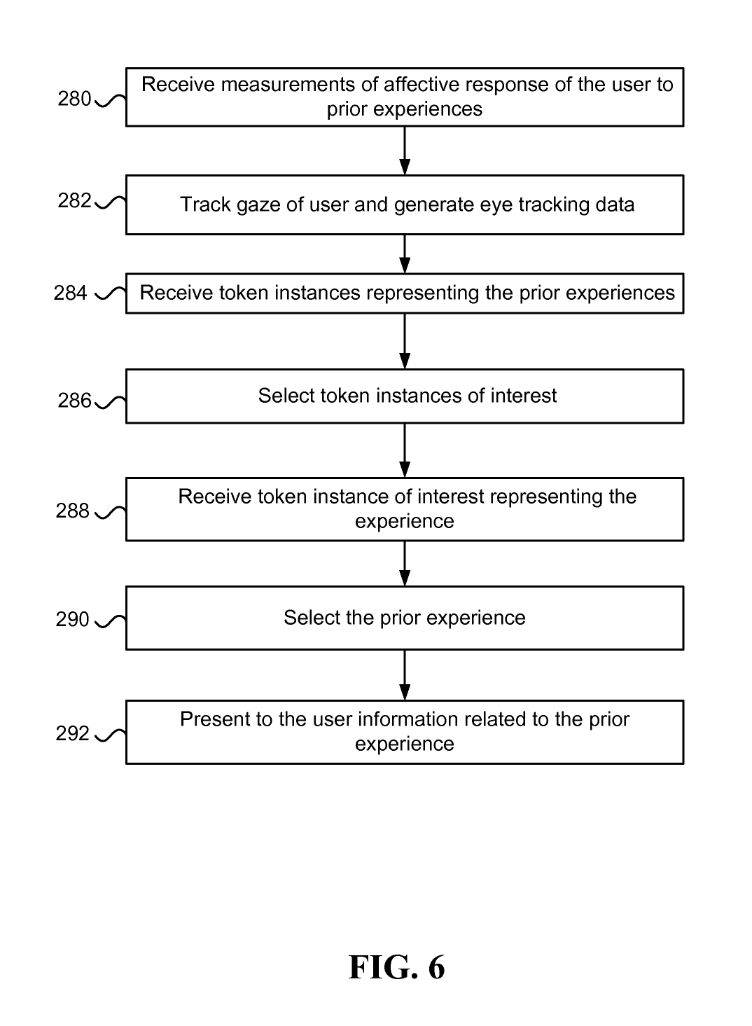

FIG. 6 illustrates one embodiment of a method for utilizing eye tracking to select a prior experience similar to an experience. The method includes at least the following steps: In step 280, receiving measurements of affective responses of a user to prior experiences. In step 282, tracking gaze of the user during the prior experiences and generating corresponding eye tracking data. In step 284, receiving token instances representing the prior experiences. In step 286, selecting, based on the eye tracking data, token instances of interest representing the prior experiences. In step 288, receiving a token instance of interest representing the experience. And in step 290, selecting the prior experience from among the prior experiences such that an affective response of the user to the prior experience reaches a predetermined threshold. Additionally, a similarity between the token instance of interest representing the experience and a token instance of interest representing the prior experience is greater than similarity between the token instance of interest representing the experience and most of the token instances of interest representing the prior experiences.

In one embodiment, the method illustrated in FIG. 6 optionally includes a step involving receiving eye tracking data corresponding to token instances representing the experience, and selecting, from among the token instances representing the experience, the token instance of interest representing the experience.

In one embodiment, the method optionally includes step 292 which involves presenting to the user information related to the prior experience in temporal proximity to decision making, of the user, related to the experience. Optionally, the information related to the prior experience may include a description of the token instance of interest representing the prior experience. Optionally, the information related to the prior experience may include a description of details of the prior experience. Optionally, the information related to the prior experience may include a description of juxtaposition of the prior experience and the experience. Optionally, the information related to the prior experience may include a description of a measurement of affective responses of a user related to the prior experience.

In one embodiment, the method illustrated in FIG. 6 optionally includes a step involving measuring affective responses of the user to at least some of the prior experiences with a sensor.

In one embodiment, the method illustrated in FIG. 6 optionally includes a step involving forwarding the predetermined threshold to the experience selector prior to selecting the prior experience.

In one embodiment, the method illustrated in FIG. 6 optionally includes a step involving setting the predetermined threshold to a certain value such that the magnitude of the affective response of the user to the prior experience reaching the predetermined threshold implies that with a probability of more than 10% the user will remember the prior experience (e.g., when reminded of it).

In one embodiment, a non-transitory computer-readable medium stores program code that may be used by a computer to utilize eye tracking to select a prior experience similar to an experience. The computer includes a processor, and the non-transitory computer-readable medium stores the following program code: Program code for receiving measurements of affective responses of a user to prior experiences. Program code for tracking gaze of the user during the prior experiences, and for generating corresponding eye tracking data. Program code for selecting, based on the eye tracking data, token instances of interest representing the prior experiences. Program code for receiving a token instance of interest representing the experience. And program code for selecting the prior experience from among the prior experiences such that an affective response of the user to the prior experience reaches a predetermined threshold. Additionally, a similarity between the token instance of interest representing the experience and a token instance of interest representing the prior experience, is greater than similarity between the token instance of interest representing the experience and most of the token instances of interest representing the prior experiences.

In one embodiment, the non-transitory computer-readable medium may optionally store program code for receiving eye tracking data corresponding to token instances representing the experience, and selecting, from among the token instances representing the experience, the token instance of interest representing the experience. In one embodiment, the non-transitory computer-readable medium may optionally store program code for presenting to the user information related to the prior experience in temporal proximity to decision making, of the user, related to the experience. In one embodiment, the non-transitory computer-readable medium may optionally store program code for measuring affective responses of the user to at least some of the prior experiences with a sensor. In one embodiment, the non-transitory computer-readable medium may optionally store program code for forwarding the predetermined threshold to the experience selector prior to selecting the prior experience. In another embodiment, the non-transitory computer-readable medium may optionally store program code for setting the predetermined threshold to a certain value such that the magnitude of the affective response of the user to the prior experience reaching the predetermined threshold implies that with a probability of more than 10% the user will remember the prior experience (e.g., when reminded of it).

In one embodiment, the experience selector selects a prior experience as the prior experience. The prior experience is selected because it is represented by a token instance that is the same as the token instance of instance representing the chosen experience, or essentially identical to it. Optionally, the token instance representing the prior experience is a token instance of interest representing the prior experience.

In one embodiment, the token instance representing the prior experience may be essentially identical to the token instance of interest representing the chosen experience. For example, there may be certain attributes that are different between the token instance representing the prior experience and the token instance of interest representing the chosen experience, e.g., they both represent the same character with different clothing or they represent different characters with very similar appearance and/or behavior. However, despite slight differences between the two, due to the token instance representing the prior experience being essentially identical to the token instance of interest representing the chosen experience, the affective response of the user to the two token instances is expected to be similar. Thus, by being essentially identical to the token instance representing the prior experience, the token instance of interest representing the chosen experience may also represent the prior experience.

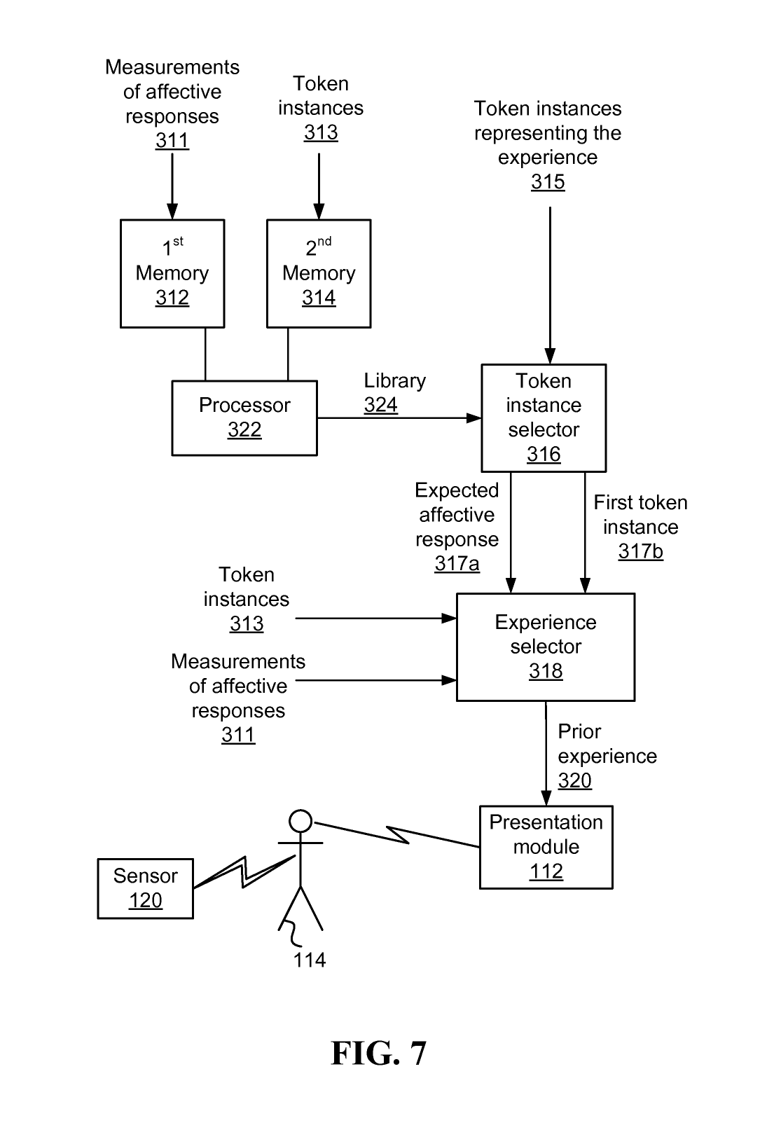

FIG. 7 illustrates one embodiment of a system configured to utilize a library that includes expected affective responses to token instances to select a prior experience relevant to an experience of a user. The system includes at least a token instance selector 316 and an experience selector 318. Optionally, the token instance selector 316 and the experience selector 318 are realized in the same computer hardware (e.g., they are realized, at least in part, as programs running on the same processor). Optionally, at least one of the token instance selector 316 and the experience selector 318 run on a server remote of the user 114, such as a cloud-based server.

In one embodiment, the experience represented by the token instances 315 (referred to herein as “the experience”) is an experience which the user may have in the future. Optionally, the experience is selected for the user by a software agent (e.g., a movie to watch, a chat room to join, a chore to complete). Alternatively, the experience may be an experience the user is already having or completed in the past, such as movie the user is watching, an item the user has purchased, or a chore the user is performing.

The token instance selector 316 is configured to receive token instances 315 representing the experience, and to utilize the library 324 to select from among the token instances 315, a first token instance 317b. Optionally, the library 324 indicates that expected affective response 317a to the first token instance 317b reaches a predetermined threshold. Optionally, the first token instance 317b is a token instance, selected from among token instances 315 representing the experience, which according to values in the library 324, is expected to cause highest magnitude of affective response.

In one embodiment, the predetermined threshold is forwarded to the experience selector 318 prior to selection of the prior experience 320. In another embodiment, the predetermined threshold is set to a certain value for which the fact that, according to the library 324, affective response 317a of the user to the first token instance reaches the predetermined threshold implies that with a probability of more than 10% the user will remember an experience represented by the first token instance (e.g., when reminded of it). Thus, the affective response 317a to the first token instance 317b may be considered significant, and there is a probability non-negligible probability that the user will remember details of the prior experience 320 if reminded of it. The experience selector 318 is configured to receive: token instances 313 representing prior experiences, and affective responses 311 of the user 114 to the prior experiences. Optionally, at least some of the affective responses 311 are measured utilizing the sensor 120. The experience selector 318 is also configured to select, from among the prior experiences, the prior experience 320. Optionally, the selection of the prior experience 320 is done so there is certain similarity between the prior experience 320 and the experience. Optionally, the similarity between the experiences is determined based on similarity of token instances representing the experiences and/or similarity of affective responses to the experiences. In some embodiments, having the prior experience 320 be similar to the experience both by virtue of similar token instances representing both and similar affective responses, increases the chance that the user will associate between the prior experience and the experience. This may help explain the selection of the experience for the user, trigger a discussion with the user regarding the experience, assist the user in formulating attitude of the user towards the experience, and/or imply to the user that affective response of the user to the experience is likely to be similar to affective response of the user to the prior experience 320.

In one embodiment, the prior experience 320 is selected such that similarity, between the first token instance 317b and a second token instance representing the prior experience 320, is greater than similarity between the first token instance 317b and most token instances 313 representing the prior experiences. That is, the similarity between the first token instance 317b and the second token instance representing the prior experience 320 is, on average, greater than a similarity of the first token instance 317b and a randomly selected token instance of interest from among the token instances 313. In one example, the first token instance 317b is essentially identical to the second token instance, and as such, the first token instance 317b may also represent the prior experience. In another example, the first token instance 317b and the second token instance are instantiations of the same token.

Additionally or alternatively, similarity between the expected affective response 317a to the first token instance 317b and an affective response of the user to the prior experience 320 is greater than similarity between the expected affective response 317a and most of the affective responses 311 of the user to the prior experiences. That is, the similarity between the expected affective response 317a to the first token instance 317b and the affective response of the user to the prior experience 320 is, on average, greater than a similarity of the expected affective response 317a and a randomly selected affective response to a prior experience from among the affective responses 311.

In another embodiment, experiences are represented as feature vectors that include values derived from token instances representing the experiences and/or affective responses to the features. Optionally, a vector representing the experience utilizes the affective response 317a to the first token instance 317a as the affective response to the experience for the purpose of constructing a feature vector representing the experience. The experience selector 318 may utilize various distance functions that operate on pairs of feature vectors in order to select the prior experience 320. For example, the distance functions may involve computation of Euclidean distance between pairs of vectors (e.g., the distance between the points they represent in a multi-dimensional space), and/or a function of the vectors such as the dot-product between a pair of vectors. In one example, the prior experience 320 is an experience for which a distance between a feature vector representation of the experience and a feature vector representation of the prior experience is below a threshold. Optionally, the distance between the pair of vectors is the smallest (and thus the similarity is the highest), from among all pairs of feature vectors that include a feature vector representation of the experience and a feature vector representation of a prior experience.

In one embodiment, the system illustrated in FIG. 7 may optionally includes a first memory 312 that is configured to store the affective responses 311 of the user 114 to the prior experiences, a second memory 314 that is configured to store the token instances 313 representing the prior experiences, and a processor 322 that is configured to utilize the stored affective responses and the stored token instances to create the library 324 of expected affective responses. Optionally, the library includes expected affective responses of the user to at least one of the stored token instances. For example the library 324 may include a list of tokens and/or token instances, and expected affective responses of the user 114 to the tokens and/or token instances.

In one embodiment, expected affective responses to tokens and/or token instances listed in the library may be implied by the presence of the tokens and/or token instances in the library. For example, a first library may contain primarily token instances for which the user is expected to have a strong positive affective response, while a second library may contain primarily token instances for which the user is expected to have a strong negative affective response. Thus, by virtue of knowing which library is used, the affective response may be implied, without the library specifying for each token instance its specific expected affective response.

In one embodiment, the library 324 includes expected affective responses of other users to tokens and/or token instances. For example, the library is generated from data related to other users (e.g., experiences of the other users and affective responses of the other users).

In one embodiment, the library 324 is generated from a model trained on data comprising at least some of the stored affective responses and at least some of the stored token instances. Optionally, parameters of the model are utilized to derive the expected affective response to at least one of the stored the token instances. Optionally, the model is a naive Bayes model, a regression model, a maximum entropy model, a neural network, or a decision tree. Additional details regarding constructing a library from a model are given further below in this disclosure.

In one embodiment, the library 324 may attribute affective responses to prior experiences to token instances of interest representing the prior experiences. For example, given an experience which is represented by a certain token instance of interest, the library 324 may attribute a certain portion, or essentially all of, the affective response to the experience to the certain token instance of interest. Thus, for example, when queried about the certain token instance of interest, the library 324 may return a certain portion, or essentially all of the affective response to the experience, as the expected affective response to the certain token instance of interest. Optionally, the certain token instance of interest is a token instance for which measured attention level of the user is highest from among token instances representing an experience. Optionally, the certain token instance of interest is a token instance for which predicted attention level is the highest, from among token instances representing an experience.

In one embodiment, the system illustrated in FIG. 7 optionally includes the presentation module 112 that is configured to present to the user 114 information related to the prior experience 320. This information may be presented in temporal proximity to when the user 114 needs to make a decision related to the experience, such as whether or not to participate in the experience. Various types of information related to the prior experience 320 may be presented to the user 114. In one example, the information related to the prior experience 320 includes a description of the first token instance 317b. In another example, the information related to the prior experience 320 includes a description of details of the prior experience 320. In yet another example, the information related to the prior experience 320 includes description of juxtaposition of the prior experience 320 and the experience. In still another example, the information related to the prior experience 320 includes description of a measurement of affective responses of a user related to the prior experience.

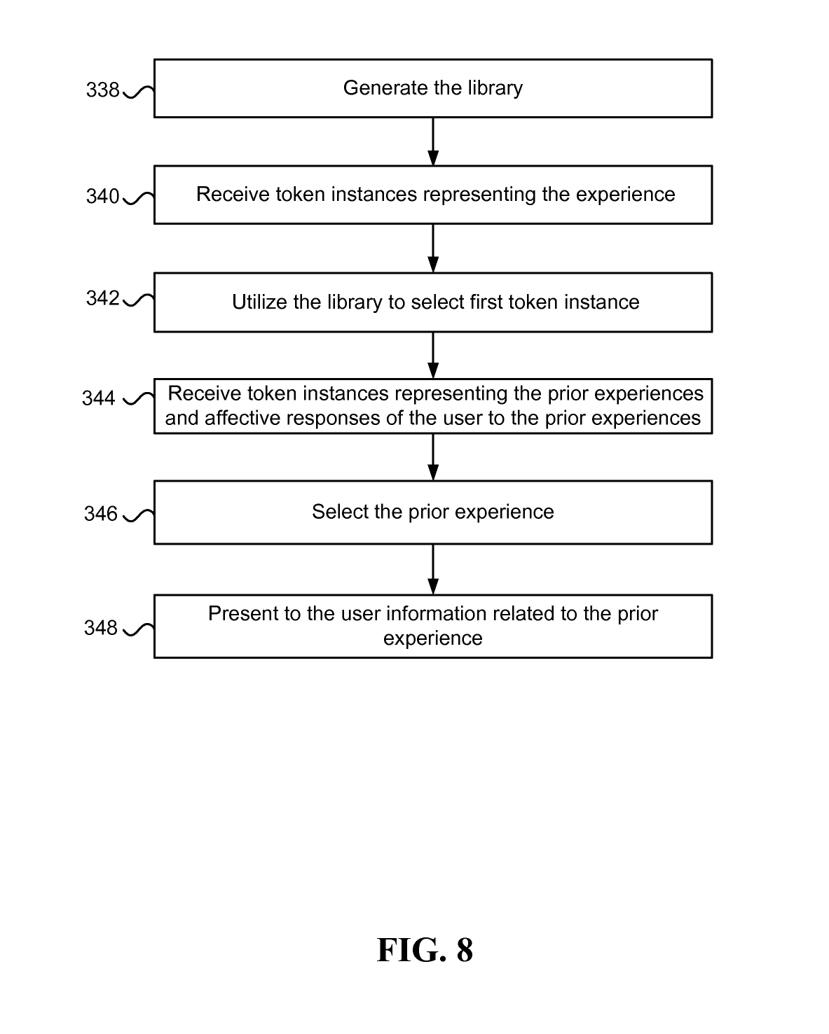

FIG. 8 illustrates one embodiment of a method for utilizing a library comprising expected affective responses to token instances to select a prior experience relevant to an experience of a user. The method includes at least the following steps: In step 340 receiving token instances representing the experience. In step 342, utilizing the library to select, from among the token instances representing the experience, a first token instance. Optionally, the library indicates that expected affective response to the first token instance reaches a predetermined threshold. In step 344, receiving token instances representing prior experiences and affective responses of the user to the prior experiences. And in step 346, selecting, from among the prior experiences, the prior experience. The selection is done so that similarity, between the first token instance and a second token instance representing the prior experience, is greater than similarity between the first token instance and most token instances representing the prior experiences. Additionally, similarity between the expected affective response to the first token instance and an affective response of the user to the prior experience is greater than similarity between the expected affective response and most of the affective responses of the user to the prior experiences.

In one embodiment, the method illustrated in FIG. 8 optionally includes step 338 involving generating the library by: receiving affective responses of a user to prior experiences, receiving token instances representing the prior experiences, and utilizing the affective responses and the token instances to create the library of expected affective responses. Optionally, the library includes expected affective responses of the user to at least one of the received token instances.

In one embodiment, the generating of the library involves training a model on data that includes at least some of the received affective responses and at least some of the received token instances. Optionally, parameters of the model are utilized to derive the expected affective response to at least one of the stored the token instances. Optionally, the model is a naive Bayes model, a regression model, a maximum entropy model, a neural network, or a decision tree.

In one embodiment, the method illustrated in FIG. 8 optionally includes a step that involves presenting to the user information related to the prior experience in temporal proximity to decision making, of the user, related to the experience. Optionally, the information related to the prior experience may include a description of the token instance of interest representing the prior experience. Optionally, the information related to the prior experience may include a description of details of the prior experience. Optionally, the information related to the prior experience may include a description of juxtaposition of the prior experience and the experience. Optionally, the information related to the prior experience may include a description of a measurement of affective responses of a user related to the prior experience.

In one embodiment, the method illustrated in FIG. 8 optionally includes a step that involves measuring affective responses of the user to at least some of the prior experiences with a sensor.

In one embodiment, the method illustrated in FIG. 8 optionally includes a step that involves receiving the predetermined threshold prior to selecting of the prior experience.

In one embodiment, a non-transitory computer-readable medium stores program code that may be used by a computer to utilize a library comprising expected affective responses to token instances to select a prior experience relevant to an experience of a user. The computer includes a processor, and the non-transitory computer-readable medium stores the following program code: Program code for receiving token instances representing the experience. Program code for utilizing the library to select, from among the token instances representing the experience, a first token instance. Optionally, the library indicates that expected affective response to the first token instance reaches a predetermined threshold. Program code for receiving token instances representing prior experiences and affective responses of the user to the prior experiences. And program code for selecting, from among the prior experiences, the prior experience, such that similarity, between the first token instance and a second token instance representing the prior experience, is greater than similarity between the first token instance and most token instances representing the prior experiences. Additionally, similarity between the expected affective response to the first token instance and an affective response of the user to the prior experience is greater than similarity between the expected affective response and most of the affective responses of the user to the prior experiences.

In one embodiment, the non-transitory computer-readable medium optionally stores program code for generating the library by: receiving affective responses of a user to prior experiences, receiving token instances representing the prior experiences, and utilizing the affective responses and the token instances to create the library of expected affective responses; wherein the library comprises expected affective responses of the user to at least one of the received token instances. In one embodiment, the non-transitory computer-readable medium optionally stores program code for presenting to the user information related to the prior experience in temporal proximity to decision making, of the user, related to the experience. In one embodiment, the non-transitory computer-readable medium optionally stores program code for measuring affective responses of the user to at least some of the prior experiences with a sensor. In one embodiment, the non-transitory computer-readable medium optionally stores program code for receiving the predetermined threshold prior to selecting of the prior experience. Optionally, the predetermined threshold is set to a certain value such that the reaching the predetermined threshold by the expected affective response of the user to the first token instance implies that with a probability of more than 10% the user will remember an experience that is represented by the first token instance.

In one embodiment, a system configured to select a prior experience relevant to a user includes at least the token instance selector 316 and the experience selector 318. In this embodiment, the token instance selector 316 configured to receive token instances representing an experience relevant to a user, and to utilize a library to select, from among the token instances, a first token instance to which affective response of the user is expected to be significant. For example, the expected affective response to the first token instance reaches a predetermined threshold. Optionally, the library includes token instances and their expected affective responses relevant to the user.

Additionally, in this embodiment, the experience selector 318 is configured to receive token instances representing prior experiences relevant to the user. The experience selector 318 is also configured to select the prior experience from among the prior experiences based on the library. Optionally, the prior experience is represented by a second token instance that is more similar to the first token instance than most of the token instances representing the other prior experiences, and the library indicates that expected affective response to the second token instance, which is relevant to the user, reaches a predetermined threshold. Optionally, the fact that the magnitude reaches the predetermined threshold implies that with a probability of more than 10% the user remembers the prior experience.

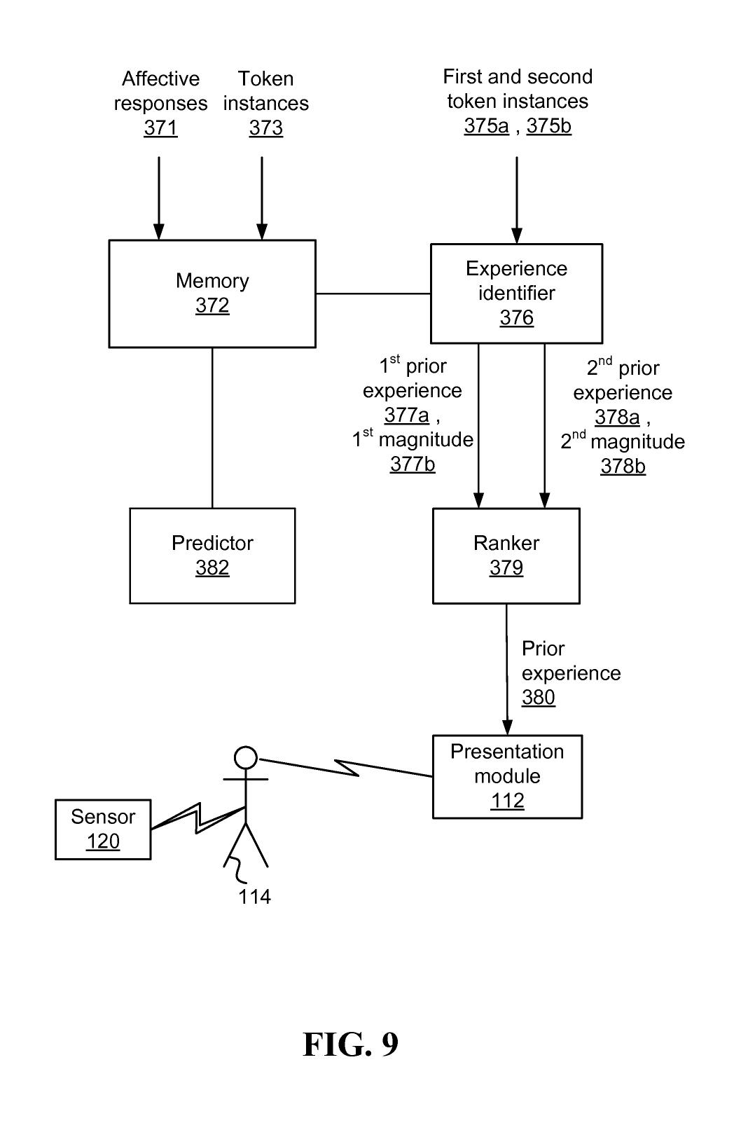

FIG. 9 illustrates one embodiment of a system configured to rank experiences for a user based on affective responses to prior experiences. The system includes at least a memory 372, an experience identifier 376, and a ranker 379. Optionally, the experience identifier 376 and the ranker 378 are realized in the same computer hardware (e.g., they are realized, at least in part, as programs running on the same processor). Optionally, the memory 372 belongs to computer hardware on which the experience identifier 376 and/or the ranker 378 run.

In one embodiment, the experience identifier 376 and/or the ranker 378 run on a server that is remote of the user 114, such as a cloud-based server. Optionally, the memory 372 also belongs to the server.

In another embodiment, experience identifier 376 and/or the ranker 378 run on a device that belongs to the user 114, such as a mobile and/or wearable computing device. Optionally, the memory 372 belongs to the device. Optionally, the presentation module 112 belongs to the device.

The memory 372 is configured to store token instances 373 representing prior experiences relevant to the user 114. Optionally, at least some of the token instances 373 are stored as the prior experiences occur. For example, token instances representing a conversation the user 114 is having are generated within a few seconds as the conversation takes place by algorithms that employ speech recognition and semantic analysis, and are conveyed to the memory 372 essentially as they are generated. Alternatively or additionally, at least some of the token instances 373 may be stored before or after the experiences take place. For example, token instances representing a movie may be downloaded from a database prior to when the user views the movie (or sometime after the movie was viewed).

In one embodiment, at least some of the prior experiences are of the user 114. For example, at least some of the prior experiences were experienced by the user 114. Additionally or alternatively, at least some of the prior experiences are relevant to the user. Optionally, the prior experiences may include experiences that are expected to be relevant to the user according to a predetermined model describing users that behave similarly. For example, if there are other users who have similar profiles to the user 114, and those profiles include indications of certain experiences that the other users had, then those certain experiences may be considered relevant to the user 114. Optionally, at least some of the prior experiences may be considered relevant to the user 114 if they were also experienced my people related to the user 114, such as direct social network friends of the user 114, such as people that are Facebook™ friends of the user 114.

In some embodiments, the memory 372 may also stores affective responses 371 to the prior experiences. Optionally, at least some of the affective responses 371 are affective responses of the user. Optionally, the measurements of affective responses 371 are received essentially as they are generated (e.g., a stream of values generated by a measuring device). Optionally, the measurements of affective responses 371 are received in batches (e.g., downloaded from a device or server), and the measurements of affective responses 371 may be stored at various durations after they occur (e.g., possibly hours or even days after they the affective responses occurred). Optionally, at least some of the measurements of affective responses 371 are obtained utilizing the sensor 120 which may be configured to measure a physiological value and/or a behavioral cue of the user 114.

In one embodiment, the memory 372 includes information that enables linkage between the affective responses 371 and the token instances 373, so for at least some of the prior experiences it is possible to determine both the affective response to an experience and which token instances represent the experience.

The experience identifier 376 may be utilized, in some embodiments, to identify similar experiences. In particular, given a certain experience, the experience identifier 376 may be used to identify a prior experience that resembles it. Optionally, the experience identifier 376 detects similarity of experiences based on similarity of token instances representing the experiences. Optionally, identifying a prior experience involves providing a description of the prior experience, such as a code identifies it, a file in which information related to the prior experience is stored, and/or one or more token instances that represent the prior experience.

In one embodiment, the experience identifier 376 is configured to receive a first token instances 375a representing a first experience and a second token instance 375b representing a second experience. The experience identifier 376 is also configured to identify, from among the prior experiences, a first prior experience 377a represented by a third token instance that is more similar to the first token instance 375a than most of the token instances representing the other prior experiences. The first prior experience 377a is associated with a first affective response with a first magnitude 377b that reaches a first predetermined threshold. Additionally, the experience identifier 376 is configured to identify, from among the prior experiences, a second prior experience 378a represented by a fourth token instance that is more similar to the second token instance 375b than most of the token instances representing the other prior experiences. The second prior experience 378a is associated with a second affective response which has a second magnitude 378b that does not reach a second predetermined threshold. The fact that the second magnitude 378b does not reach the second predetermined threshold implies that the user 114 is less likely to remember the second prior experience 378a than the user 114 is likely to remember the first prior experience 377a. Optionally, the first magnitude 377b is a magnitude of an affective response of the user 114 to the first prior experience 377a. Optionally, the second magnitude 378b is a magnitude of an affective response of the user 114 to the second prior experience 378a.

In one embodiment, the first predetermined threshold and the second predetermined threshold are the same threshold. For example, every affective response either reaches both the first and second predetermined thresholds, or does not reach the first and second predetermined thresholds. Alternatively, the first and second predetermined thresholds may be different thresholds. For example, they may utilize different threshold values that may depend on various factors such as characteristics of the first and/or second prior experiences, such as token instances representing the first and/or second prior experiences. Thus, in some cases, a certain affective response may reach the first predetermined threshold but not the second predetermined threshold, or vice versa.

In one embodiment, the fact that an affective response of a user to a prior experience reaches a predetermined threshold indicates that the prior experience might have resonated with the user. Thus, when reminded of the prior experience, such as when information related to the prior experience is presented to the user, recollecting the prior experience may assist the user in understanding and/or dealing with another, similar, experience. For example, presenting information related to the prior experience to the user may help explain selection of a new experience for the user (e.g., a selection by of an experience for the user by a software agent). In another example, presenting the information related to the prior experience to the user may trigger a discussion with the user regarding a new experience, such as a discussion with a software agent suggesting the new experience to the user. In yet another example, presenting the information related to the prior experience to the user may assist the user in formulating attitude of the user towards the new experience. In still another example, presenting the information related to the prior experience to the user may imply to the user that affective response of the user to a new experience is likely to be similar to affective response of the user to the prior experience; this may encourage the user to start or follow through the new experience—if an affective response to the prior experience was positive, or alternatively, this may discourage the user from starting or continuing with a new experience—if an affective response to the prior experience was negative.

The ranker 379 is configured to rank experiences according to their relevance to users. Optionally, the ranking is done by providing a score to experiences which indicates their relevance (e.g., the higher the score the more relevant the experiences is considered to be). Additionally or alternatively, the ranker 379 may rank experiences by assigning them an order, such as an order in a queue; for example, the closer an experience is to the head of the queue, the more relevant it may be considered. Additionally or alternatively, the ranker 379 may rank experiences by removing experiences from consideration that are deemed less relevant, and/or remove experiences whose relevance is below a threshold. Thus, in this case, experiences that still remain for consideration after ranking may be deemed more relevant, by virtue of not being removed.

In one embodiment, the ranker 379 determines relevance of a certain experience based on whether there exists a prior experience, which is similar to the experience, and to which an affective response of the user reaches a predetermined threshold. Optionally, having an affective response to the prior experience reach the predetermined threshold indicates that the user is likely to remember the prior experience. Thus, if need arises, mentioning to the user information related to the prior experience may assist the user with dealing with the certain experience, since the user is more likely to remember it and/or since the prior experience is more likely to resonate with the user. If an additional experience does not have a prior experience that is similar to it, and to which an affective response of the user reaches a predetermined threshold, then the additional experience may be deemed less relevant to the user, since there is no prior experience that can be recalled to help the user deal with the additional experience.

In one embodiment, the ranker 379 receives indications of prior experiences, such as identifiers of the prior experiences, descriptions of the prior experiences, and/or token instances representing the prior experiences. Additionally, the ranker 379 receives affective responses to the prior experiences, such as magnitudes of the affective responses to the prior experiences and/or indications of whether the affective responses to the prior experiences reach predetermined thresholds.

In one embodiment, the ranker 379 is configured to rank, based on the first magnitude 377b and the second magnitude 378b, the first prior experience 377a as more relevant than the second prior experience 378a for the user 114. Optionally, the first prior experience 377a is ranked more relevant than the second prior experience 378a since the first magnitude 377b reaches the first predetermined threshold, and as such is more likely to be remembered by the user 114; since the second magnitude 378b does not reach the second predetermined threshold, it is less likely to be remembered by the user 114.

In one embodiment, the system illustrated in FIG. 9 optionally includes a presentation module 112 that is configured to present to the user 114 information related to the first prior experience 377a. This information may be presented in temporal proximity to when the user 114 needs to make a decision related to the first prior experience 377a.

In one embodiment, the system illustrated in FIG. 9 optionally includes a predictor 382 of affective response configured to receive at least some token instances representing the prior experiences, and to predict affective responses to at least some of the prior experiences. Optionally, the predictor 382 of affective response utilizes a model of the user 114, trained on data comprising experiences described by token instances and measured affective response of the user 114 to the experiences, to predict affective responses of the user 114 to at least some of the prior experiences. Optionally, the predictor 382 of affective response utilizes a model trained on data comprising experiences described by token instances and measured affective responses of other users to the experiences, to predict the predicted affective responses to the prior experiences.

In one embodiment, at least some of the affective responses to prior experiences that are stored in the memory 372, are predicted by the predictor 382 based on at least some of the token instances 373. Additionally, the predictor 382 may be, and/or may utilize, in some embodiments, a content Emotional Response Predictor (content ERP) in the process of making its predictions.

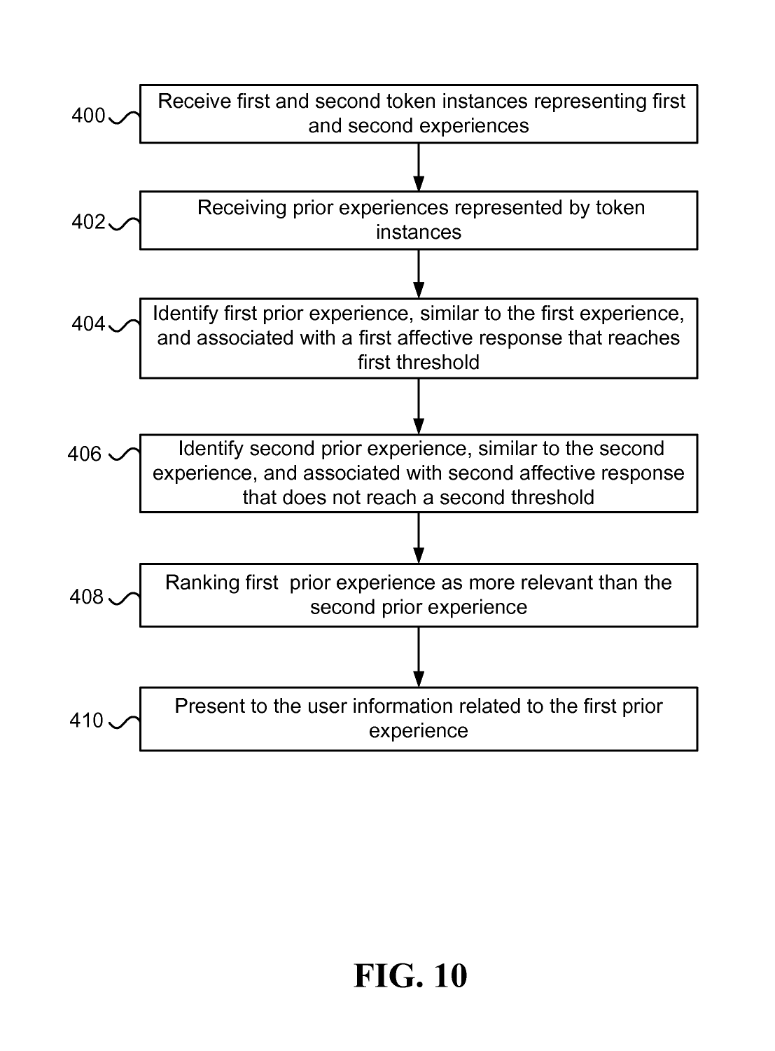

FIG. 10 illustrates one embodiment of a method for ranking experiences for a user based on affective response to prior experiences. The method includes at least the following steps:

In step 400, receiving first and second token instances representing first and second experiences, respectively. That is, the first token instance represents the first experience and the second token instance represents the second experience. Optionally, the first token instance is a token instance for which measured attention level of the user is highest, compared to attention level to other token instances representing the first experience. Optionally, the first token instance is a token instance for which predicted attention level is the highest, compared to attention level predicted for other token instances representing the first experience.

In step 402, receiving prior experiences relevant to the user, which are represented by token instances. For example, the prior experiences may include experiences that are expected to be relevant to the user according to a predetermined model describing users that behave similarly, and/or the prior experiences may be considered relevant to the user if they were also experienced my people related to the user such as a friend or acquaintance.

In step 404, identifying, from among the prior experiences, a first prior experience represented by a third token instance that is more similar to the first token instance than most of the token instances representing the other prior experiences. That is, on average, the third token instance is more similar to the first token instance than it is to a randomly selected token instance representing a randomly selected prior experience. Optionally, this fact implies that the first experience is more similar to the first prior experience than to a randomly selected prior experience. Additionally, the first prior experience is associated with a first affective response that reaches a first predetermined threshold. Optionally, the first predetermined threshold is set to a certain value for which the fact that the first affective response reaches the first predetermined threshold implies that the user is likely to remember the first prior experience with probability of more than 10%.

In step 406, identifying, from among the prior experiences, a second prior experience represented by a fourth token instance that is more similar to the second token instance than most of the token instances representing the other prior experiences. That is, on average, the fourth token instance is more similar to the second token instance than a randomly selected token instance representing a randomly selected prior experience. Optionally, this fact implies that the second experience is more similar to the second prior experience than it is to a randomly selected prior experience. Additionally, the second prior experience is associated with a second affective response that does not reach a second predetermined threshold. Optionally, the first predetermined threshold and the second predetermined threshold are the same threshold. Optionally, the second predetermined threshold is set to a certain value for which the fact that the second affective response does not reach the second predetermined threshold implies that there is a probability of more than 10% that the user remembers the second prior experience.

And in step 408, ranking the first experience as more relevant than the second experience for the user based on the first and second magnitudes. Optionally, the ranking is done by providing the first experience a higher relevance score than the second experience, and/or placing the first experience ahead of the second experience in a priority queue.

In one embodiment, the method optionally includes step 410 involving presenting to the user information related to the first experience.

In one embodiment, the method illustrated in FIG. 10 optionally includes a step that involves receiving affective responses to the prior experiences of the user. Optionally, the affective responses are stored in the memory 372. Optionally, affective responses to the prior experiences of the user are affective responses of the user 114 to the prior experiences. For example, the user 114 experienced the prior experiences and affective response measurements of the user 114 were taken at that time. Optionally, the affective responses to the prior experiences of the user 114 are, at least in part, affective responses of other users to experiences that may be similar to prior experiences of the user 114.

In one embodiment, the method illustrated in FIG. 10 optionally includes a step that involves receiving at least some token instances representing the prior experiences, and predicting affective responses to at least some of the prior experiences. Optionally, for predicting the affective responses of the user to the at least some of the prior experiences is done by utilizing a model of the user, trained on data comprising experiences described by token instances and measured affective response of the user to the experiences. Optionally, predicting the affective responses to the at least some of the prior experiences is done utilizing a model trained on data comprising experiences described by token instances and measured affective responses of other users to the experiences.

In one embodiment, the method illustrated in FIG. 10 optionally includes a step that involves measuring, utilizing a sensor, affective responses of the user to at least some of the experiences of the user. Optionally, the sensor 120 is used to measure at least some of the affective responses.

In one embodiment, the method illustrated in FIG. 10 optionally includes a step that involves forwarding the first predetermined threshold prior to performing the ranking, and/or forwarding the second predetermined threshold prior to performing the ranking.

In one embodiment, a non-transitory computer-readable medium stores program code that may be used by a computer to rank experiences for a user based on affective response to prior experiences. The computer includes a processor, and the non-transitory computer-readable medium stores the following program code: Program code for receiving first and second token instances representing first and second experiences, respectively. Program code for receiving prior experiences relevant to the user, which are represented by token instances. Program code for identifying, from among the prior experiences, a first prior experience represented by a third token instance that is more similar to the first token instance than most of the token instances representing the other prior experiences. Optionally, the first prior experience is further associated with a first affective response that reaches a first predetermined threshold. Program code for identifying, from among the prior experiences, a second prior experience represented by a fourth token instance that is more similar to the second token instance than most of the token instances representing the other prior experiences. Optionally, the second prior experience is further associated with a second affective response that does not reach a second predetermined threshold; whereby the fact that the second magnitude does not reach the second predetermined threshold implies that the user is less likely to remember the second prior experience than the user is likely to remember the first prior experience. And program code for ranking the first experience as more relevant than the second experience for the user based on the first and second magnitudes. Optionally, the program code for ranking includes program code for providing the first experience a higher relevance score than the second experience, and/or program code for placing the first experience ahead of the second experience in a priority queue.

In one embodiment, the non-transitory computer-readable medium may optionally store program code for presenting to the user information related to the first prior experience.

In one embodiment, the non-transitory computer-readable medium may optionally store program code for storing affective responses to the prior experiences of the user. Optionally, the affective responses are affective responses of the user to prior experiences of the user.

In one embodiment, the non-transitory computer-readable medium may optionally store program code for receiving at least some token instances representing the prior experiences, and for predicting affective responses to at least some of the prior experiences. Optionally, the program code predicting the affective responses of the user to the at least some of the prior experiences includes program code for utilizing for the predicting a model of the user, trained on data comprising experiences described by token instances and measured affective response of the user to the experiences. Optionally, the program code predicting the affective responses of the user to the at least some of the prior experiences includes program code for utilizing for the predicting a model trained on data comprising experiences described by token instances and measured affective responses of other users to the experiences.

In one embodiment, the non-transitory computer-readable medium may optionally store program code for measuring, utilizing a sensor, affective responses of the user to at least some of the experiences of the user.

In one embodiment, the non-transitory computer-readable medium may optionally store program code for forwarding the first predetermined threshold to the experience selector prior to performing the ranking.

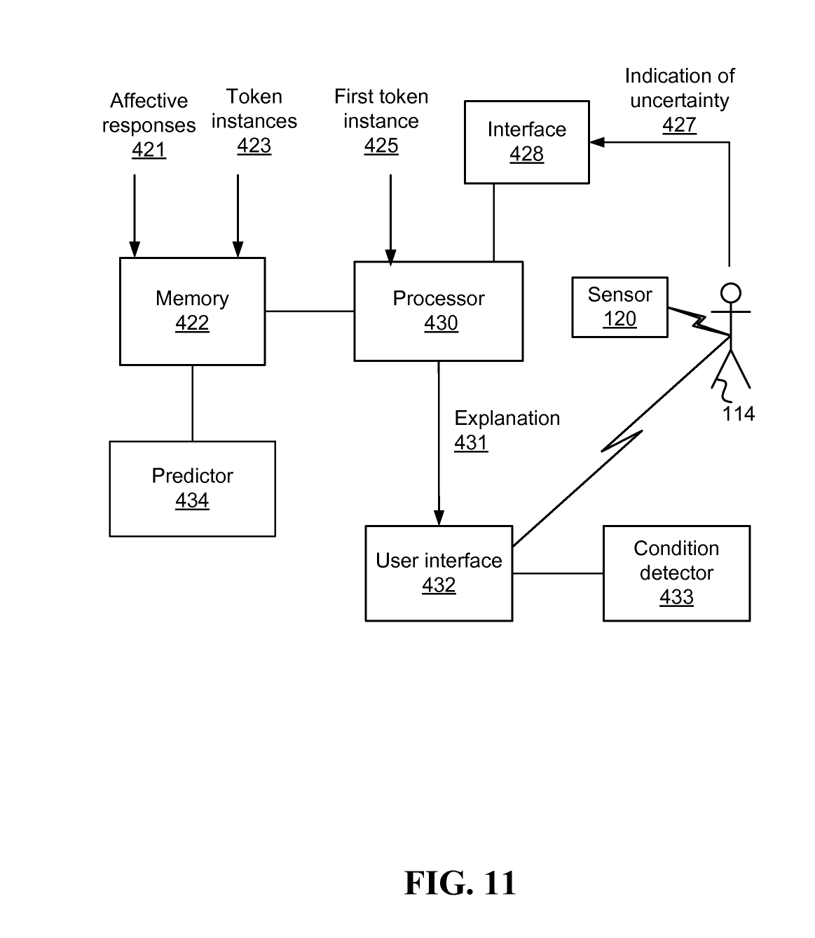

FIG. 11 illustrates one embodiment of a system configured to respond to uncertainty of a user regarding an experience. For example, the experience may involve certain content for consumption by the user, an activity for the user to participate in, and/or an item for purchase for the user. The system includes at least an interface 428, a memory 422, a processor 430, and a user interface 432. Optionally, the interface 428 and/or the memory belong to a device to which the processor 430 also belongs. Optionally, the device is a remote computing server, such as a cloud-based server. Optionally, the user interface 432 belongs to the same device the processor 430 belongs to, e.g., the device may be a mobile computing device, such as a smartphone or a wearable computer.

The interface 428 is configured to receive an indication of uncertainty 427 of the user 114 regarding the experience. Optionally, the interface receives a measurement of a sensor that measures the user 114 in order to determine the uncertainty of the user 114.

In one example, a camera may record an image of the user making a facial expression that indicates ambivalence in temporal proximity to being presented with the experience and/or being reminded of the experience. Optionally, the indication of uncertainty 427 is generated by facial analysis software that identifies expressions and/or facial micro-expressions. Optionally, the analysis software runs on the processor 430. Alternatively or additionally, the analysis software may run on a remote server, such as a cloud-based server, and/or run on a device of the user, such as a device that presents the user with content.

In another example, the indication of uncertainty 427 may be generated based on a communication of the user 114, such as a textual communication (e.g., email, SMS, or status update on a social network) and/or a verbal communication, such as the user 114 making a comment to another person and/or to a computer (e.g., to a software agent of the user 114). Optionally, the indication of uncertainty 427 is generated utilizing semantic analysis methods to determine a subject of a communication of the user 114 and/or attitude of the user 114 towards the experience.

In yet another example, the indication of uncertainty 427 may be generated based on an affective response measurement of the user 114 taken in temporal proximity to when the user 114 is reminded about the experience and/or is expected to act regarding the experience (e.g., take a certain action to start the experience). Optionally, the affective response measurement is taken by the sensor 120. For example, the sensor 120 may include an EEG sensor measuring brainwave potentials, a heart-rate monitor, and/or a monitor of Galvanic skin Response (GSR).

In still another example, the indication of uncertainty 427 may be derived from actions, or lack of actions, of the user 114. For example, if the user is prompted to make a choice regarding an experience (e.g., start playing a game), and the user neither starts the game, nor cancels the game, then the indication of uncertainty 427 may be generated. In another example, hesitation of the user 114, as detected for example from jittering of a finger of the user 114 on a touch screen, may be a cause for generating the indication of uncertainty 427.

The memory 422 is configured to store token instances 423 representing prior experiences relevant to the user 114, and to store affective responses 421 to the prior experiences. Optionally, at least some of the token instances 423, and/or some of the affective responses 421, are stored as the prior experiences occur. For example, token instances representing a conversation the user 114 is having are generated within a few seconds as the conversation takes place by algorithms that employ speech recognition and semantic analysis, and are conveyed to the memory 422 essentially as they are generated. Alternatively or additionally, at least some of the token instances 423 may be stored before or after the experiences take place. For example, token instances representing a movie may be downloaded from a database prior to when the user views the movie (or sometime after the movie was viewed). In another example, affective responses 421 are downloaded periodically from a device of the user 114, and stored in the memory 422 which may be located remotely of the user 114.

In one embodiment, the memory 422 may comprise multiple memory cells, located in different locations. Thus, though physically dispersed, the memory 422 may be considered a single logical entity.

The processor 430 is configured to receive a first token instance 425 representing the experience for the user 114. The processor 430 is further configured to identify a prior experience, from among the prior experiences, which is represented by a second token instance that is more similar to the first token instance 425 than most of the token instances representing the other prior experiences. Thus, in a sense, the prior experience may be considered more similar to the experience, than a randomly selected prior experience. Additionally, an affective response to the prior experience reaches a predetermined threshold. Optionally, the fact that the affective response reaches the predetermined threshold implies that there is a probability of more than 10% that the user 114 remembers the prior experience.

In one embodiment, the second token instance is a token instance for which a measured attention level of the user 114 is highest, compared to attention level to other token instances representing the prior experience. For example, the second token instance may represent an object in content (e.g., an actor in a movie), and attention level of the user 114 may be measured utilizing an eye tracker.

In another embodiment, the second token instance is a token instance for which predicted attention level is the highest, compared to attention level predicted for other token instances representing the prior experience. Further below in this disclosure are examples of algorithmic approaches that may be utilized to predict attention levels to token instances.

The processor 430 is also configured to generate an explanation 431 regarding relevance of the experience to the user based on the prior experience. Optionally, the explanation may comprise a comment by the system for the user 114, and/or may include description of the prior experience.

In one embodiment, the explanation 431 of relevance is based on at least one of the first and second token instances. For example, it includes information describing the token instances (e.g., textual or visual depicting of objects represented by the token instances). Additionally or alternatively, the explanation 431 of relevance may include description of the affective response of the user to the prior experience.

In one embodiment, the explanation 431 may be intended to have different influences on the user 114, depending on the affective response of the user 114 to the prior experience. In one example, the affective response of the user 114 to the prior experience is negative, and therefore, the explanation 431 may describe why the user should not have the experience (e.g., “last time you drank four shots of Vodka in a row didn't end well—don't do it now!”). In another example, the affective response of the user to the prior experience is positive, and therefore the explanation describes why the user should have the experience (e.g., “You really enjoyed Spiderman 7, go and see Spiderman 8!”).

The user interface 432 is configured to present the explanation 431 to the user as a response to the indication of uncertainty 427. Optionally, the explanation 431 is presented, at least in part, via a display (e.g., a head-mounted display and/or screen of a device). Optionally, the explanation 431 is presented, at least in part, via speakers that play sounds to the user 114, such as voice of a software agent or music indicating to the user that a choice the user 114 is about to make is ill-conceived.

In one embodiment, the explanation 431 comprises portions of the experience and/or the prior experience. For example, the experience may involve consuming content, and the explanation may include portions of the content (e.g., a video clip) that specifically depicts why the user will enjoy the content (for a favorable explanation), or why the user is likely to hate it (for an unfavorable explanation designed to persuade the user not to have the experience).

In another embodiment, the explanation 431 may include description of the user having the prior experience and/or a description of the user having a suggested experience. For example, an explanation why the user should not shave her head may include an image of the user last time she shaved her head. In another example, an explanation of why the user should go to the gym may include an image of the user from a year ago in a swimsuit which received many “likes” on a social network. In still another example, an explanation regarding why a user should buy a new suit may include a computer-generated image of the user in the new suit.

In one embodiment, the system illustrated in FIG. 11 optionally includes a user condition detector 433 configured to delay presentation of the explanation 431 until determining that the user 114 is amenable to the reminding of the prior experience in order to ameliorate the uncertainty. For example, if the explanation 431 involves saying something out loud to the user 114 which may be private, the user condition detector 433 may indicate to the user interface to present the explanation when the user 114 is detected to be alone. In another example, if the user 114 is detected, e.g., by a camera, to be busy in an activity such as driving or conversing with other people, the user condition detector 433 may indicate to delay the presentation until the user is done with the activity.

In one embodiment, the system illustrated in FIG. 11 optionally includes a predictor 434 of affective response configured to receive at least one token instance representing the prior experience, and to predict affective response to the prior experience. Optionally, at least some of the affective responses 421 are predicted affective responses to the prior experiences. Optionally, the predictor 434 of affective response utilizes a model of the user 114, trained on data comprising experiences described by token instances and measured affective response of the user 114 to the experiences, to predict the affective response of the user 114 to the prior experience. Optionally, the predictor 434 of affective response utilizes a model, trained on data comprising experiences described by token instances and measured affective response of other users to the experiences, to predict the affective response of the user 114 to the prior experience.

In one example embodiment, a current experience for the user 114 involves the user is going out with friends. The time for going out has come, and the user 114 is still at home. The system may detect this as the indication of uncertainty 427, and locate an example of a prior experience (with the same friends which are represented by similar token instances to the ones representing the current experience). The system may detect that in the prior experience, the user had a good time and generate the explanation 431 which includes comments the user 114 made about the prior experience in a journal of the user and/or present the user with affective response measurements taken at that time that prove the user 114 was having fun!.

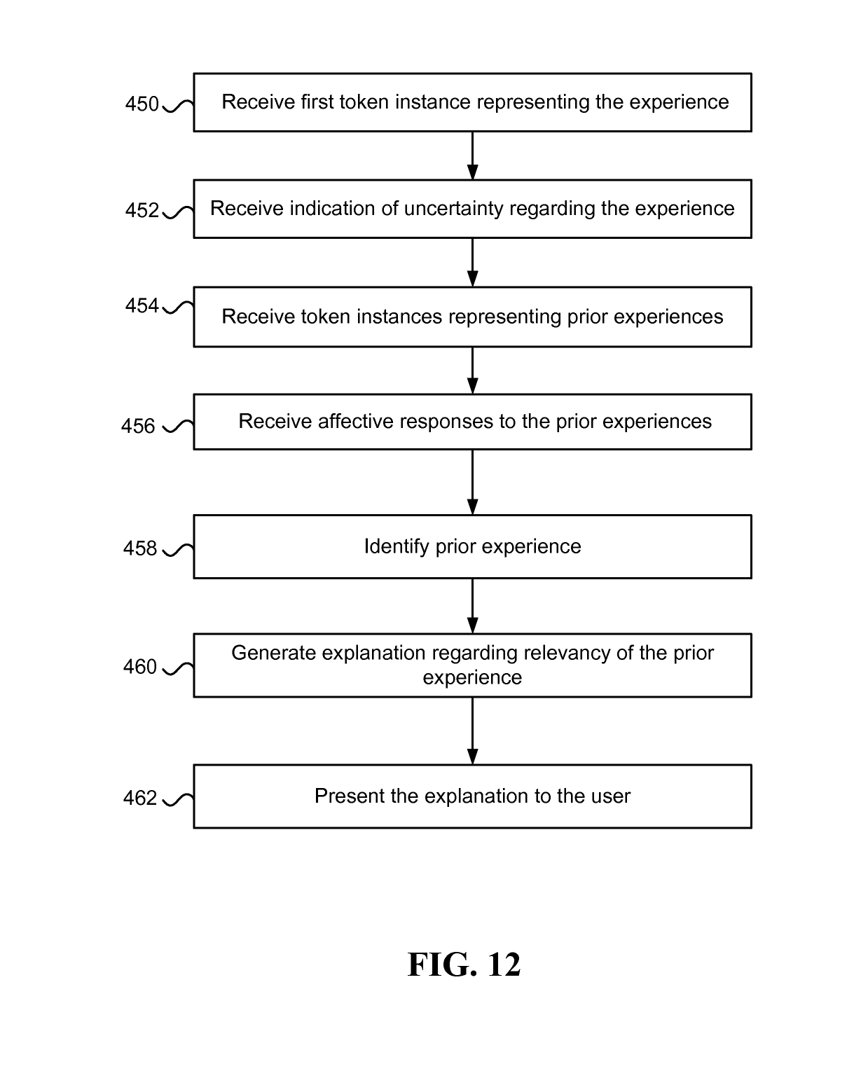

FIG. 12 illustrates one embodiment of a method responding to uncertainty of a user regarding an experience. The method includes at least the following steps:

In step 450, receiving a first token instance representing the experience for the user. Optionally, the experience may involve certain content for consumption by the user, an activity for the user to participate in, and/or an item for purchase for the user.

In step 452, receiving an indication of uncertainty of the user regarding the experience. Optionally, the indication of uncertainty may be derived from one or more of the following: a facial expression of the user, a comment made by the user, body language of the user, physiological measurement of the user, or lack of action by the user.

In step 454, receiving token instances representing prior experiences. Optionally, the token instances may be stored in a memory such as the memory 422.

In step 456, receiving affective responses to the prior experiences. Optionally, the affective responses may be measured utilizing the sensor 120. Additionally or alternatively, at least some of the affective responses may be predicted. Optionally, the affective responses may be stored in a memory such as the memory 422.

In step 458, identifying, from among prior experiences, a prior experience represented by a second token instance that is more similar to the first token instance than most of the token instances representing the other prior experiences. Optionally, the second token instance is a token instance for which measured attention level of the user is highest, compared to attention level to other token instances representing the prior experience. Optionally, the second token instance is a token instance for which predicted attention level is the highest, compared to attention level predicted for other token instances representing the prior experience. Additionally, an affective response to the prior experience reaches a predetermined threshold. Optionally, the fact that the affective response reaches the predetermined threshold implies there is a probability of more than 10% that the user remembers the prior experience.

In step 460, generating an explanation regarding relevance of the experience to the user based on the prior experience. Optionally, generating the explanation of relevance is based on at least one of the first and second token instances. Additionally or alternatively, generating the explanation of relevance may be based on affective response of the user to the prior experience. Optionally, if the affective response of the user to the prior experience is negative, the explanation describes why the user should not have the experience. Alternatively, if the affective response of the user to the prior experience is positive, the explanation may describe why the user should have the experience.

And in step 462, presenting the explanation to the user as a response to the indication of uncertainty.

In one embodiment, the method illustrated in FIG. 12 optionally includes a step that involves delaying presenting the explanation until determining that the user is amenable to a reminder of the prior experience in order to ameliorate the uncertainty.

In one embodiment, the method illustrated in FIG. 12 optionally includes a step that involves receiving at least one token instance representing the prior experience, and predicting affective response to the prior experience. Optionally, predicting the affective response to the prior experience is done utilizing a model of the user, trained on data comprising experiences described by token instances and measured affective response of the user to the experiences. Optionally, predicting the affective response to the prior experience is done utilizing a model, trained on data comprising experiences described by token instances and measured affective response of other users to the experiences.

In one embodiment, the method illustrated in FIG. 12 optionally includes a step that involves measuring, utilizing a sensor, affective responses of the user to the prior experience.

In one embodiment, a non-transitory computer-readable medium stores program code that may be used by a computer to respond to uncertainty of a user regarding an experience. The computer includes a processor, and the non-transitory computer-readable medium stores the following program code: Program code for receiving a first token instance representing the experience for the user. Program code for receiving an indication of uncertainty of the user regarding the experience. Program code for receiving token instances representing prior experiences, and affective responses to the prior experiences. Program code for identifying, from among prior experiences, a prior experience represented by a second token instance that is more similar to the first token instance than most of the token instances representing the other prior experiences. Additionally, an affective response to the prior experience reaches a predetermined threshold. Optionally, the fact that the affective response reaches the predetermined threshold implies that there is a probability of more than 10% that the user remembers the prior experience. Program code for generating an explanation regarding relevance of the experience to the user based on the prior experience. And program code for presenting the explanation to the user as a response to the indication of uncertainty.

In one embodiment, the non-transitory computer-readable medium may optionally store program code for waiting with the reminding until determining that the user is amenable to a reminder of the prior experience in order to ameliorate the uncertainty.

In one embodiment, the non-transitory computer-readable medium may optionally store program code for generating the explanation of relevance based on at least one of the first and second token instances.

In one embodiment, the non-transitory computer-readable medium may optionally store program code for generating the explanation of relevance based on affective response of the user to the prior experience.

In one embodiment, the non-transitory computer-readable medium may optionally store program code for storing affective responses of the user to the prior experiences.

In one embodiment, the non-transitory computer-readable medium may optionally store program code for receiving at least one token instance representing the prior experience, and for predicting affective response to the prior experience. Optionally, the program code predicting the affective response of the user to the prior experience includes program code for utilizing for the predicting a model of the user, trained on data comprising experiences described by token instances and measured affective response of the user to the experiences. Optionally, the program code predicting the affective response of the user to the prior experience includes program code for utilizing for the predicting a model trained on data comprising experiences described by token instances and measured affective responses of other users to the experiences.

In one embodiment, the non-transitory computer-readable medium may optionally store program code for measuring, utilizing a sensor, affective responses of the user to the prior experience.

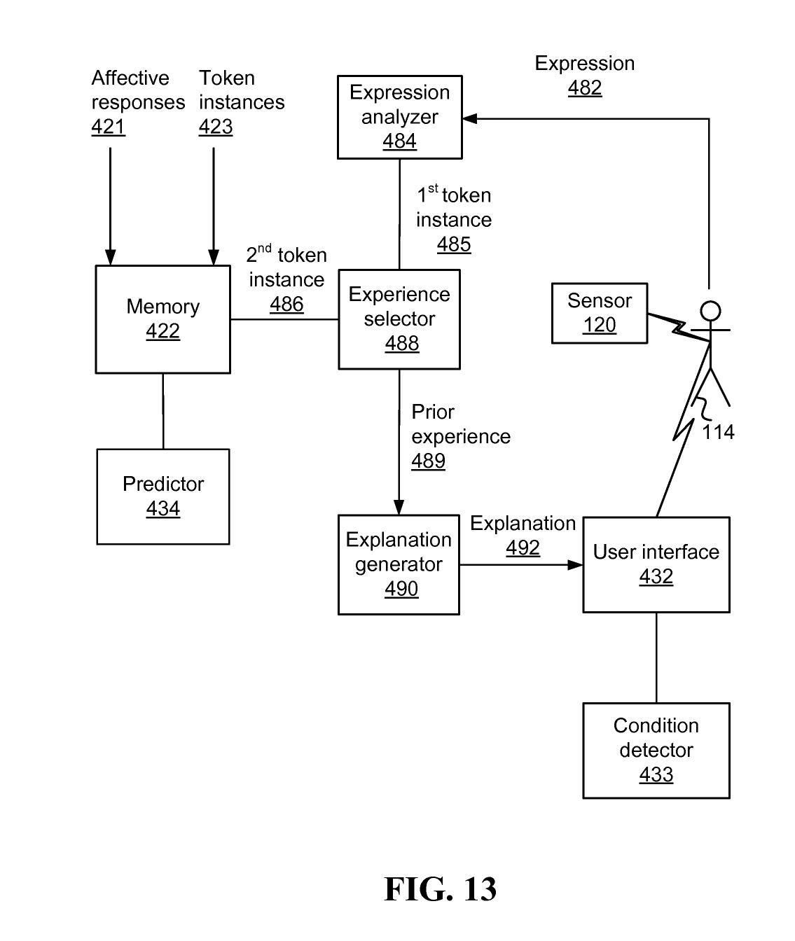

FIG. 13 illustrates one embodiment of a system configured to explain to a user a relevance of an experience for the user. For example, a software agent may select a certain experience for the user that may involve certain content for consumption by the user, an activity for the user to participate in, and/or an item for purchase for the user. The user may have reservations regarding selection of the experience. For instance the user may not understand why the experience was selected and/or disagree with the selection. Accordingly the user may voice and/or express apprehension regarding the experience. In such a case, the system may respond with an explanation of the selection that may address the apprehension expressed by the user.

In some embodiments, the system illustrated in FIG. 13 includes at least an expression analyzer 484, an experience selector 488, an explanation generator 490, and the user interface 432. Optionally, two or more of the expression analyzer 484, the experience selector 488, and the explanation generator 490 may run on the same computer and/or may be realized by the same software module. Optionally, the expression analyzer 484, the experience selector 488, and/or the explanation generator 490 may run on a server remote of the user 114, such as a cloud-based server.

The expression analyzer 484 is configured to receive an expression 482 of the user 114 and to analyze the expression 482 to determine whether the expression 482 indicates apprehension of the user regarding the experience. Optionally, the expression 482 includes images of the user 114 (e.g., video images of expression of the user), audio of the user 114 (e.g., statements expressed by the user 114), digital communications of the user 114 (e.g., text messages), and/or measurements of affective responses of the user 114.

In one embodiment, the expression analyzer 484 may utilize various semantic analysis methods to determine a subject of the expression 482 and/or whether the expression 482 includes negative sentiment, such as apprehension, towards the experience. Further discussion of semantic analysis methods that may be utilized appears further below in this disclosure. Additionally, the expression analyzer 484 is configured to extract a first token instance 485 from the expression. The first token instance 485 represents an aspect of the experience. Optionally, the expression analyzer 484 utilizes semantic analysis to extract the first token instance 485. Optionally, the semantic analysis indicates that the first token instance 485 is likely a cause of the apprehension of the user 114 regarding the experience. For example, the semantic analysis may indicate that an object represented by the first token instance 485 is the subject of negative attitude of the user with regards to the selected experience.

In one example, the aspect of the experience represented by the first token instance 485 is the type of experience (e.g., viewing a movie, going out, buying an item online). In another example, the aspect of the experience represented by the first token instance 485 is a character participating in the experience (e.g., a character in a game, a friend to meet for drinks). In yet another example, the aspect of the experience represented by the first token instance 485 is a location of the experience (e.g., URL of website where the user may visit, location of bar to visit).

In one embodiment, the expression analyzer 484 utilizes a measurement Emotional Response Predictor (measurement ERP) to determine an emotional response of the user from the expression 482 which comprises affective response measurements. Optionally, the measurement ERP may detect a negative emotional response in the expression 482, which may correspond to apprehension of the user 114 regarding the experience.

In one embodiment, the expression 482 of the user 114 is conveyed, at least in part, via images of the user 114, such as video images. Optionally, the expression analyzer 484 may utilizes eye tracking to extract first token instance 485. Optionally, the eye tracking may identify an object, represented by the first token instance 485, on which gaze of the user 114 is fixated. Optionally, gaze of the user 114 is fixated on the object while the user voices apprehension which may be detected via semantic analysis. Optionally, the gaze of the user 114 is fixated on the object while the user makes an expression corresponding to apprehension (e.g., a facial expression) which may be detected using facial expression recognition algorithms.

The experience selector 488 is configured to select a prior experience 489, from among prior experiences. Optionally, the prior experiences are represented by the token instances 423 that are stored in the memory 422. Additionally, the memory 422 may store affective responses 421 to the prior experiences. Optionally, at least some of the affective responses 421 to the prior experiences are measured with the sensor 120.

In one embodiment, the selection of the prior experience 489 is done such that the prior experience 489 is represented by a second token instance 486 that is more similar to the first token instance 485 than most of the token instances 423 representing the other prior experiences. Thus, similarity between the first token instance 485 and the second token instance 486 may be considered to be greater, on average, than similarity between the first token instance 485 and a randomly selected token instance representing a prior experience from among the token instances 423. Additionally, the prior experience 489 is selected such that an affective response of the user 114 to the prior experience 489 reaches a predetermined threshold. Optionally, the fact that the affective response reaches the predetermined threshold implies there is a probability of more than 10% that the user 114 remembers the prior experience (e.g., when reminded of it).

In one embodiment, the second token instance 486 is a token instance for which measured attention level of the user is highest, compared to attention level to other token instances representing the prior experience 489. Additionally or alternatively, the second token instance 486 may be a token instance for which predicted attention level is the highest, compared to attention level predicted for other token instances representing the prior experience.

In one embodiment, the experience selector 488 provides information regarding the prior experience 489 to the explanation generator 490. For example, the experience selector 488 may provide a description of the prior experience, a token instance representing the prior experience, and/or a description of the user having the prior experience and/or aftermath of the prior experience (e.g., video of the user taken during the prior experience).

The explanation generator 490 is configured to generate an explanation 492 of relevance of the experience to the user 114 based on the prior experience 489. Optionally, the explanation 492 of relevance is based on at least one of the first token instance 485 and/or the second token instance 486. For example, it includes information describing the token instances (e.g., textual or visual depicting of objects represented by the token instances). Additionally or alternatively, the explanation 492 of relevance may include description of the affective response of the user 114 to the prior experience 489. Additionally or alternatively, the explanation 492 of relevance may include description of the similarities and/or differences between the first token instance 485 and the second token instance 486. Optionally, the description of the similarities and/or differences may assist the user 114 in assessing relevance of the prior experience 489, and/or the affective response to the prior experience, to the experience.

In one embodiment, the explanation 492 includes a portion of the prior experience 489 which is displayed to contrast the apprehension of the user. For example, the explanation may include reference to the second token instance 486 and mentioning to the affective response to the prior experience 489 in order to convey to the user 114 the message that the user is likely to have a similar affective response to the experience.

In another embodiment, the explanation 492 may include description of the user having the prior experience and/or a description of the user having a suggested experience. For example, a user may voice apprehension about going to the gym (e.g., the user may say: “I'm tired, I don't want to go!”); an explanation of why the user should go to the gym may include an image of the user from a year ago in a swimsuit which received many “likes” on a social network. In another example, an explanation regarding why a user should buy a new suit, even though the user voiced apprehension (e.g., the user said it is too expensive), may include a computer-generated image of the user in the new suit with a voiceover stating that it will make the user look “like a million bucks!”.

The user interface 432 is configured to present the explanation 492 to the user as a response to the expression of the user indicating the apprehension. Optionally, the explanation 492 is presented shortly after the apprehension is expressed (e.g., within a few seconds after). Optionally, the explanation 492 is presented shortly before a decision of the user 114 needs to be made regarding the experience selected for the user 114.

In one embodiment, the explanation 492 is presented, at least in part, via a display (e.g., a head-mounted display and/or screen of a device). Optionally, the explanation 492 is presented, at least in part, via speakers that play sounds to the user 114, such as voice of a software agent or music indicating to the user that a choice the user 114 is about to make is ill-conceived.

In one embodiment, the system illustrated in FIG. 13 optionally includes a user condition detector 433 configured to delay presentation of the explanation 492 until determining that the user 114 is amenable to the reminding of the prior experience in order to respond to the apprehension expressed by the user.

In one embodiment, the system illustrated in FIG. 13 optionally includes a predictor 434 of affective response configured to receive at least one token instance representing the prior experience, and to predict affective response to the prior experience 489. Optionally, at least some of the affective responses 421 are predicted affective responses to the prior experiences. Optionally, the predictor 434 of affective response utilizes a model of the user 114, trained on data comprising experiences described by token instances and measured affective response of the user 114 to the experiences, to predict the affective response of the user 114 to the prior experience.

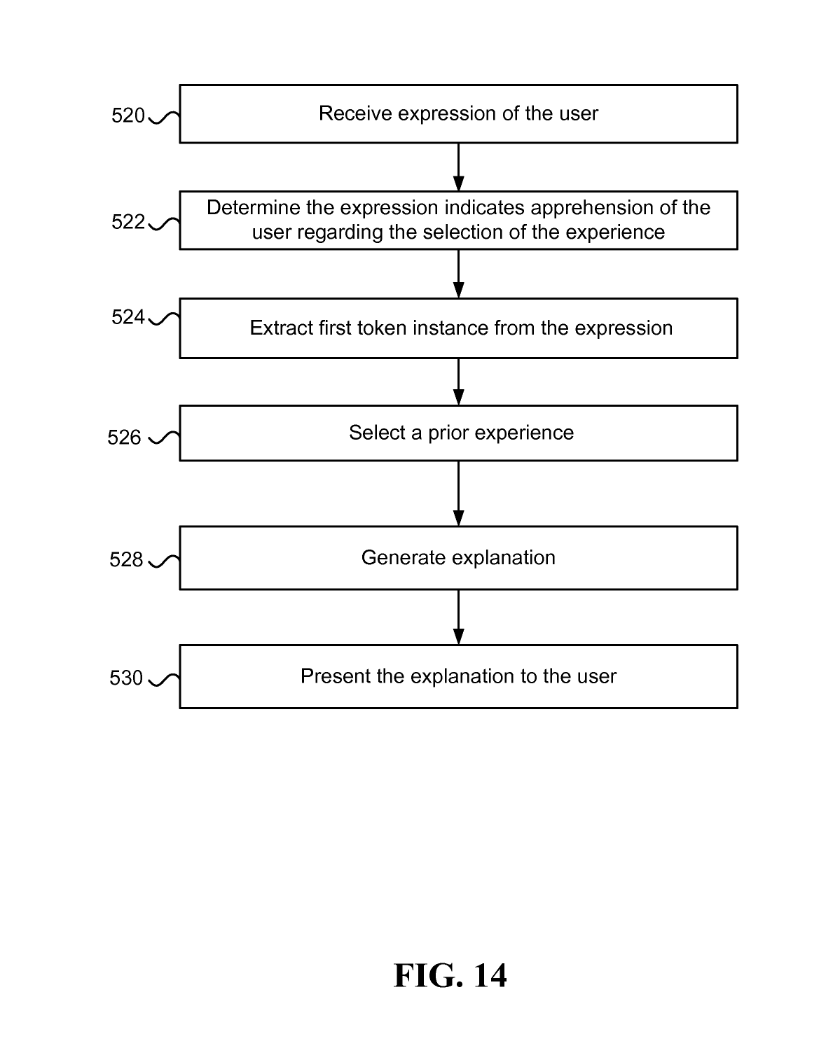

FIG. 14 illustrates one embodiment of a method explaining to a user relevance of an experience for the user. The method includes at least the following steps:

In step 520, receiving expression of the user. Optionally, the expression may include a communication of the user, a video of the user, and/or measurements of the user.

In step 522, analyzing the expression to determine that the expression indicates apprehension of the user regarding the experience. Optionally, the experience may involve certain content for consumption by the user, an activity for the user to participate in, and/or an item for purchase for the user.

In step 524, extracting a first token instance from the expression. Optionally, the first token instance represents an aspect of the experience. For example, the aspect may be a type of experience (e.g., viewing a movie, going out, buying an item online), a character participating in the experience (e.g., a character in a game, a friend to meet for drinks), a location of the experience (e.g., URL of website where the user may visit, location of bar to visit), and/or the cost of having the experience.

In step 526, selecting a prior experience, from among prior experiences, such that the prior experience is represented by a second token instance that is more similar to the first token instance than most of the token instances representing the other prior experiences. Optionally, the second token instance is a token instance for which measured attention level of the user is highest, compared to attention level to other token instances representing the prior experience. Optionally, the second token instance is a token instance for which predicted attention level is the highest, compared to attention level predicted for other token instances representing the prior experience.

Additionally, an affective response of the user to the prior experience reaches a predetermined threshold. Optionally, the fact that the affective response reaches the predetermined threshold implies that there is a probability of more than 10% that the user remembers the prior experience.

In step 528, generating an explanation of relevance of the experience to the user based on the prior experience. Optionally, the explanation of relevance comprises description of the first token instance. Optionally, the explanation of relevance comprises at least one of: description of similarity between the first token instance and the second token instance, and description of affective response of the user to the prior experience.

An in step 530, presenting the explanation to the user as a response to the expression of the user indicating the apprehension.

In one embodiment, step 524 may involve utilizing semantic analysis for the extracting of the first token instance. Optionally, the semantic analysis indicates that the first token instance is likely a cause of the apprehension of the user regarding the experience. Additionally or alternatively, step 524 may involve utilizing eye tracking for the extracting of the first token instance. Optionally, the eye tracking identifies an object, represented by the first token instance, on which gaze of the user is fixated.

In one embodiment, the method illustrated in FIG. 14 optionally includes a step involving storing token instances representing the prior experiences. Additionally or alternatively, the method may optionally include a step involving storing affective responses of the user to the prior experiences.

In one embodiment, the method illustrated in FIG. 14 optionally includes a step involving measuring affective response of the user to the prior experience utilizing a sensor.

In one embodiment, the method illustrated in FIG. 14 optionally includes a step involving receiving at least one token instance representing the prior experience, and predicting affective response to the prior experience. Optionally, predicting the affective response to the prior experience is done utilizing a model of the user, trained on data comprising experiences described by token instances and measured affective response of the user to the experiences. Optionally, predicting the affective response to the prior experience is done utilizing a model, trained on data comprising experiences described by token instances and measured affective response of other users to the experiences.

In one embodiment, the method illustrated in FIG. 14 optionally includes a step that involves delaying presenting the explanation until determining that the user is amenable to a reminder of the prior experience in order to ameliorate the apprehension.

In one embodiment, a non-transitory computer-readable medium stores program code that may be used by a computer to explain to a user relevance of an experience for the user. The computer includes a processor, and the non-transitory computer-readable medium stores the following program code: Program code for receiving expression of the user. Program code for analyzing the expression to determine that the expression indicates apprehension of the user regarding the experience. Program code for extracting a first token instance from the expression. Optionally, the first token instance represents an aspect of the experience. Program code for selecting a prior experience, from among prior experiences, such that the prior experience is represented by a second token instance that is more similar to the first token instance than most of the token instances representing the other prior experiences. Additionally, an affective response of the user to the prior experience reaches a predetermined threshold. Optionally, the fact that the affective response reaches the predetermined threshold implies there is a probability of more than 10% that the user remembers the prior experience. Program code for generating an explanation of relevance of the experience to the user based on the prior experience. And program code for presenting the explanation to the user as a response to the expression of the user indicating the apprehension.

In one embodiment, the non-transitory computer-readable medium may optionally store program code for utilizing semantic analysis for the extracting of the first token instance. Optionally, the semantic analysis indicates that the first token instance is likely a cause of the apprehension of the user regarding the experience.

In one embodiment, the non-transitory computer-readable medium may optionally store program code for utilizing eye tracking for the extracting of the first token instance. Optionally, the eye tracking identifies an object, represented by the first token instance, on which gaze of the user is fixated.

In one embodiment, the non-transitory computer-readable medium may optionally store program code for storing token instances representing the prior experiences.

In one embodiment, the non-transitory computer-readable medium may optionally store program code for storing affective responses of the user to the prior experiences.

In one embodiment, the non-transitory computer-readable medium may optionally store program code for measuring affective response of the user to the prior experience utilizing a sensor.

In one embodiment, the non-transitory computer-readable medium may optionally store program code for receiving at least one token instance representing the prior experience, and for predicting affective response to the prior experience. Optionally, the program code predicting the affective response of the user to the prior experience includes program code for utilizing for the predicting a model of the user, trained on data comprising experiences described by token instances and measured affective response of the user to the experiences. Optionally, the program code predicting the affective response of the user to the prior experience includes program code for utilizing for the predicting a model trained on data comprising experiences described by token instances and measured affective responses of other users to the experiences.

In one embodiment, the non-transitory computer-readable medium may optionally store program code for delaying presenting the explanation until determining that the user is amenable to a reminder of the prior experience in order to ameliorate the apprehension.

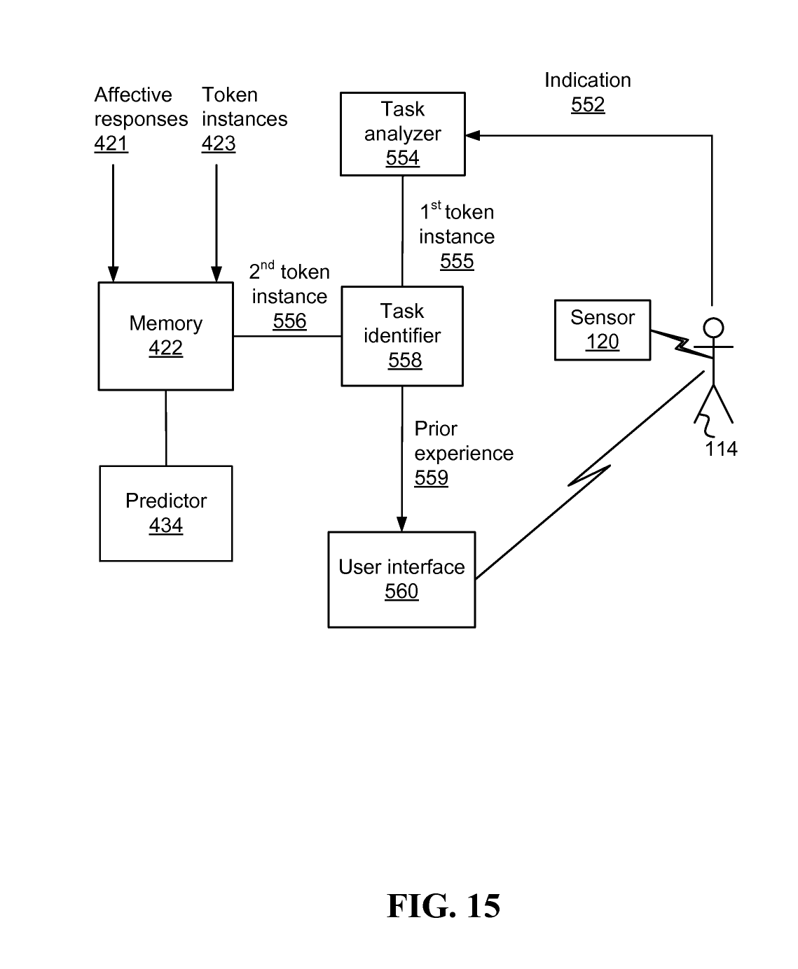

FIG. 15 illustrates one embodiment of a system configured to provide positive reinforcement for performing a task. For example, a user may face performing a task that the user may not feel positively about such as exercise, a chore, shopping, homework, mingling at a party, or preparing healthy food. The system may sense the negative emotional response and remind the user of a similar task completed by the user in the past to which the user had a positive emotional response. This reminder may serve as positive reinforcement which may assist the user in completing the task at hand.

In some embodiments, the system illustrated in FIG. 15 includes at least a task analyzer 554, a task identifier 558, and the user interface 560. Optionally, the task analyzer 554 and the task identifier 558 may run on the same computer and/or may be realized by the same software module. Optionally, the task analyzer 554 and/or the task identifier 558 may run on a server remote of the user 114, such as a cloud-based server.

The task analyzer 554 is configured to receive an indication of negative affective response of the user 114 occurring in temporal proximity to the user performing a first task. Optionally, the negative affected response is measured by the sensor 120. For example, the negative affective response may be derived from images of the user displaying displeasure (e.g., via facial expressions). In another example, the negative affective response may be reflected from physiological signals, such as changes to heart rate and/or skin conductance. In yet another example, the negative affective response may be detected by measuring brainwaves utilizing EEG. Optionally, the task analyzer 554 may utilize a measurement Emotional Response Predictor (measurement ERP) in order to infer negative affective emotional response from affective response measurements.

In one embodiment, the negative affective response is inferred from responses of the user such as comments or gestures the user 114 makes (e.g., body language of the user). Optionally, the negative affective response is inferred by utilizing semantic analysis to determine attitude of the user 114 from communications and/or verbal expressions of the user 114.

In another embodiment, the negative affective response is predicted based on past performances of tasks by the user 114. For example, if the user 114 typically has a negative affective response before each time the user 114 needs to exercise, the system need not wait until the user 114 verbalizes a negative response. The system may elect to preemptively provide the user 114 with positive reinforcement.

The task analyzer 554 is also configured to identify a first token instance 555 representing the first task. For example, the first token instance 555 may correspond to the task itself (e.g., “exercise”, “doing the dishes”, “homework”) and/or a characteristic of the task (e.g., “physical exhaustion”, “boredom”). Optionally, the characteristic of the task is a characteristic to which the user 114 expresses negative affective response.

In one embodiment, the task analyzer 554 generates the first token instance 555 based on a description of the task provided by the user 114 (e.g., from a description the user provides). Additionally or alternatively, the task analyzer 554 may utilize external data sources (e.g., a database) to obtain and/or select the first token instance 555.

The task identifier 558 is configured to identify a prior performance of a second task, from among prior performances of tasks by the user 114, which is represented by a second token instance 556 that is more similar to the first token instance 555 than most token instances representing the other prior performances. Optionally, the first task and the second task are essentially the same task. For example, they both involve going to the gym, completing homework, or eating dietetic food. Optionally, the first token instance 555 and the second token instance 556 are instantiations of a same token instance. Additionally, an associated positive emotional response of the user 114 to the second task reached a predetermined threshold. Optionally, the fact that the emotional response reached the predetermined threshold implies that there is a probability of more than 10% that the user remembers the positive emotional response associated with the prior performance of the second task. Thus, the user 114 may remember performing the second task, which may assist the user to complete the first task.

In one embodiment, the system includes the memory 422 which is configured to store the token instances 423 representing prior experiences relevant to the user 114, and to store the affective responses 421 to the prior experiences. Optionally, the second token instance 556 is selected from among the token instances 423, and the positive emotional response is derived from an affective response from among the affective responses 421.

In one embodiment, the positive emotional response associated with the prior performance of the second task refers to an emotional response to completion of the second task. For example, the positive emotional response may be the feeling felt after an exercise, after homework is done, or after the house is clean.

In another emotional response, the positive emotional response associated with the prior performance of the second task refers to an emotional the user has while performing the second task. For example, the user may enjoy exercising at the gym (however, the user may dread the time building up to that experience).

In one embodiment, a semantic analyzer configured to receive report of the user regarding the prior performance of the second task and to derive the associated positive emotional response of the user from the report by utilizing semantic analysis of the report.

The user interface 560 is configured to remind the user 114 of the prior performance of the second task. Optionally, the user interface 560 is configured to remind the user by presenting to the user description of a similarity between the first task and the second task. For example, the user interface may explain to the user 114 that the first task is no different than the second task. The underlying assumption being, since the user completed the second task, there is no reason not to complete the first task (“You already ran 5K last week, no reason not to do it today”). In another example, the user interface 560 is configured to remind the user 114 by presenting to the user 114 description of the associated positive emotional response. For example, the description may relate to how good the user felt last time he went out (even though the user is tired right now).

In one embodiment, the system illustrated in FIG. 15 optionally includes a predictor 434 of affective response configured to receive at least one token instance representing the prior experience, and to predict affective response to the prior experience 489. Optionally, at least some of the affective responses 421 are predicted affective responses to the prior experiences. Optionally, the predictor 434 of affective response utilizes a model of the user 114, trained on data comprising experiences described by token instances and measured affective response of the user 114 to the experiences, to predict the affective response of the user 114 to the prior experience.

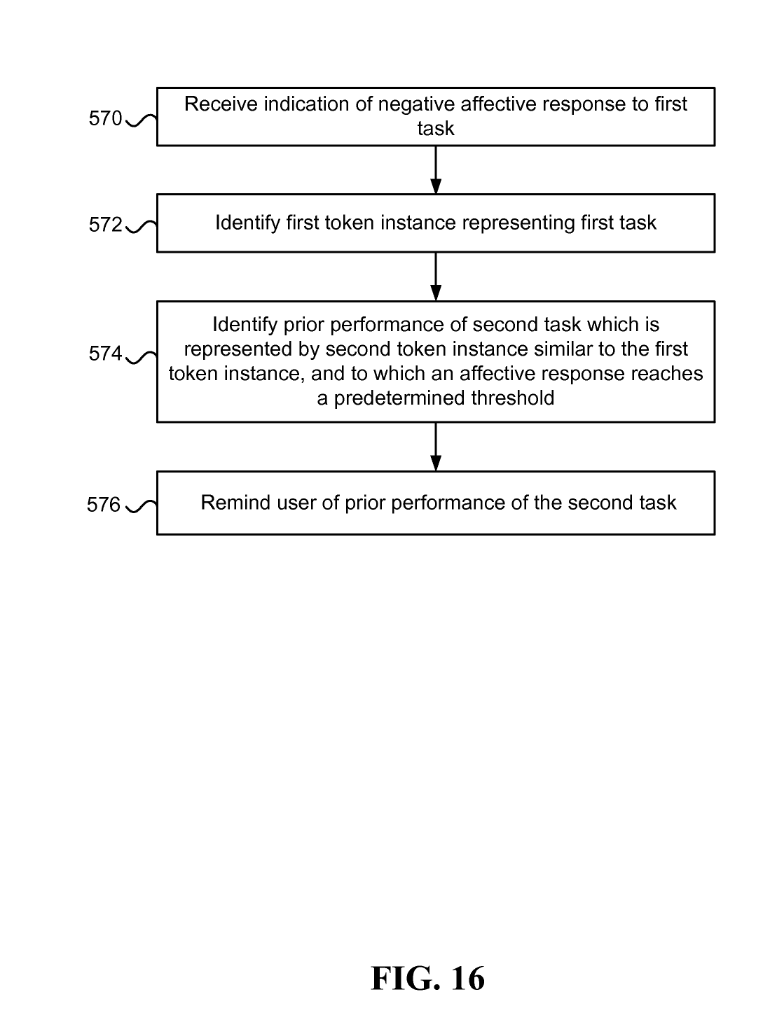

FIG. 16 illustrates one embodiment of a method providing positive reinforcement for performing a task. The method includes at least the following steps:

In step 570, receiving indication of negative affective response of a user occurring in temporal proximity to the user performing a first task.

In step 572, identifying a first token instance representing the first task.

In step 574, identifying a prior performance of a second task, from among prior performances of tasks by the user, which is represented by a second token instance that is more similar to the first token instance than most token instances representing the other prior performances, and to which an associated positive emotional response of the user reached a predetermined threshold. Optionally, the fact that emotional response reached the predetermined threshold implies that there is a probability of more than 10% that the user remembers the positive emotional response associated with the prior performance of the second task. Optionally, the first task and the second task are essentially the same task. Optionally, the first token instance and the second token instance are instantiations of a same token instance. Optionally, the associated positive emotional response refers to an emotional response to completion of the second task. Additionally or alternatively, the associated positive emotional response refers to an emotional response of the user while performing the second task.

And in step 576, reminding the user of the prior performance of the second task. Optionally, reminding the user involves presenting to the user description of a similarity between the first task and the second task. Optionally, reminding the user involves presenting to the user description of the associated positive emotional response.

In one embodiment, the method illustrated in FIG. 16 optionally includes a step involving storing token instances representing the prior performances of tasks. Additionally or alternatively, the method may include a step involving storing associated emotional responses of the user to the prior performances of tasks.

In one embodiment, the method illustrated in FIG. 16 optionally includes a step involving measuring affective response of the prior performance of the second task with a sensor. Optionally, the associated positive emotional response of the user is determined based on a measurement of the sensor, for example utilizing a measurement ERP.

In one embodiment, the method illustrated in FIG. 16 optionally includes a step involving receiving a report of the user regarding the prior performance of the second task and derive the associated positive emotional response of the user from the report by utilizing semantic analysis of the report.

In one embodiment, the method illustrated in FIG. 16 optionally includes a step involving receiving at least one token instance representing the prior performance of the second task, and predicting the associated positive emotional response of the user. Optionally, the predicting of the associated positive emotional response is done utilizing a model of the user, trained on data comprising performances of tasks represented by token instances and emotional responses of the user to the performances of the tasks. Optionally, the predicting of the associated positive emotional response is done utilizing a model, trained on data comprising performances of tasks represented by token instances and emotional responses of other users to the performances of the tasks.

In one embodiment, a non-transitory computer-readable medium stores program code that may be used by a computer to provide positive reinforcement for performing a task. The computer includes a processor, and the non-transitory computer-readable medium stores the following program code: Program code for receiving indication of negative affective response of a user occurring in temporal proximity to the user performing a first task. Program code for identifying a first token instance representing the first task. Program code for identifying a prior performance of a second task, from among prior performances of tasks by the user, which is represented by a second token instance that is more similar to the first token instance than most token instances representing the other prior performances, and to which an associated positive emotional response of the user reached a predetermined threshold. Optionally, the fact that emotional response reached the predetermined threshold implies that there is a probability of more than 10% that the user remembers the positive emotional response associated with the prior performance of the second task. And program code for reminding the user of the prior performance of the second task.

In one embodiment, the non-transitory computer-readable medium may optionally store program code for reminding the user by presenting to the user description of a similarity between the first task and the second task. In one embodiment, the non-transitory computer-readable medium may optionally store program code for reminding the user by presenting to the user description of the associated positive emotional response. In one embodiment, the non-transitory computer-readable medium may optionally store program code for storing token instances representing the prior performances of tasks. In one embodiment, the non-transitory computer-readable medium may optionally store program code for storing associated emotional responses of the user to the prior performances of tasks. In one embodiment, the non-transitory computer-readable medium may optionally store program code for measuring affective response of the prior performance of the second task with a sensor. Optionally, the associated positive emotional response of the user is determined based on a measurement of the sensor. In one embodiment, the non-transitory computer-readable medium may optionally store program code for receiving a report of the user regarding the prior performance of the second task and derive the associated positive emotional response of the user from the report by utilizing semantic analysis of the report.

In one embodiment, the non-transitory computer-readable medium may optionally store program code for receiving at least one token instance representing the prior performance of the second task, and predicting the associated positive emotional response of the user. Additionally, the non-transitory computer-readable medium may optionally store program code for utilizing a model of the user, trained on data comprising performances of tasks represented by token instances and emotional responses of the user to the performances of the tasks for the predicting of the associated positive emotional response. Optionally, the non-transitory computer-readable medium may optionally store program code for utilizing a model, trained on data comprising performances of tasks represented by token instances and emotional responses of other users to the performances of the tasks, for predicting of the associated positive emotional response.

In one embodiment, presenting the user with information related to a prior experience may include replaying a portion of the prior experience. Optionally, while the user has the prior experiences, portions of the prior experiences are stored. Optionally, the portions of the prior experiences are linked to stored representations of the prior experiences (e.g., token instances representing the prior experiences) and/or measurements of the affective responses of the user to the prior experiences.

In one embodiment, portions of prior experiences that involve exposure of the user to content are recorded by storing portions of the content. Alternatively or additionally, pointers to the content and/or specific portions of the content may be saved. For example, if a user sees a commercial, the commercial may be stored for future reference (e.g., a commercial for a concert may be replayed to the user to explain why the user's agent is suggesting to go to the concert). In another example, the system may store certain scenes belonging to a movie the user is watching; these scenes may represent the movie in future references, when the user needs to be reminded of the movie.

In one embodiment, portions of prior experiences are recorded using a device of the user, as the user has the prior experiences. For example, a camera attached to a smart phone, clothing of the user, or to glasses worn by the user (e.g., a camera that works with augmented reality glasses), may be used to record portions of the experience from the point of view of the user. In one example, a camera on glasses the user wears records a social activity the user participates in, like going out to a bar. The images taken by the camera correspond to the objects and/or people the user pays attention to since the camera is typically pointed in the direction at which the user gazes. In another example, a microphone records conversations the user has with other users. Portions of the conversations may be replayed back to the user in order to induce associations that may help to explain certain chosen experiences (e.g., to explain why the user should hang out with a certain person or why the user should not hang out with another).

In one embodiment, recordings of portions of prior experiences are obtained from external sources. For example, images of the user participating in a prior experience may be obtained from postings of other people on a social network (e.g., Facebook, YouTube). In another example, portions of content the user consumed in the prior experiences are obtained from sites such as YouTube and/or IMDB.

Storage of information related to prior experiences may involve various types of data, such as token instances representing the prior experiences, measurements of the affective response of the user to the prior experiences, and/or recording of portions of the prior experiences. In some cases it may not be necessary and/or beneficial to store such information to the same extent in all circumstances. For example, if the experience the user is having does not have a noticeable and/or significant effect on the user, it may not be necessary and/or beneficial to store information related to the experience in much detail. However, an experience that has a noticeable and/or significant effect on the user may be stored in detail; in a future occasion, such an experience is more likely to be recalled to the user to induce an association relevant to a chosen experience, compared to a prior experience that did not have a noticeable effect on the user.

In one embodiment, a system configured to store information regarding experiences of the user includes at least a memory, an analyzer of affective response measurements, and a storage controller. Optionally the analyzer of the affective response measurements and the storage controller are implemented as the same module (e.g., a program that performs the tasks of both components).

The memory is configured to store information related to an experience a user has such as measurements of affective response of the user to the experience, token instances representing the experience, and/or a recorded portion of the experience. Optionally, the stored portion of the experience may include a portion of content the user was exposed to, an image taken from a device of the user while having the experience, and/or an image, taken from an external source, of the experience. Optionally, the memory is comprised of various components that may store the data at different locations (e.g., affective response measurements are stored in one database, while token instances are stored in another database).

The analyzer of affective response measurements is configured to receive a measurement of the affective response of the user to the experience, analyze it, and to forward to the storage controller a result based on the analysis. Optionally, the measurement of the affective response of the user to the experience is taken by a sensor that measures values of a physiological signal and/or a behavioral cue. Optionally, the analyzer of affective response is configured to determine the extent of the affective response. For example, the analyzer is configured to determine whether the measurement reflects a noticeable and/or significant affective response. Optionally, the analyzer of affective response measurements determines whether the measurement of affective response to the experience reaches a predetermined threshold.

In one embodiment, the fact that the user is having a noticeable and/or significant affective response may be determined by comparing a value derived from the measurement to a value taken before the experience and/or a baseline value of the user. For example, if the heart rate of the user, as measured during the experience is 10% higher than the heart before the experience and/or the baseline heart of the user, the measurement may be considered to reflect a significant affective response.

The storage controller is configured to receive the result of the analysis of the analyzer of affective response measurements, and to determine based on the received result, extent of storage of the information related to the experience the user has. For example, if the result indicates that the affective response of the user is not noticeable, significant and/or reaches the predetermined threshold, the storage controller may cause the information to be only partially stored and/or not stored at all. In one example, partially storing the information may be achieved by storing general information pertaining to the experience, e.g., token instances describing the general details such time, date, location, and/or participants of the activity; however, little information is stored involving specific details of the activity, such as what participants are doing at different times. In another example, partially storing the information may be achieved by storing information at a lower volume per unit of time; for instance video may be stored at lower resolution or frame rate, measurements of affective response may be stored using a lower dimensional representation and/or time series measurement values may be stored at larger time intervals.

In some embodiments, prior experiences used to induce an association with the user regarding the chosen experience, may be prior experiences of other users. For example, the other users may be related to the user (e.g., friends of the user on a social network). In another example, the other users may have similar profiles to the user (e.g., similar demographic statistics, hobbies, activities, content consumption patterns) and/or respond similarly to the user when having similar experiences (e.g., have similar affective responses to certain scenes in movies or games, have the same affective responses in similar social situations, such as anxious when meeting new people or being in public). In some cases, recalling a prior experience of another user can help the user determine an attitude towards a chosen experience for the user, which is similar to the prior experience. Knowing that the other user is either related to the user and/or similar to the user in some way can help the user determine how to relate to the prior experience of the other user, and what conclusions to draw from that prior experience.

In one embodiment, a system configured to select a prior experience of another user, similar to a chosen experience for a user, includes at least a first memory, a second memory, a third memory, an experience comparator, a user comparator, and an experience selector. Optionally, the first memory, the second memory, and/or the second memory are the same memory. Optionally, the experience comparator, the user comparator, and/or the experience selector are realized in the same computer hardware (e.g., they are realized, at least in part, as programs running on the same processor). Optionally, the first memory, the second memory, and/or the third memory are coupled to the experience comparator, the user comparator, and/or the experience selector. For example, the first memory and/or the second memory are coupled to a processor on which the experience comparator, the user comparator, and/or the experience selector, run.

The first memory is configured to store measurements of affective responses of users to prior experiences.

The second memory configured to store token instances representing the prior experiences.

The third memory is configured to store profiles of the users. Optionally, the third memory may store information describing relationship of users to the user. Optionally, the third memory may store information pertaining to demographics, activities, hobbies and/or preferences of the users.

The experience comparator is configured to receive token instances representing the chosen experience for the user. Optionally, the chosen experience is chosen by a software agent. The experience comparator is also configured to compare the token instances representing the chosen experience with token instances representing the prior experiences to identify prior experiences similar to the chosen experience.

The user comparator is configured to receive a profile of the user and to compare the profile of the user to profiles of other users in order to detect users that are related to the user. Optionally, the related users are connected to the user via a social network (e.g., friends and/or family of the user). Optionally, the related users are similar to the user (e.g., similar demographic statistics, hobbies, activities, content consumption patterns). Optionally, the related users react similarly to the user to experiences.

The experience selector is configured to select the prior experience of another user, from among the prior experiences similar to the chosen experience, for which an associated measurement of the affective response of the user reaches a predetermined threshold. Additionally, the experience selector is configured to select the experience had by the another user, based on how related the other user is to the user. For example, an experience of another user may be selected if the other user is connected to the user on a social network and/or has similar responses to the user to certain content.

Since the measurement of the affective response of the another user to the prior experience reaches the predetermined threshold, it is likely that recollecting the prior experience of the another user is likely to induce an association relevant to the chosen experience. In addition the fact that the another user is related to the user can help the user understand how the affective response of the another user to the prior experience has baring on the affective response of the user to the chosen experience.

In some embodiments, a sensor may include, without limitation, one or more of the following: a physiological sensor, an image capturing device, a microphone, a movement sensor, a pressure sensor, and/or a magnetic sensor.

Herein, a “sensor” may refer to a whole structure housing a device used for measuring a physical property, or to one or more of the elements comprised in the whole structure. For example, when the sensor is a camera, the word sensor may refer to the entire structure of the camera, or just to its CMOS detector.

A physiological signal is a value that reflects a person's physiological state. Some examples of physiological signals that may be measured include: Heart Rate (HR), Blood-Volume Pulse (BVP), Galvanic Skin Response (GSR), Skin Temperature (ST), respiration, electrical activity of various body regions or organs such as brainwaves measured with electroencephalography (EEG), electrical activity of the heart measured by an electrocardiogram (ECG), electrical activity of muscles measured with electromyography (EMG), and electrodermal activity (EDA) that refers to electrical changes measured at the surface of the skin.

A person's affective response may be expressed by behavioral cues, such as facial expressions, gestures, and/or other movements of the body. Behavioral measurements of a user may be obtained utilizing various types of sensors, such as an image capturing device (e.g., a camera), a movement sensor, an acoustic sensor, an accelerometer, a magnetic sensor, and/or a pressure sensor.

In one embodiment, images of the user are captured with an image capturing device such as a camera. In another embodiment, images of the user are captured with an active image capturing device that transmits electromagnetic radiation (such as radio waves, millimeter waves, or near visible waves) and receives reflections of the transmitted radiation from the user. Optionally, captured images are in two dimensions and/or three dimensions. Optionally, captured images are comprised of one or more of the following types: single images, sequences of images, video clips.

Affective response measurement data, such as the data generated by the sensor, may be processed in many ways. The processing of the affective response measurement data may take place before, during and/or after the data is stored and/or transmitted. Optionally, at least some of the processing of the data is performed by a sensor that participates in the collection of the measurement data. Optionally, at least some of the processing of the data is performed by a processor that receives the data in raw (unprocessed) form, or partially processed form. There are various ways in which affective response measurement data may be processed in the different embodiments, some of them are described in the following embodiments and examples:

In some embodiments, at least some of the affective response measurements may undergo signal processing, such as analog signal processing, discrete time signal processing, and/or digital signal processing.

In some embodiments, at least some of the affective response measurements may be scaled and/or normalized. For example, the measurement values may be scaled to be in the range [−1,+1]. In another example, the values of some of the measurements are normalized to z-values, which bring the mean of the values recorded for the modality to 0, with a variance of 1. In yet another example, statistics are extracted from the measurement values, such as statistics of the minimum, maximum, and/or various moments of the distribution, such as the mean, variance, or skewness. Optionally, the statistics are computed for measurement data that includes time-series data, utilizing fixed or sliding windows.

In some embodiments, at least some of the affective response measurements may be subjected to feature extraction and/or reduction techniques. For example, affective response measurements may undergo dimensionality reducing transformations such as Fisher projections, Principal Component Analysis (PCA), and/or feature subset selection techniques like Sequential Forward Selection (SFS) or Sequential Backward Selection (SBS).

In some embodiments, affective response measurements comprising images and/or video may be processed in various ways. In one example, algorithms for identifying cues like movement, smiling, laughter, concentration, body posture, and/or gaze, are used in order to detect high-level image features. Additionally, the images and/or video clips may be analyzed using algorithms and/or filters for detecting and/or localizing facial features such as location of eyes, brows, and/or the shape of mouth. Additionally, the images and/or video clips may be analyzed using algorithms for detecting facial expressions and/or micro-expressions.

In another example, images are processed with algorithms for detecting and/or describing local features such as Scale-Invariant Feature Transform (SIFT), Speeded Up Robust Features (SURF), scale-space representation, and/or other types of low-level image features.

In some embodiments, processing affective response measurements involves compressing and/or encrypting portions of the data. This may be done for a variety of reasons, for instance, in order to reduce the volume of measurement data that needs to be transmitted. Another reason to use compression and/or encryption is that it helps protect the privacy of a measured user by making it difficult for unauthorized parties to examine the data. Additionally, the compressed data may be pre-processed prior to its compression.

In addition, the literature describes various algorithmic approaches that can be used for processing affective response measurements, acquired utilizing various types of sensors. Some embodiments may utilize these known, and possibly other yet to be discovered, methods for processing affective response measurements. Some examples include: (i) a variety of physiological measurements may be preprocessed according to the methods and references listed in van Broek, E. L., Janssen, J. H., Zwaag, M. D., D. M. Westerink, J. H., & Healey, J. A. (2009), Prerequisites for Affective Signal Processing (ASP), In Proceedings of the International Joint Conference on Biomedical Engineering Systems and Technologies, INSTICC Press, incorporated herein by reference; (ii) a variety of acoustic and physiological signals may be pre-processed and have features extracted from them according to the methods described in the references cited in Tables 2 and 4, Gunes, H., & Pantic, M. (2010), Automatic, Dimensional and Continuous Emotion Recognition, International Journal of Synthetic Emotions, 1 (1), 68-99, incorporated herein by reference; (iii) Pre-processing of Audio and visual signals may be performed according to the methods described in the references cited in Tables 2-4 in Zeng, Z., Pantic, M., Roisman, G., & Huang, T. (2009), A survey of affect recognition methods: audio, visual, and spontaneous expressions, IEEE Transactions on Pattern Analysis and Machine Intelligence, 31 (1), 39-58, incorporated herein by reference; and (iv) pre-processing and feature extraction of various data sources such as images, physiological measurements, voice recordings, and text based-features, may be performed according to the methods described in the references cited in Tables 1,2,3,5 in Calvo, R. A., & D'Mello, S. (2010). Affect Detection: An Interdisciplinary Review of Models, Methods, and Their Applications. IEEE Transactions on affective computing 1(1), 18-37, incorporated herein by reference.

In some embodiments, the duration in which the sensor operates in order to measure the user's affective response may differ depending on one or more of the following: (i) the type of content the user is exposed to, (ii) the type of physiological and/or behavioral signal being measured, and (iii) the type of sensor utilized for the measurement. In some cases, the user's affective response to the content may be measured by the sensor substantially continually throughout the period in which the user is exposed to the content. However, in other cases, the duration during which the user's affective response to the content is measured need not necessarily overlap, or be entirely contained in the time in which the user is exposed to the content.

With some physiological signals, there is an inherent delay between the time in which a stimulus occurs and changes the user's emotional state, and the time in which the corresponding affective response is observed via a change in the physiological signal's measurement values. For example, an affective response comprising changes in skin temperature may take several seconds to be detected by a sensor. In addition, some physiological signals may depart very rapidly from baseline values, but take much longer to return to the baseline values.

In some cases, the physiological signal might change quickly as a result of a stimulus, but returning to the pervious baseline value (from before the stimulus), may take much longer. For example, the heart rate of a person viewing a movie in which there is a startling event may increase dramatically within a second; however, it can take tens of seconds and even minutes for the person to calm down and for the heart rate return to a baseline level.

The lag in time it takes affective response to be manifested in certain physiological and/or behavioral signals can lead to it that the period in which the affective response is measured occurs after the exposure to the content. Thus, in some embodiments, measuring the affective response of the user to the content may end, and possibly even also start, essentially after the user is exposed to the content. For example, measuring the user's response to a surprising short scene in a video clip (e.g., a gunshot lasting a second), may involve taking a GSR measurement a couple of seconds after the gunshot was played to the user. In another example, the user's affective response to playing a level in a computer game may include taking heart rate measurements lasting even minutes after the game play is completed.

In some embodiments, determining the user's affective response to the content may utilize measurement values corresponding to a fraction of the time the user was exposed to the content. The user's affective response to the content may be measured by obtaining values of a physiological signal that is slow to change, such as skin temperature, and/or slow to return to baseline values, such as heart rate. In such cases, measuring the user's affective response to content does not have to involve continually measuring the user throughout the duration in which the user is exposed to the content. Since such physiological signals are slow to change, reasonably accurate conclusions regarding the user's affective response to the content may be reached from samples of intermittent measurements taken at certain periods during the exposure (the values corresponding to times that are not included in the samples can be substantially extrapolated). In one example, measuring the user's affective response to playing a computer game involves taking measurements during short intervals spaced throughout the user's exposure, such as taking a GSR measurement lasting two seconds, every ten seconds. In another example measuring the user's response to a video clip with a GSR, heart rate and/or skin temperature sensor may involve operating the sensor mostly during certain portions of the video clip, such as a ten-second period towards the end of the clip.

In some embodiments, determining the user's affective response to content may involve measuring a physiological and/or behavioral signal of the user before and/or after the user is exposed to the content. Optionally, this is done in order to establish a baseline value for the signal to which measurement values of the user taken during the exposure to the content, and/or shortly after the exposure, can be compared. For example, the user's heart rate may be measured intermittently throughout the duration, of possibly several hours, in which the user plays a multi-player game. The values of these measurements are used to determine a baseline value to which measurements taken during a short battle in the game can be compared in order to compute the user's affective response to the battle. In another example, the user's brainwave activity is measured a few seconds before displaying an exciting video clip, and also while the clip is played to the user. Both sets of values, the ones measured during the playing of the clip and the ones measured before it, are compared in order to compute the user's affective response to the clip.

In some embodiments, “eye tracking” is a process of measuring either the point of gaze of the user (where the user is looking) or the motion of an eye of the user relative to the head of the user. An eye tracker is a device for measuring eye positions and/or movement of the eyes. Optionally, the eye tracker and/or other systems measure positions of the head and/or movement of the head. Optionally, an eye tracker may be head mounted, in which case the eye tracking system measures eye-in-head angles. However, by adding the head position and/or direction to eye-in-head direction, it is possible to determine gaze direction. Optionally, the eye tracker device may be remote relative to the user (e.g., a video camera directed at the user), in which case the eye tracker may measure gaze angles.

Those skilled in the art may realize that there are various types of eye trackers and/or methods for eye tracking that may be used. In one example, eye tracking is done using optical tracking, which track the eye and/or head of the user; e.g., a camera may focus on one or both eyes and record their movement as the user looks at some kind of stimulus. In another example, eye tracking is done by measuring the movement of an object, such as a contact lens, attached to the eye. In yet another example, eye tracking may be done by measuring electric potentials using electrodes placed around the eyes.

In some embodiments, an eye tracker generates eye tracking data by tracking the user, for a certain duration. Optionally, eye tracking data related to an experience involving exposure of a user to content is generated by tracking the user as the user is exposed to the content. Optionally, tracking the user is done utilizing an eye tracker that is part of a content delivery module through which the user is exposed to content (e.g., a camera embedded in a phone or tablet, or a camera or electrodes embedded in a head-mounted device that has a display).

There may be various formats for eye tracking data, and eye tracking data may provide various insights. For example, eye tracking data may indicate a direction and/or an object the user was looking at, a duration the user looked at a certain object and/or in certain direction, and/or a pattern and/or movement of the line of sight of the user. Optionally, the eye tracking data may be a time series, describing for certain points in time a direction and/or object the user was looking at. Optionally, the eye tracking data may include a listing, describing total durations and/or time intervals, in which the user was looking in certain directions and/or looking at certain objects.

In one embodiment, eye tracking data is utilized to determine a gaze-based attention. Optionally, the gaze-based attention is a gazed-based attention of the user and is generated from eye tracking data of the user. Optionally, the eye tracking data of the user is acquired while the user is consuming content and/or in temporal vicinity of when a user consumes the content. Optionally, gaze-based attention may refer to a level of attention the user paid to the content the user consumed.

For example, if the user looks in a direction of the content and focuses on the content while consuming the segment, the gaze-based attention level at that time may be considered high. However, if the user only glances cursorily at the content, or generally looks in a direction other than the content while being exposed to the segment, the gaze-based attention level to the segment at that time may be low. Optionally, the gaze-based attention level may be determined for a certain duration, such as a portion of the time content is displayed to the user. Thus, for example, different durations that occur within the presentation of certain content may have different corresponding gaze-based attention levels according to eye tracking data collected in each duration.

In one example, a gaze-based attention level of the user to content may be computed, at least in part, based on difference between the direction of sight of the user, and the direction from the eyes of the user to a display on which the segment is presented. Optionally, the gaze-based attention level of the user to content is computed according to the difference between the average direction the user was looking at during a duration in which the content was being displayed, compared to the average direction of the display (relative to the user), during the duration. Optionally, the smaller the difference between the direction of sight and the direction of the content, the higher the gazed-based attention level. Optionally, the gaze-based attention level may be expressed by a value inversely proportional to the difference in the two directions (e.g., inversely proportional to the angular difference).

In another example, a gaze-based attention level of the user to content may be computed, at least in part, based on the portion time, during a certain duration, in which the user gazes in the direction of the content (e.g., looking at a module on which the content is displayed). Optionally, the gazed-based attention level is proportional to the time spent viewing the content during the duration. For example, if it is determined that the user spent 60% of the duration looking directly at the content, the gaze-based attention level may be reported as 60%.

In still another example, a gaze-based attention level of the user to content may be computed, at least in part, based on the time the user spent gazing at certain objects belonging to the content. For example, certain objects in the segment may be deemed more important than others (e.g., a lead actor, a product being advertised). In such a case, if the user is determined to be gazing at the important objects, it may be considered that the user is paying attention to the content. However, if the user is determined to be gazing at the background or at objects that are not important, it may be determined that the user is not paying attention to the content (e.g., the user is daydreaming). Optionally, the gaze-based attention level of the user to the content is a value indicative of the total time and/or percent of time that the user spent during a certain duration gazing at important objects in the content.

In yet another example, a gaze-based attention level of the user to content may be computed, at least in part, based on a pattern of gaze direction of the user during a certain duration. For example, if the user gazes away from the content many times, during the duration, that may indicate that there were distractions that made it difficult for the user to pay attention to the segment. Thus, the gaze-based attention level of the user to the segment may be inversely proportional to the number of times the user changed the direction at which the user gazed, e.g., looking and looking away from the content), and/or the frequency at which the user looked away from the content.

In one example, a gaze-based attention level of the user to content may be computed, at least in part, based on physiological cues of the eyes of the user. For example, the size of the pupil is known to be linked to the attention level; pupil dilation may indicate increased attention of the user in the content. In another example, a blinking rate and/or pattern may also be used to determine attention level of the user. In yet another example, if the eyes of the user are shut for extended periods during the presentation of content, that may indicate a low level of attention (at least to visual content).

In one embodiment, a gaze-based attention level of the user to a segment is computed by providing one or more of the data described in the aforementioned examples (e.g., values related to direction and/or duration of gaze, pupil size), are provided to a function that computes a value representing the gaze-based attention level. For example, the function may be part of a machine learning predictor (e.g., neural net, decision tree, regression model). Optionally, computing the gaze-based attention level may rely on additional data extracted from sources other than eye tracking. In one example, values representing the environment are used to predict the value, such as the location (at home vs. in the street), the number of people in the room with the user (if alone it is easier to pay attention than when with company), and/or the physiological condition of the user (if the user is tired or drunk it is more difficult to pay attention). In another example, values derived from the content may be used in computing the attention level, such as the type or genre of content, the duration of the content, may also be factors that may be considered in the computation. In yet another example, prior attention levels of the user and/or other users to similar content may be used in the computation (e.g., a part that many users found distracting may also be distracting to the user).

In one embodiment, a gaze-based attention level is represented by one or more values. For example, the attention level may be a value between 1 and 10, with 10 representing the highest attention level. In another example, the attention level may be a value representing the percentage of time the user was looking at the content. In yet another example, the attention level may be expressed as a class or category (e.g., “low attention”/“medium attention”’/“high attention”, or “looking at content”/“looking away”). Optionally, a classifier (e.g., decision tree, neural network, Naive Bayes) may be used to classify eye tracking data, and possibly data from additional sources, into a class representing the gaze-based attention level.

In one embodiment, a user's level of interests in some of the tokens may be derived from measurements of the user, which are processed to detect the level at which the user is paying attention to some of the token instances at some of the times.

In one embodiment, the attention level may be measured, for example by a camera and software that determines if the user's eyes are open and looking in the direction of the visual stimuli, and/or by physiological measurements that may include one or more of the following: heart-rate, electromyography (frequency of muscle tension), electroencephalography (rest/sleep brainwave patterns), and/or motion sensors (such as MEMS sensors held/worn by the user), which may be used to determine the level of the user's consciousness, co-consciousness, and/or alertness at a given moment. In one example, the fact that a user is looking or not looking at a display is used to determine the user's level of interest in a program appearing on the display.

In one embodiment, object-specific attention level may be measured for example by one or more cameras and software that performs eye-tracking and/or gaze monitoring to detect what regions of a display, or region of an object, or physical element the user is focusing his/her attention at. The eye-tracking/gaze information can be compared to object annotation of the picture/scene the user is looking at to assign weights and/or attention levels to specific token instances, which represent the objects the user is looking at.

In one embodiment, various methods and models for predicting the user's interest level are used in order to assign interest level scores for some token instances.

In one embodiment, user interest levels in image-based token instances are predicted according to one or more automatic importance predicting algorithms, such as the one described in Spain, M. & Perona, P. (2011), Measuring and Predicting Object Importance, International Journal of Computer Vision, 91 (1). pp. 59-76. In another embodiment, user interest in objects is estimated using various video-based attention prediction algorithms such as the one described in Zhai, Y. and Shah, M. (2006), Visual Attention Detection in Video Sequences Using Spatiotemporal Cues, In the Proceedings of the 14th annual ACM international conference on Multimedia, pages 815-824, or Lee, W. F. et al. (2011), Learning-Based Prediction of Visual Attention for Video Signals, IEEE Transactions on Image Processing, 99, 1-1.

Optionally, the predicted level of interest from such models may be stored as an attribute value for some token instances. In one example, a model for predicting the user's interest level in various visual objects is created automatically using the one or more selected automatic importance predicting algorithm, using token instances for which there is user attention-monitoring, as training data. In one embodiment, different types of tokens are tagged with different attention data, optionally in parallel.

Analysis of previous observations of the user's interest in some tokens may be used to determine interest in new, previously unobserved, tokens. In one embodiment, a machine learning algorithm is used to create a model for predicting the user's interest in tokens, for which there is possibly no previous information, using the following steps: (i) extracting features for each token instance, for example describing the size, duration, color, subject of visual objects; (ii) using the attention-level monitoring data as a score for the user's interest; (iii) training a predictor on this data with a machine learning algorithm, such as neural networks or support vector machines for regression; and (iv) using the trained predictor to predict interest levels in instance of other (possibly previously unseen) tokens.

In one embodiment, analysis of previous observations of the user may be used to determine interest in specific tokens. In one embodiment, a predictor for the level of attention a user is expected to pay to different token instances is created by combining the attention predictor models and/or prediction data from other users through a machine learning collaborative filtering approach.

In one embodiment, information gathered from other users who were essentially exposed to the same token instances as the user may be used to assign interest levels for the user, for example, in cases where the user's interest level data is missing or unreliable. In one example, when assigning interest level to tokens extracted from a multimedia, at times when the user's eye-tracking information is missing or inconclusive for a token instance, the interest levels for that token instance can be set to average interest levels given to that token instance by other users who viewed the same multimedia content.

In one embodiment, an external source may provide the system with data on the user's interest level in some tokens and/or token instances. In one example, information on users' interest may be provided by one or more humans by answering a questionnaire indicating current areas of interest. The questionnaire may include areas such as: pets, celebrities, gadgets, media such as music and/or movies (genres, performers, etc.), and more. The questionnaire may be answered by the user, friends, relations, and/or a third party. In another example, semantic analysis of the user's communications such as voice and/or video conversations, instant messages, emails, blog posts, twits, comments in forums, keyword use in web searches, and/or browsing history may be used to infer interest in tokens describing specific subjects, programs, and or objects of interest. In yet another example, some of the user's subjects of interest may be provided by third-parties, such as social-networking sites like Facebook, and/or online retailers like Amazon.

In one embodiment, a temporal attention level is computed for the user at a specific time. Optionally, the user's temporal attention level refers to a specific token instance or group of token instances. In one example, the temporal attention level is stored as a time series on a scale from no attention being paid to full attention is being paid. Optionally, temporal attention level data is extracted from a visual attention data source (e.g., eye-tracking, face expression analysis, posture analysis), an auditory data sources, monitoring the users movement (e.g., analysis of motion sensor coupled to the user), and/or physiological measurements (e.g., EEG).

In one embodiment, interest levels obtained from various sources are combined into a single “combined interest level score”. The combined interest level score may be stored as an attribute in some of the token instances. In one example, the interest level scores from various sources such as attention-level monitoring, predicted interest based on the user's historical attention-levels, and/or interest data received from external data sources, may be available for a token instance. Optionally, the combined interest level score may be a weighted combination of the values from the different sources, where each source has a predefined weight.

In one embodiment, a module that receives a query that includes a sample (e.g., a vector of feature values), and predicts a label for that sample (e.g., a class associated with the sample), is referred to as a “predictor”. A sample provided to a predictor in order to receive a prediction for it may be referred to as a “query sample”. Additionally, the pair that includes a sample and its corresponding label may be referred to as a “labeled sample”.

In some embodiments, a sample for a predictor (e.g., a sample used as training data and/or a query sample) includes one or more feature values. Optionally, at least some of the feature values are numerical values. Optionally, at least some of the feature values may be categorial values that may be represented as numerical values (e.g., via indexes for different categories).

In some embodiments, a label that may serve as prediction value for a query sample provided to a predictor, may take one or more types of values. For example, a label maybe include a discrete categorial value (e.g., a category), a numerical value (e.g., a real number), and/or a multidimensional value (e.g., a point in multidimensional space).

In one embodiment, a predictor utilizes a model in order to make predictions for a given query sample. There is a plethora of machine learning algorithms for training different types of models that can be used for this purpose. Some of the algorithmic approaches that may be used for creating the predictor are classification, clustering, function prediction, and/or density estimation. Those skilled in the art can select the appropriate type of model depending on the characteristics of the training data (e.g., it's dimensionality), and/or the type of value used as labels (e.g., discrete value, real value, or multidimensional).

For example, classification methods like Support Vector Machines (SVMs), Naive Bayes, nearest neighbor, and/or neural networks can be used to create a predictor of a discrete class label. In another example, algorithms like a support vector machine for regression, neural networks, and/or gradient boosted decision trees can be used to create a predictor for real-valued labels, and/or multidimensional labels. In yet another example, a predictor may utilize clustering of training samples in order to partition a sample space such that new query samples can be placed in clusters and assigned labels according to the clusters they belong to. In somewhat similar approach, a predictor may utilize a collection of labeled samples in order to perform nearest neighbor classification (in which a query sample is assigned a label according to the labeled samples that are nearest to them in some space).

In one embodiment, semi-supervised learning methods are used to train a predictor's model, such as bootstrapping, mixture models and Expectation Maximization, and/or co-training. Semi-supervised learning methods are able to utilize as training data unlabeled samples in addition to the labeled samples.

In one embodiment, a predictor may return as a label other samples that are similar to a given query sample. For example, a nearest neighbor approach method may return one or more samples that are closest in the data space to the query sample (and thus in a sense are most similar to it.)

In one embodiment, in addition to a label predicted for a query sample, a predictor may provide a value describing a level of confidence in its prediction of the label. In some cases, the value describing the confidence level may be derived directly from the prediction process itself. For example, a predictor utilizing a classifier to select a label for a given query sample may provide a probability or score according to which the specific label was chosen (e.g., a Naive Bayes' posterior probability of the selected label, or a probability derived from the distance of the sample from the hyperplane when using an SVM).

In one embodiment, a predictor making a prediction for a query sample returns a confidence interval as its prediction or in addition to a predicted label. A confidence interval is a range of values and an associated probability that represents the chance that the true value corresponding to the prediction falls within the range of values. For example, if a prediction is made according to an empirically determined Normal distribution with a mean m and variance ŝ2, the range [m−2s,m+2s] corresponds approximately to a 95% confidence interval surrounding the mean value m.

The type and quantity of training data used to train a predictor's model can have a dramatic influence on the quality of the predictions made by the predictor. Generally speaking, the more data available for training a model, and the more the training samples are similar to the samples on which the predictor will be used (also referred to as test samples), the more accurate the predictions for the test samples are likely to be. Therefore, when training a model that will be used to make predictions regarding a specific user, it may be beneficial to collect training data from the user (e.g., data comprising measurements of the specific user).

In the embodiments, a predictor that predicts a label that is related to an emotional response may be referred to as a “predictor of emotional response” or an Emotional Response Predictor (ERP). A predictor of emotional response that receives a query sample that includes features that describe content may be referred to as a predictor of emotional response from content, a “content emotional response predictor”, and/or a “content ERP”. Similarly, a predictor of emotional response that receives a query sample that includes features that describe an experience may be referred to as a predictor of emotional response to an experience, an “experience emotional response predictor”, and/or an “experience ERP”. Similarly, a predictor of emotional response that receives a query sample that includes features derived from measurements of a user, such as affective response measurements taken with a sensor, may be referred to as a predictor of emotional response from measurements, a “measurement emotional response predictor”, and/or a “measurement ERP”. Additionally, a model utilized by an ERP to make predictions may be referred to as an “emotional response model”.

In some embodiments, a model used by an ERP (e.g., a content ERP and/or a measurement ERP), is primarily trained on data collected from a plurality of users and at least 50% of the training data used to train the model does not involve a specific user. In such a case, a prediction of emotional response made utilizing such a model may be considered a prediction of the emotional response of a representative user. It is to be noted that the representative user may in fact not correspond to an actual single user, but rather correspond to an “average” of a plurality of users. Additionally, under the assumption that a specific user has emotional responses that are somewhat similar to other users' emotional responses, the prediction of emotional response for the representative user may be used in order to determine the likely emotional response of the specific user.

In some embodiments, a label returned by an ERP may represent an affective response, such as a value of a physiological signal (e.g., GSR, heart rate) and/or a behavioral cue (e.g., smile, frown, blush).

In some embodiments, a label returned by an ERP may be a value representing a type of emotional response and/or derived from an emotional response. For example, the label my indicate a level of interest and/or whether the response can be classified as positive or negative (e.g., “like” or “dislike”).

In some embodiments, a label returned by an ERP may be a value representing an emotion. In the embodiments, there are several ways to represent emotions (which may be used to represent emotional states and emotional responses as well). Optionally, but not necessarily, an ERP utilizes one or more of the following formats for representing emotions returned as its predictions.

In one embodiment, emotions are represented using discrete categories. For example, the categories may include three emotional states: negatively excited, positively excited, and neutral. In another example, the categories include emotions such as happiness, surprise, anger, fear, disgust, and sadness.

In one embodiment, emotions are represented using a multidimensional representation, which typically characterizes the emotion in terms of a small number of dimensions. In one example, emotional states are represented as points in a two dimensional space of Arousal and Valence. Arousal describes the physical activation and valence the pleasantness or hedonic value. Each detectable experienced emotion is assumed to fall in a specified region in that 2D space. Other dimensions that are typically used to represent emotions include: potency/control (refers to the individual's sense of power or control over the eliciting event), expectation (the degree of anticipating or being taken unaware), and intensity (how far a person is away from a state of pure, cool rationality). The various dimensions used to represent emotions are often correlated. For example, the values of arousal and valence are often correlated, with very few emotional displays being recorded with high arousal and neutral valence. In one example, emotions are represented as points on a circle in a two dimensional space pleasure and arousal, such as the circumflex of emotions.

In one embodiment, emotions are represented using a numerical value that represents the intensity of the emotional state with respect to a specific emotion. For example, a numerical value stating how much the user is enthusiastic, interested, and/or happy. Optionally, the numeric value for the emotional state may be derived from a multidimensional space representation of emotion; for instance, by projecting the multidimensional representation of emotion to the nearest point on a line in the multidimensional space.

In one embodiment, emotional states are modeled using componential models that are based on the appraisal theory, as described by the OCC model (Ortony, A.; Clore, G. L.; and Collins, A. 1988. The Cognitive Structure of Emotions. Cambridge University Press). According to this theory, a person's emotions are derived by appraising the current situation (including events, agents, and objects) with respect to the person goals and preferences.

In some embodiments, an ERP such as a content ERP, experience ERP, or a measurement ERP may receive additional input values that may describe a situation (e.g., the situation of the user) and/or a baseline value (e.g., a baseline value of the user). Optionally, the ERP is trained on data that includes the additional input values, which describe a situation and/or a baseline value.

These additional inputs may be utilized by the ERP to make better predictions, according to the situation and/or baseline value. For example, if the situation indicates that the user is tired, a content ERP may predict that the user is not likely to enjoy certain content (e.g., a piece of music that is challenging to follow); however had the situation been different, e.g., the user was not tired, the content ERP might have predicted that the user would enjoy the piece of music. In another example, a measurement ERP may receive a baseline value indicating the user's mood (e.g., as determined from measurements taken throughout the day). The baseline value may be utilized in order to refine and adjust the predictions of the ERP relative to the baseline. Thus, if the user is generally grumpy, elevated heart rate and GSR values may indicate agitation compared to excitement that would have been typically predicted.

In one embodiment, a measurement ERP is used to predict an emotional response of a user from a query sample that includes feature values derived from affective response measurements. Optionally, the affective response measurements are preprocessed and/or undergo feature extraction prior to being received by the measurement ERP. Optionally, the prediction of emotional response made by the measurement ERP is a prediction of the emotional response of a specific user. Alternatively or additionally, the prediction of emotional response made by the measurement ERP is a prediction of emotional response of a representative user.

There are various methods in which a measurement ERP may predict emotional response from measurements of affective response. Examples of methods that may be used in some embodiments include: (i) physiological-based predictors as described in Table 2 in van den Broek, E. L., et al. (2010) Prerequisites for Affective Signal Processing (ASP)—Part II. In: Third International Conference on Bio-Inspired Systems and Signal Processing, Biosignals 2010; and/or (ii) Audio- and visual-based predictors as described in Tables 2-4 in Zeng, Z., Pantic, M., Roisman, G. I., and Huang, T. S. (2009) A Survey of Affect Recognition Methods: Audio, Visual, and Spontaneous Expressions. IEEE Transaction on Pattern Analysis and Machine Intelligence, Vol. 31(1), 39-58.

In one embodiment, a measurement ERP may need to make decisions based on measurement data from multiple types of sensors (often referred to in the literature as multiple modalities). This typically involves fusion of measurement data from the multiple modalities. Different types of data fusion may be employed, for example feature-level fusion, decision-level fusion, or model-level fusion, as discussed in Nicolaou, M. A., Gunes, H., & Pantic, M. (2011), Continuous Prediction of Spontaneous Affect from Multiple Cues and Modalities in Valence-Arousal Space, IEEE Transactions on Affective Computing.

In one embodiment, a content ERP is used to predict an emotional response of a user from a query sample that includes feature values derived from content. Optionally, the content is preprocessed and/or undergoes feature extraction prior to being received by the content ERP. Optionally, the prediction of emotional response to the content made by the content ERP is a prediction of the emotional response of a specific user to the content. Alternatively or additionally, the prediction of emotional response to the content made by the content ERP is a prediction of emotional response of a representative user.

In another embodiment, an experience ERP is used to predict an emotional response of a user from a query sample that includes feature values derived from a description of an experience (e.g., an experience involving consumption of content or an activity the user participates in). The description may cover various aspects of the activity such as the participants, the location, what happens, and/or content involved in the activity, Optionally, the prediction of emotional response to the experience made by the content ERP is a prediction of the emotional response of a specific user to the experience. Alternatively or additionally, the prediction of emotional response to the experience is a prediction of emotional response of a representative user.

Herein, in some embodiments, the term “content ERP” may be used interchangeably with the term “experience ERP”; the prediction of the experience ERP to consuming content may replace, or be replaced by, the prediction of a content ERP on the content. Similarly, feature values describing an experience may be considered as describing the content of the experience; thus in some cases, predicting the emotional response to an experience by be done using the content ERP. In these cases, the use of the terms “content ERP” and “experience ERP” may be done depending on the context; when the experience is likely to involve consumption of content, the term “content ERP” may be used instead of the term “experience ERP”.

In one embodiment, feature values are used to represent at least some aspects of a content and/or an experience. Various methods may be utilized to represent aspects of content as feature values. For example, the text in a segment that includes text content can be converted to N-gram or bag of words representations, in order to set the values of at least some of the feature values. In another example, an image or video clip from a segment that includes visual content may be converted to features by applying various low-pass and/or high-pass filters; object, gesture and/or face recognition procedures; genre recognition; and/or dimension reduction techniques. In yet another example, auditory signals are converted to features values such as low-level features describing acoustic characteristics such as loudness, pitch period and/or bandwidth of the audio signal. In still another example, semantic analysis may be utilized in order to determine feature values that represent the meaning of the content of a segment.

There are many feature extraction methods mentioned in the literature that can be utilized to create features for audio-, image-, and/or video-containing content. For example, useful feature extraction methods are used in areas such as visual content-based video indexing and retrieval, automatic video highlighting, and affective video content representation and modeling.

In one embodiment, training data used to create a content ERP and/or an experience ERP, is collected from one or more users. Optionally, a sample used as training data is derived from content to which a user is exposed; the sample's corresponding label may be generated from measurements of the user's affective response to the content, e.g., by providing the measurements to a measurement ERP. Optionally, at least a portion of the training data is collected from the user. Additionally or alternatively, at least a portion of the training data is collected from a set of users that does not include the user.

In one embodiment, to make predictions, the content ERP and/or experience ERP utilize feature values that describe aspects beyond the scope of the data conveyed in the content or experience. These additional aspects can have an impact on a user's emotional response to the content and/or the experience, so utilizing feature values describing these values can make predictions more accurate.

In particular, in many cases, a prediction of a user's emotional response may depend on the context and situation in which the content is consumed. For example, for content such as an action movie, a user's emotional response might be different when viewing a movie with friends compared to when viewing alone (e.g., the user might be more animated and expressive with his emotional response when viewing with company). However, the same user's response might change dramatically to uneasiness and/or even anger if younger children are suddenly exposed to the same type of content in the user's company. Thus, context and situation, such as who is consuming content with the user can have a dramatic effect on a user's emotional response.

Similarly, a user's emotional state, such as a user's mood, can also influence a user's emotional response to content. For example, while under normal circumstances, a slapstick oriented bit of comedy might be dismissed by a user as juvenile, a user feeling depressed might actually enjoy it substantially more (as a form of a comedic “pick-me-up”), and even laugh heartily at the displayed comedic antics.

Therefore, in order to capture information regarding context and/or situation in which a user consumes the content or has the experience, in some embodiments, samples that may be provided to an ERP include feature values describing the context in which the content is consumed and/or the user's situation. For example, these feature values may describe aspects related to the user's location, device on which the content is consumed, people in the user's vicinity, tasks or activities the user performed or needs to perform (e.g., work remaining to do), and/or the user's or other peoples emotional state as determined, for example, from analyzing communications of a log of the activities of the user and/or other people related to the user. In another example, the feature values describing context and/or situation may include physiological measurements and/or baseline values (e.g., current and/or typical heart rate) of the user and/or other people.

As well as consuming content, a user interacting with a digital device may also generate content that can undergo analysis. For example, messages created by a user (e.g., a spoken sentence and/or a text message), are user-generate content that may be analyzed to determine the user's emotional state (e.g., using voice stress analysis, and/or semantic analysis of a text message). In another example, information regarding the way a user plays a game, such as the number of times the user shoots in a shooter game and/or the type of maneuvers a user performs in a game that involves driving a vehicle, are also user-generated content that can be analyzed. Therefore, in one embodiment, one or more features derived from a segment of user-generated content are included in a sample for the content ERP, in order to provide further information on context in which the content is consumed and/or on the user's situation.

One source of data that has been found useful for predicting a user's emotional response to content has been the emotional responses of other users' to content (an approach sometimes referred to as “collaborative filtering”). In one embodiment, a content ERP utilizes data regarding other users' emotional responses to content. For example, by comparing a user's emotional response to certain segments of content, with the emotional responses other users had to at least some of those segments, it is possible to find other users that respond similarly to the user in question. These users may be said to have a similar response profiles to the user. Thus, in order to predict the user's response to previously unobserved content, a content ERP may rely on the responses that other users, with a similar response profiles to the user, had to the unobserved segment.

In one embodiment, a sample provided to a content ERP may include data related to the number of times a user was previously exposed to certain token instances and/or when some of the previous exposures to the token instances took place. This information may be utilized by the content ERP to adjust its predictions to take into accounts the effects of habituation. Habituation may cause the user to have a reduced response to certain token instances, if the user was exposed multiple times to the token instances. In such a case, an additional exposure may not elicit as strong a response from the user as the initial response. For example, a user may be excited by seeing images of a cute kitten; however, the response to seeing the cute kittens for the tenth time during the day may not be as strong.

In one embodiment, a sample provided to a content ERP may include data related to the number of token instances to which the user is simultaneously exposed. This information may be utilized by the content ERP in order to adjust its predictions to take into account the effects of saturation. When a user is simultaneously exposed to many stimuli, that can overwhelm the user; this may lead to a diminished effect of the token instances on the user compared to the effect they may have when the user is exposed to only one token instance, or a smaller number of token instances, simultaneously. Thus, in certain cases the accuracy of a content ERP's prediction may be improved if the content ERP compensates for the effects of saturation.

In one embodiment, a response to a token instance such as a measured response or a predicted response are expressed as an absolute value. For example, a response may be an increase of 5 beats per minute to the heart rate or an increase of 2 points on a scale of arousal. Alternatively or additionally, a response may be expressed as a ratio (compared to an initial or baseline value). For example, the total response to being exposed to token instances may be an increase of 10% to the heart rate compared to a measurement taken before the exposure to token instances. Alternatively or additionally, a response may be expressed as relative or qualitative change. For example, a response may be paraphrased as the user being slightly happier than his/her original state.

In one embodiment, a response of the user to being exposed to token instances, e.g., a measured response or a predicted response, may be computed by comparing an early response of with a response of the user corresponding to a later time. For example, the early response my correspond to the beginning of the exposure, while the later response may correspond to the end of the exposure. Optionally, the response is obtained by subtracting the early response from the later response. Optionally, the total response is obtained by computing the ration between the later response and the early response (e.g., by dividing a value of the later response by a value of the early response).

In one example, the total response may be expressed as a change in the user's heart rate; it may be computed by subtracting a first heart rate value from a later second heart rate value, where the first value is taken in temporal proximity the beginning of the user's exposure to the received token instances while the later second value is taken in temporal proximity to the end of the user's exposure to the received token instances. In another example, the total response to the token instances is computed by comparing emotional states corresponding to the beginning and the end of the exposure to the token instances. For example, the total response may be the relative difference in the level of happiness and/or excitement that the user is evaluated to be in (e.g., computed by dividing the level after the exposure to the token instances by the level before the exposure to the token instances).

Herein, temporal proximity refers to closeness in time. Two events that occur in temporal proximity, occur at times close to each other. For example, measurements of the user used that are taken at temporal proximity to the beginning of the exposure of the user to the token instances, may be taken a few seconds before and/or possibly a few seconds after the beginning of the exposure (some measurement channels such as GSR or skin temperature may change relatively slowly compared to fast changing measurement channel such as EEG). Similarly, measurements of the user that are taken at temporal proximity to the beginning of the exposure of the user to the token instances may be taken a few seconds before and/or possibly a few seconds after the beginning of the exposure.

In one embodiment, responses used to compute the measured or predicted response to token instances may be a product of a single value. For example, a response corresponding to before the exposure to the token instances may be a measurement value such as a single GSR measurement taken before the exposure. Alternatively, responses used to compute the measured or predicted response to token instances may be a product of may be a product of multiple values. For example, a response may be average of user channel measurement values (e.g., heart rate, GSR) taken during the exposure to the token instances. In another example, a response is a weighted average of values; for instance, user measurement values used to derive the response may be weighted according to the attention of the user as measured at when the user measurements were taken.

In one embodiment, the response of the user to the token instances to which the user is exposed is computed by comparing a response of the user with a baseline value. Optionally, the baseline value may be computed from measurements (e.g., the user's resting heart-rate as computed over several hours). Additionally or alternatively, the baseline value may be predicted such as a machine learning-trained model. For example, such a model may be used to predict that in a certain situation such as playing a computer game, the user is typically mildly excited. Optionally, the response may be computed by subtracting a baseline value from the measured response to being exposed to token instances.

In one embodiment, computing a response to token instances involves receiving a baseline value for the user. The computation of the user's response maybe done with adjustments with respect to the baseline value. For example, the user's response may be described as a degree of excitement which is the difference between how excited the was before and after being exposed to the token instance. This computation can also take into account the distance of values from the baseline value. Thus, for example, if before the exposure to the token instances, the user was in an over-excited state (much above the baseline), and after the exposure the user's excitement level was only slightly above the base line, part of the decline may be attributed to the user's natural return to a baseline level of excitement.

In one embodiment, the response of the user to a certain token instance (e.g., a token instance of interest) is estimated according to the difference between two values, such as two measured responses, a measured response and a representation of measurements, and/or a measured response and a predicted response. Optionally, the difference is obtained by subtracting one of the values from the other (e.g. subtracting the value of a measured response from the representation of measurements). Optionally, the difference may be obtained using a distance function. For example, the difference between response values expressed as multi-dimensional points may be given according to the Euclidean distance between the points. Additionally or alternatively, the difference between two multi-dimensional values may be expressed as a vector between the points representing the values.

In one embodiment, the estimated response to the certain token instance may derived from the value of the difference in addition to one or more normalizations and/or adjustments according to various factors.

In one example, estimating the response of the user to the certain token instance of interest takes into account the response which was determined for other users. Optionally, the other users have similar responses to the user (e.g., they respond to many token instances in the same way). Thus, if in some cases, the user's response is significantly different from the response other users have to the certain token instance, the user's response may be normalized and set to be closer to the other users' response (e.g., by setting the user's response to be the average of the other users' response and the user's originally estimated response).

In another example, estimating the response of the user to the certain token instance may take into account a baseline value for the user. If the user's initial state before being exposed to the certain token instances is different from a received baseline value, then the estimated response may be corrected in order to account for a natural return to the baseline. For example, if the user's response is described via a physiological measurement such as a change to the heart rate, estimating the response to the certain token instance needs to take into account the rate at which the user's heart rate returns to the baseline value (which may happen within tens of seconds to a few minutes). Thus, for example an initial estimate of the response may show that the response to the certain token instance was not substantial (e.g., there was very little change to the heart rate). However, if the user was unexcited to begin with, then over the time the user's heart rate should decrease to return to the baseline. However, if the heart rate did not return to the baseline at the expected rate, this can be attributed, at least in part, to the user's response to the certain token instance; thus the estimation of the response may be amended in this case (e.g., by increasing the value of the estimated response to account for the tendency to return to the baseline value).

In still another example, estimating the response of the user to the certain token instance may take into account information regarding the other token instances the user was exposed at the time. In some cases, the user's attention may be focused on a single token instance or small number of token instances at any given time (e.g., if the user is looking at details in an image). If there are many token instances to which the user is exposed simultaneously, this can lead to saturation, in which due to the sensory overload, the user's response to individual token instances may be diminished. Thus, estimating the user's response to the certain token instance may take into account corrections due to saturation. For example, if the user is exposed to many token instances at the same time, the original estimate of the response may be increase to compensate for the fact that there were many token instances competing for the user's attention that may have distracted the user from the certain token instance.

In one embodiment, a model used for predicting affective response is analyzed in order to generate a library of expected affective response to token instances. Herein, by stating the library is of expected affective response to token instances, it is meant that the library may be utilized to determine the affective response to the tokens (e.g., the typical response to a token without having a specific instantiation of the token in mind) and to instantiations of tokens (the token instances). Optionally, the model utilized for generating the library is a model trained for a predictor, such as a content ERP. The library may include values that represent the affective response of the user to token instances. Optionally, the user's affective response to the token instances is expressed as an expected emotional response and/or as a value representing a physiological signal and/or behavioral cue. Additionally or alternatively, the user's affective response to the token instances may be expressed as an expected change to an emotional state and/or as a change to a value representing a physiological signal and/or behavioral cue.

In one embodiment, the training data used to generate the model used for predicting affective response includes samples generated from token instances representing experiences (e.g., content a user was exposed to and/or activities a user participated in). Additionally, the training data used to generate the model may include target values corresponding to the experiences in the form of affective responses, which represent the user's response to the experiences. Optionally, the affective responses used to generate the target values include measurements of affective response taken with one or more sensors.

In one embodiment, the library is generated from the model used for predicting affective response includes various values and/or parameters extracted from the model. Optionally, the extracted values and/or parameters indicate the type and/or extent of affective response to some token instances. Optionally, the extracted values and/or parameters indicate characteristics of the affective response dynamics, for example, how a user is affected by phenomena such as saturation and/or habituation, and/or how fast the user's state returns to baseline levels, how the affective response changes when the baseline is at different levels (such as when the user is aroused vs. not aroused).

In one embodiment, the model for predicting affective response that is used to generate the library is trained on data collected by monitoring a user over a long period of time (for instance hours, days, months and even years), and/or when the user is in a large number of different situations. Optionally, the training data is comprised of token instances originating from multiple sources and/or of different types. In one example, some token instances may represent elements extracted from digital media content (e.g., characters, objects, actions, plots, and/or low-level features of the content). In another example, some token instances may represent elements extracted from an electromechanical device in physical contact with the user (e.g., sensor measurements of the user's state). In yet another example, some token instances may represent elements of an activity in which the user participated (e.g., other participants, the type of activity, location, and/or the duration).

In one embodiment, the training data may include some token instances with overlapping instantiation periods, i.e., a user may be simultaneously exposed to a plurality of token instances. Optionally, the user may be simultaneously exposed to a plurality of token instances originating from different token sources and/or different types of token sources. Optionally, some of the token instances originate from different token sources, and are detected by the user using essentially different sensory pathways (i.e., routes that conduct information to the conscious cortex of the brain).

In one embodiment, the training data collected by monitoring the user, is collected during periods in which the user is in a number of different situations. Optionally, the data is partitioned into multiple datasets according to the different sets of situations in which the user was in when the data was collected. Optionally, each partitioned training dataset is used to train a separate situation-dependent model, from which a situation-dependent library may be derived, which describes the user's expected affective response to token instances when the user is in a specific situation.

In one embodiment, data related to previous instantiations of tokens is added to some of the samples in the training data. This data is added in order for the trained model to reflect the influences of habituation. Thus, the library generated from the model may be considered a habituation-compensated library, which accounts for the influence of habituation on the user's response to some of the token instances. In some cases, habituation occurs when the user is repeatedly exposed to the same, or similar, token instances, and may lead to a reduced response on the part of the user when exposed to those token instances. By contrast, in some cases the user's response may gradually strengthen if repeatedly exposed to token instances that are likely to generate an emotional response (for example, repeated exposure to images of a disliked politician).

To account for the aforementioned possible influence of the user's previous exposures to instances of tokens, in one embodiment, certain variables may be added explicitly to some of the training samples. Optionally, the added variables may express for some token instances information such as the number of times a token was previously instantiated in a given time period (for example, the last minute, hour, day, or month), the sum of the weight of the previous instantiations of the token in the given time period, and/or the time since the last instantiation of the token. Optionally, the habituation-related information may be implicit, for example by including in the sample multiple variables corresponding to individual instantiations of the same token in order to reflect the fact that the user had multiple (previous) exposures to the token.

In one embodiment, a predictor is provided in order to classify some of the tokens into classes. For example, two token instances representing images of people may be classified into the same class. Optionally, information may be added to some of the training samples, regarding previous instantiations of tokens from certain classes, such as the number of times tokens of a certain class were instantiated in a given time period (for example, the last minute, hour, day, or month), the sum of the weight of the previous instantiations of tokens of a certain class in the given time period, and/or the time since the last instantiation of any token from a certain class.

In one embodiment, data related to the collection of token instances the user is exposed to simultaneously, or over a very short duration (such as a few seconds), is added to some of the samples in the training data. This data is added so the model, from which the library is generated, will be able to model the influence of saturation on the user's affective response; thus creating a saturation-compensated library. In some cases, saturation occurs when the user is exposed to a plurality of token instances, during a very short duration, and may lead to a reduced response on the part of the user (for instance due to sensory overload). Therefore, in one embodiment certain statistics may be added to some of the training samples, comprising information such as the number token instances the user was exposed to simultaneously (or during a short duration such as two seconds) and/or the weight of the token instances the user was exposed to simultaneously (or in the short duration). Optionally, a classifier that assigns tokens to classes based on their type can be used in order to provide statistics on the user's simultaneous (or near simultaneous) exposure to different types of token instances, such as images, sounds, tastes, and/or tactile sensations.

In one embodiment, the model used to generate the library is trained on data comprising significantly more samples than target values. For example, many of the samples that include token instances representing experiences may not have corresponding target values. Thus, most of the samples may be considered unannotated or unlabeled. In this case, the model may be trained using a semi-supervised machine learning training approach such as self-training, co-training, and/or mixture models trained using expectation maximization. In some cases, the models trained by semi-supervised methods may be more accurate than models learned using only labeled data, since the semi-supervised methods often utilize additional information from the unlabeled data. This may enable to compute things like distributions of feature values more accurately.

In one embodiment, the library may be accessed or queried using various methods. In one example, the library may be queried via a web-service interface. Optionally, the web-service is provided a user identification number and an affective response, and the service returns the tokens most likely to elicit the desired response. Optionally, the system is provided a token (or token instances), and the system returns the user's expected response. Optionally, the service is provided a token (or token instances), and the system returns a different token expected to elicit a similar response from the user.

In one embodiment, a Naive Bayes model is trained in order to create a library of a user's expected affective response to token instances. Optionally, the affective response is expressed using C emotional state categories. Optionally, the library comprises prior probabilities of the form p(c), 1≦c≦C, and class conditional probabilities of the form p(k|c), where k is an index of a token from 1 to N (total number of tokens). Optionally, the probability p(c|k) is computed using Bayes rule and the prior probabilities and the class conditional probabilities. Optionally, for each class, the tokens are sorted according to decreasing probability p(c|k), thus the library may comprise ranked lists of tokens according to how likely (or unlikely) they are to be correlated with a certain emotional states with the user.

In one embodiment, a maximum entropy model is trained in order to create a library of the use's expected affective response to token instances. Optionally, the model comprises the parameters λi,j, for 1≦i≦N, and 1≦j≦C, that correspond to the N×C feature functions used to train the model (assuming the input vectors have N features and there are C emotional state categories to classify to), and creating j lists of the form λ1,j . . . λN,j, one for each emotional state class j=1 . . . C. Optionally, For each class j=1 . . . C the parameters λ1,j . . . λN,j are sorted according to decreasing values; the top of the list (most positive λi,j values) represents the most positively correlated token instances with the class (i.e., being exposed to these token instances increases the probability of being in emotional state class j); the bottom of the list (most negative λi,j values) represents the most negatively correlated token instances with the class (i.e., being exposed to these token instances decreases the probability of being in emotional state class j). Optionally, some input variables (for example, representing token instances) are normalized, for instance to a mean 0 and variance 1, in order to make the weights assigned to feature functions more comparable between token instances.

In one embodiment, a regression model is trained in order to create a library of the user's expected affective response to token instances. Optionally, the model comprises the regression parameters βi, for 1≦i≦N, that correspond to the N possible token instances included in the model. Optionally, the parameters β1, . . . βN are sorted; the top of the list (most positive βi values) represents the token instances that most increase the response variable's value; the bottom of the list (most negative βi values) represents the most negatively correlated token instances with the class (i.e., being exposed to these token instances decreases the probability of being in emotional state class j). Optionally, some input variables (for example, representing token instances) are normalized, for instance to a mean 0 and variance 1, in order to make the parameters corresponding to different variables more comparable between token instances. Optionally, the regression model is a multidimensional regression, in which case, the response for each dimension may be evaluated in the library separately.

In one embodiment, parameters from the regression model may be used to gain insights into the dynamics of the user's response. In one example, a certain variable in the samples holds the difference between a current state and a predicted baseline state, for instance, the user's arousal level computed by a prediction model using user measurement channel vs. the user's predicted baseline level of arousal. The magnitude of the regression parameter corresponding to this variable can indicate the rate at which the user's arousal level tends to return to baseline levels. By comparing the value of this parameter in the user's model, with the values of the parameter in other people's models, insight can be gained into how the user compares to the general population.

In one embodiment, a neural network model is trained in order to create a library of the user's expected affective response to token instances. Optionally, the response may be represented by a categorical value, a single dimensional value, or a multidimensional value. Optionally, the neural network may be an Elman/Jordan recurrent neural network trained using back-propagation. Optionally, the model comprises information derived from the analysis of the importance and/or contribution of some of the variables to the predicted response. For example, by utilizing methods such as computing the partial derivatives of the output neurons in the neural network, with respect to the input neurons. In another example, sensitivity analysis may be employed, in which the magnitude of some of the variables in the training data is altered in order to determine the change in the neural network's response value. Optionally, other analysis methods for assessing the importance and/or contribution of input variables in a neural network may be used.

In one embodiment, the library comprises of sorting token (or token instances) according to the degree of their contribution to the response value, for example, as expressed by partial derivatives of the neural network's output values (the affective response), with respect to the input neurons that correspond with token instances. Optionally, the list of tokens may be sorted according to the results of the sensitivity analysis, such as the degree of change each token induces on the response value. Optionally, some input variables (for example, representing token instances) are normalized, for instance to a mean 0 and variance 1, in order to make the parameters corresponding to different variables more comparable between token instances. Optionally, the neural network model used to generate a response, predicts a multidimensional response value, in which case, the response for each dimension may be evaluated in the library separately.

In one embodiment, a random forest model is trained in order to create a library of the user's expected affective response to token instances. Optionally, the response may be represented by a categorical value, for example an emotional state, or categories representing transitions between emotional states. Optionally, the training data may be used to assess the importance of some of the variables, for example by determining how important they are for classifying samples, and how important they are for classifying data correctly in a specific class. Optionally, this may be done using data permutation tests or the variables' GINI index, as described at http://stat-www.berkeley.edu/users/breiman/RandomForests/cc_home.htm.

In one embodiment, the library may comprise ranked lists or tokens according to their importance toward correct response classification, and towards correct classification to specific response categories. Optionally, some input variables (for example, representing token instances) are normalized, for instance to a mean 0 and variance 1, in order to make the parameters corresponding to different variables more comparable between token instances.

Semantic analysis is often used to determine the meaning of content from its syntactic structure. Optionally, semantic analysis of content may be used to create feature values that represent the meaning of a portion of content; such as features describing the meaning of one or more words, one or more sentences, and/or the full segment of content.

Providing insight into the meaning of the segment of content may help to predict the user's emotional response to the segment of content more accurately. For example, a segment of content that is identified as being about a subject that the user likes, is likely to cause the user to be interested and/or evoke a positive emotional response. In another example, being able to determine that the user received a message that expressed anger (e.g., admonition of the user), can help to reach the conclusion that the user is likely to have a negative emotional response to the content.

In some embodiments, semantic analysis may be utilized to determine whether certain emotions are expresses such as hesitation and/or apprehension regarding certain content and/or experiences. Semantic analysis of content can utilize various procedures that provide an indication of the meaning of the content.

In one embodiment, Latent Semantic Indexing (LSI) and/or Latent Semantic Analysis (LSA) are used to determine the meaning of content comprising text (e.g., a paragraph, a sentence, a search query). LSI and LSA involve statistically analyzing the frequency of words and/or phrases in the text in order to associate the text with certain likely concepts and/or categories.

In one embodiment, semantic analysis of a segment of content utilizes a lexicon that associates words and/or phrases with their core emotions. For example, the analysis may utilize a lexicon similar to the one described in “The Deep Lexical Semantics of Emotions” by Hobbs, J. R. and Gordon, A. S., appearing in Affective Computing and Sentiment Analysis Text, Speech and Language Technology, 2011, Volume 45, 27-34, which describe the manual creation of a lexicon that classifies words into 32 categories related to emotions.

In one embodiment, semantic analysis of content involves using an algorithm for determining emotion expressed in text. The information on the emotion expressed in the text may be used in order to provide analysis algorithms with additional semantic context regarding the emotional narrative conveyed by text. For example, algorithms such as the ones described in “Emotions from text: machine learning for text-based emotion prediction” by Alm, C. O. et al, in the Proceedings of Human Language Technology Conference and Conference on Empirical Methods in Natural Language (2005), pages 579-586, can be used to classify text into the basic emotions such as anger, disgust, fear, happiness, sadness, and/or surprise. The information on the emotion expressed in the text can be provided as feature values to a predictor of emotional response.

In one embodiment, a segment of content to which the user is exposed includes information that can be converted to text. For example, vocal content such as a dialogue is converted to text using speech recognition algorithms, which translate spoken text into words. Optionally, the text of the converted content is subjected to semantic analysis methods. Optionally, vocal content that may be subjected to semantic analysis is generated by the user (e.g., a comment spoken by the user).

While the above embodiments described in the general context of program components that execute in conjunction with an application program that runs on an operating system on a computer, which may be a personal computer, those skilled in the art will recognize that aspects may also be implemented in combination with other program components. Program components may include routines, programs, modules, data structures, and other types of structures that perform particular tasks or implement particular abstract data types. Moreover, the embodiments may be practiced with other computer system configurations, including hand-held devices, multiprocessor systems, microprocessor-based or programmable consumer electronics, minicomputers, mainframe computers, and comparable computing devices. The embodiments may also be practiced in a distributed computing environment where tasks are performed by remote processing devices that are linked through a communications network. In a distributed computing environment, program components may be located in both local and remote memory storage devices.

Embodiments may be implemented as a computer-implemented process, a computing system, or as an article of manufacture, such as a computer program product or computer readable media. The computer program product may be a computer storage medium readable by a computer system and encoding a computer program that comprises instructions for causing a computer or computing system to perform example processes. The computer-readable storage medium can for example be implemented via one or more of a volatile computer memory, a non-volatile memory, a hard drive, a flash drive, a disk, a compact disk, and/or comparable media.

Throughout this specification, references are made to services. A service as used herein describes any networked/on line applications that may receive a user's personal information as part of its regular operations and process/store/forward that information. Such applications may be executed on a single computing device, on multiple computing devices in a distributed manner, and so on. Embodiments may also be implemented in a hosted service executed over a plurality of servers or comparable systems. The term “server” generally refers to a computing device executing one or more software programs typically in a networked environment. However, a server may also be implemented as a virtual server (software programs) executed on one or more computing devices viewed as a server on the network. Moreover, embodiments are not limited to personal data. Systems for handling preferences and policies may be implemented in systems for right management and/or usage control using the principles described above.

Herein, a predetermined value, such as a predetermined confidence level or a predetermined threshold, is a fixed value and/or a value determined any time before performing a calculation that compares its result with the predetermined value. A value is also considered to be a predetermined value when the logic used to determine a threshold is known before start calculating the threshold.

In this description, references to “one embodiment” mean that the feature being referred to may be included in at least one embodiment of the invention. Moreover, separate references to “one embodiment” or “some embodiments” in this description do not necessarily refer to the same embodiment.

The embodiments of the invention may include any variety of combinations and/or integrations of the features of the embodiments described herein. Although some embodiments may depict serial operations, the embodiments may perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed. The embodiments are not limited in their applications to the details of the order or sequence of steps of operation of methods, or to details of implementation of devices, set in the description, drawings, or examples. Moreover, individual blocks illustrated in the figures may be functional in nature and do not necessarily correspond to discrete hardware elements.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple instantiations of a mechanism unless noted otherwise. For example, when an interface is disclosed in one embodiment, the scope of the embodiment is intended to also cover the use of multiple interfaces. Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments. Accordingly, it is intended to embrace all such alternatives, modifications, and variations that fall within the spirit and scope of the appended claims and their equivalents.

What is claimed is:

1. A system configured to respond to apprehension of a user towards an experience with an explanation indicative of similarity between the experience and a prior experience of the user, comprising:
an expression analyzer configured to receive an expression of the user and to analyze the expression to determine that the expression indicates apprehension of the user towards the experience;
the expression analyzer is further configured to extract a first token instance from the expression; wherein the first token instance represents an aspect of the experience;
an experience selector configured to select a prior experience, from among prior experiences, such that the prior experience is represented by a second token instance that is more similar to the first token instance than most of the token instances representing the other prior experiences, and an affective response of the user to the prior experience reaches a predetermined threshold; whereby the fact that the affective response reaches the predetermined threshold implies that there is a probability of more than 10% that the user remembers the prior experience; and
an explanation generator configured to generate an explanation of relevance of the experience to the user, which is indicative of similarity between the first token instance and the second token instance.

2. The system of claim 1, further comprising a user interface configured to present the explanation to the user in response to the expression of the user indicating the apprehension.

3. The system of claim 2, further comprising a user condition detector configured to delay presentation of the explanation until determining that the user is amenable to receive the explanation.

4. The system of claim 1, wherein the expression analyzer utilizes semantic analysis to extract the first token instance; and wherein the semantic analysis indicates that the first token instance is likely a cause of the apprehension of the user towards the experience.

5. The system of claim 1, wherein the expression analyzer utilizes eye tracking to extract first token instance; and wherein the eye tracking identifies an object, represented by the first token instance, on which gaze of the user is fixated.

6. The system of claim 1, wherein the explanation of relevance comprises a description of an affective response of the user to the prior experience.

7. The system of claim 1, wherein the second token instance is a token instance for which measured attention level of the user is highest, compared to attention level to other token instances representing the prior experience.

8. The system of claim 1, wherein the second token instance is a token instance for which predicted attention level is the highest, compared to attention level predicted for other token instances representing the prior experience.

9. A method for responding to apprehension of a user towards an experience with an explanation indicative of similarity between the experience and a prior experience of the user, comprising:
receiving an expression of the user;
analyzing the expression to determine that the expression indicates apprehension of the user towards the experience;
extracting a first token instance from the expression; wherein the first token instance represents an aspect of the experience;
selecting a prior experience, from among prior experiences, such that the prior experience is represented by a second token instance that is more similar to the first token instance than most of the token instances representing the other prior experiences, and affective response of the user to the prior experience reaches a predetermined threshold; whereby the fact that the affective response reaches the predetermined threshold implies that there is a probability of more than 10% that the user remembers the prior experience; and
generating an explanation of relevance of the experience to the user, which is indicative of similarity between the first token instance and the second token instance.

10. The method of claim 9, further comprising presenting the explanation to the user as a response to the expression of the user indicating the apprehension.

11. The method of claim 9, further comprising utilizing semantic analysis for the extracting of the first token instance; wherein the semantic analysis indicates that the first token instance is likely a cause of the apprehension of the user towards the experience.

12. The method of claim 9, further comprising utilizing eye tracking for the extracting of the first token instance; wherein the eye tracking identifies an object, represented by the first token instance, on which gaze of the user is fixated.

13. The method of claim 9, wherein the explanation of relevance comprises a description of an affective response of the user to the prior experience.

14. The method of claim 9, wherein the second token instance is a token instance for which measured attention level of the user is highest, compared to attention level to other token instances representing the prior experience.

15. The method of claim 9, wherein the second token instance is a token instance for which predicted attention level is the highest, compared to attention level predicted for other token instances representing the prior experience.

16. A non-transitory computer-readable medium for use in a computer to respond to apprehension of a user towards an experience with an explanation indicative of similarity between the experience and a prior experience of the user; the computer comprises a processor, and the non-transitory computer-readable medium comprising:
program code for receiving expression of the user;
program code for analyzing the expression to determine that the expression indicates apprehension of the user towards the experience;
program code for extracting a first token instance from the expression; wherein the first token instance represents an aspect of the experience;
program code for selecting a prior experience, from among prior experiences, such that the prior experience is represented by a second token instance that is more similar to the first token instance than most of the token instances representing the other prior experiences, and affective response of the user to the prior experience reaches a predetermined threshold; whereby the fact that the affective response reaches the predetermined threshold implies there is a probability of more than 10% that the user remembers the prior experience; and
program code for generating an explanation of relevance of the experience to the user, which is indicative of similarity between the first token instance and the second token instance.

17. The non-transitory computer-readable medium of claim 16, further comprising program code for presenting the explanation to the user as a response to the expression of the user indicating the apprehension.

18. The non-transitory computer-readable medium of claim 16, further comprising program code for utilizing semantic analysis for the extracting of the first token instance; wherein the semantic analysis indicates that the first token instance is likely a cause of the apprehension.

19. The non-transitory computer-readable medium of claim 16, further comprising program code for utilizing eye tracking for the extracting of the first token instance; wherein the eye tracking identifies an object, represented by the first token instance, on which gaze of the user is fixated.

20. The non-transitory computer-readable medium of claim 16, wherein the second token instance is a token instance for which measured attention level of the user is highest, compared to attention level to other token instances representing the prior experience.
